(19) United States
(12) Patent Application Publication
(10) Pub. No.: US 2025/0343334 A1
(43) Pub. Date: Nov. 6, 2025

(54) HERMETICALLY SEALED BATTERY CASINGS, AND METHODS OF PRODUCING THE SAME

(71) Applicant: 24M Technologies, Inc., Cambridge, MA (US)

(72) Inventors: Elliott PRIEN, Boston, MA (US); Panuporn UDOMPANSA, Castro Valley, CA (US); Junzheng CHEN, Concord, MA (US)

(21) Appl. No.: 19/199,086

(22) Filed: May 5, 2025

Related U.S. Application Data
(60) Provisional application No. 63/642,922, filed on May 6, 2024.

(51) Int. Cl. H01M 50/517; H01M 10/613; H01M 10/647; H01M 10/6554; H01M 50/211; H01M 50/242; H01M 50/271; H01M 50/296; H01M 50/503

(52) U.S. Cl. CPC H01M 50/517; H01M 10/613; H01M 10/647; H01M 10/6554; H01M 50/211; H01M 50/242; H01M 50/271; H01M 50/296; H01M 50/503

(57) ABSTRACT

An electrochemical cell assembly includes a housing defining an internal volume configured to receive an electrochemical cell stack therein. The electrochemical cell stack includes a plurality of electrochemical cells stacked on top of each other. Each of the electrochemical cells includes at least one tab extending therefrom. The assembly may further include a feedthrough assembly configured to be electrically coupled to the electrochemical cell stack. The feedthrough assembly includes a conductive arm configured to align with and contact a tab of a corresponding electrochemical cell of the plurality of electrochemical cells when the electrochemical cell stack is disposed in the internal volume, and a feedthrough connector coupled to the conductive arm and configured to electrically couple the tab of the corresponding electrochemical cell to an electrical component external to the housing. The feedthrough assembly may reduce a number of weld points and an amount of passive materials in the assembly.

### CROSS-REFERENCE TO RELATED APPLICATIONS

This application claims priority to and the benefit of U.S. Provisional Patent Application No. 63/642,922, filed May 6, 2024, and entitled, “Hermetically Sealed Battery Casings, and Methods of Producing the Same,” the entire disclosure of which is hereby incorporated by reference herein.

### TECHNICAL FIELD

Embodiments described herein relate to sealed casings for electrochemical cells and electrochemical cell stacks, and methods of producing the same.

### BACKGROUND

Conventional approaches for producing rechargeable, lithium-ion battery packs have inherent packing inefficiencies, which lead to reduced energy density of the battery pack and increased manufacturing cost. In these methods, a battery pack or module includes a plurality of mono-cells, and each mono-cell includes distinct packaging that is formed from a metal such as aluminum, nickel-plated steel, stainless steel, and/or aluminized pouch material. In order to assemble multi-cell assemblies, external welds are used to hermetically seal the mono-cell packaging and the battery pack. However, as the number of welded locations increases, the likelihood of a sealing failure, and thereby ingress of moisture into the battery pack that can affect performance of one or more electrochemical cells included in the battery pack, increases.

### BRIEF DESCRIPTION OF THE DRAWINGS

FIG. 1A is a schematic block diagram of an electrochemical cell assembly including one or more electrochemical cells disposed in a housing, the housing disposed in an external casing including electrical terminals disposed thereon, according to an embodiment.

FIG. 1B is a schematic block diagram of an electrochemical cell, according to an embodiment.

FIG. 2A is a perspective view of an electrochemical cell assembly showing an external casing including electrical terminals, according to an embodiment.

FIG. 2B is a cross-sectional view of the electrochemical cell assembly of FIG. 2A taken along the line A-A shown in FIG. 2A. The electrochemical cell assembly includes an electrochemical cell stack disposed in a fixture and coupled to a feedthrough assembly to form an electrochemical cell subassembly, the electrochemical cell subassembly disposed in a housing and the external casing, according to an embodiment.

FIGS. 3A shows a top view of the electrochemical cell assembly, and FIG. 3B is a side cross-sectional view taken along the line B-B shown in FIG. 2A, respectively, of the electrochemical cell assembly of FIGS. 2A-2B without the external casing.

FIG. 4 shows the fixture of FIG. 2B-3B, which is configured to receive the electrochemical cell stack, according to an embodiment.

FIGS. 5A-5B show finite element analysis (FEA) modeling data of stress and displacement data, respectively, obtained from a 3 dimensional (3D) model the fixture of FIG. 4.

FIGS. 5C-5D show finite element analysis (FEA) modeling data of stress and displacement date, respectively, of the modeled fixture of FIG. 4.

FIG. 6A shows the fixture coupled to a feedthrough assembly to form the electrochemical cell subassembly, the feedthrough assembly including a set of feedthrough plates with feedthrough connectors disposed therethrough, according to an embodiment.

FIGS. 6B shows a side cross-sectional view of a portion of the electrochemical cell assembly indicated by the arrow A and taken along the line C-C shown in FIG. 6A, and FIG. 6C is a top view of the portion indicated by the arrow A, of the set of feedthrough plates coupled to the fixture.

FIG. 7A shows a perspective view of a conductive arm coupled to a feedthrough connector, according to an embodiment.

FIG. 7B shows a top cross-sectional view of the conductive arm of FIG. 7A taken along the line D-D shown in FIG. 7A showing a threaded fastener coupling the conductive arm to the feedthrough connector, according to an embodiment.

FIGS. 8A is a top view, FIG. 8B is a top, front perspective view, and FIG. 8C is a top, rear perspective view of a feedthrough plate defining apertures through which feedthrough connectors are configured to be disposed, according to an embodiment.

FIG. 9 shows a first portion of the feedthrough plate and a second portion of the feedthrough plate coupled together and secured to a support element of the fixture, according to an embodiment.

FIG. 10 shows an isometric view of the electrochemical cell subassembly disposed in a housing.

FIGS. 11A shows a front perspective view of a portion of the electrochemical cell assembly of FIGS. 2A-2C showing cover plate including standoff arms coupled to an opening defined by the housing, the feedthrough connectors disposed through respective apertures defined by the cover plate.

FIG. 11B is a side cross-section view of the portion of the assembly taken along the line E-E shown in FIG. 11A.

FIGS. 12A is a front view of the portion of the electrochemical cell assembly of FIGS. 11A-11B showing the cover plate with contact pads coupled to the feedthrough connectors and a set of threaded fasteners disposed in an opening defined by the feedthrough connector to fasten the connector pads to the cover plate, according to an embodiment.

FIG. 12B is a side cross-section view of the assembly of FIG. 12A taken along the line F-F shown in FIG. 12A, and FIG. 12C is a top view of the portion of the assembly with the housing removed.

FIGS. 13A a top, front perspective view, and FIG. 13B is a front view of a controller coupled to the standoff arms of the cover plate of FIGS. 11A-13C, according to an embodiment.

FIGS. 14A is a side perspective view of the assembly of FIGS. 12A-12C showing a controller cover coupled to the housing over the controller, the controller cover defining one or more openings, according to an embodiment.

FIG. 14B is a side cross-section view of a portion of the assembly of FIG. 14A taken along the line G-G shown in FIG. 14A, and FIG. 14C is a top cross-section view of the portion of the assembly taken along the line H-H in FIG. 14A.

FIG. 15 shows a transparent top view of the feedthrough assembly coupling the electrochemical stack to the controller, according to an embodiment.

FIGS. 16A-16B show a thermal plot of stress and displacement data, respectively, of the controller cover.

FIGS. 17A-17B show a thermal plot of stress and displacement data, respectively, of the controller cover.

FIG. 18A is a perspective view of an electrochemical cell assembly including a controller cover coupled to a housing and enclosing a controller for the electrochemical cell assembly, according to an embodiment.

FIG. 18B is a cross-section view of the electrochemical cell assembly of FIG. 18A taken along the line I-I shown in FIG. 18A. The electrochemical cell assembly includes an electrochemical cell stack disposed in a fixture and coupled to a feedthrough assembly to form an electrochemical cell subassembly, according to an embodiment.

FIG. 19 shows a top cross-sectional view of the electrochemical cell assembly of FIG. 18A taken along the line J-J.

FIG. 20 shows the fixture of FIG. 18A-19, which includes mechanical fasteners and is configured to receive the electrochemical cell stack, according to an embodiment.

FIG. 21 shows a fixture for receiving an electrochemical cell stack, according to an embodiment.

FIGS. 22A-22F show finite element analysis (FEA) modeling data of stress and displacement data, respectively, obtained from a 3 dimensional (3D) model of the fixture of FIG. 20.

FIGS. 23A-23D show finite element analysis (FEA) modeling data of stress and displacement data, respectively, obtained from a 3 dimensional (3D) model of the fixture of FIG. 21.

FIG. 24A shows the fixture of FIG. 20 coupled to a feedthrough assembly to form the electrochemical cell subassembly, the feedthrough assembly including a set of feedthrough plates with feedthrough connectors disposed therethrough, according to an embodiment.

FIG. 24B shows a side cross-section view of a portion of the electrochemical cell assembly indicated by the arrow A and taken along the line P-P shown in FIG. 24A, and FIG. 24C is a top view of the portion of the set of feedthrough plates coupled to the fixture.

FIGS. 25A-25B shows a perspective view of a conductive arm coupled to a feedthrough connector, according to an embodiment. FIG. 25C shows a top cross-sectional view of the conductive arm of FIG. 7A taken along the line K-K shown in FIG. 25A showing the conductive arm coupled to the feedthrough connector, according to an embodiment.

FIG. 26A is a top, front perspective view, FIG. 26B is a top, rear perspective view, and FIG. 26C is a top view of a feedthrough plate defining apertures through which feedthrough connectors are configured to be disposed, according to an embodiment.

FIG. 27A and FIG. 27B show a first portion of the feedthrough plate of FIGS. 26A-26C and a second portion of the feedthrough plate coupled together and secured to a support element of the fixture, according to an embodiment.

FIG. 28 shows a front perspective view of the electrochemical cell subassembly of FIGS. 18A-18B disposed in the housing of FIGS. 18A-18B.

FIG. 29A shows a front perspective view of the electrochemical cell assembly of FIGS. 18A-18B showing a cover plate including standoff arms and in with contact pads coupled to the feedthrough connectors, according to an embodiment.

FIG. 29B is a side cross-section view of the assembly taken along the line L-L shown in FIG. 29A.

FIG. 30 is a top cross-section view of the assembly taken along the line M-M shown in FIG. 29A.

FIG. 31A is a front perspective view, and FIG. 31B is a front view of a controller coupled to the standoff arms of the cover plate of FIGS. 29A-30, according to an embodiment.

FIG. 32A is a side cross-section view of the assembly of FIGS. 31A-31B taken along the line N-N showing a controller cover coupled to the housing over the controller, according to an embodiment.

FIG. 32B is a top cross-section view of the portion of the assembly taken along the line O-O in FIG. 31A.

FIGS. 33A-33B illustrate an electrochemical cell stack assembly including one or more electrochemical cells (FIG. 33B) disposed in a fixture (FIG. 33A), according to an embodiment.

FIG. 33C is a schematic illustration of an electrochemical cell of the electrochemical cell stack disposed in an enclosure formed by backing films that are sealed at their edges, according to an embodiment.

FIGS. 33D-33F illustrate various views during production of an electrochemical cell substack that is a portion of the electrochemical cell stack assembly of FIGS. 33A-33B, according to an embodiment.

FIG. 34 is a perspective view of an electrochemical cell subassembly comprising a fixture coupled to a feedthrough assembly, according to an embodiment.

FIG. 35A is a front perspective view of an electrochemical cell assembly including a cover plate having a plurality of contact pads, according to an embodiment.

FIG. 35B is a side cross-sectional view of a portion of the electrochemical cell assembly of FIG. 35A, taken along line P-P shown in FIG. 35A.

FIG. 35C is a front perspective view of an electrochemical cell assembly having a contact pad arrangement and insulation components, according to an embodiment.

FIG. 35D is a side cross-sectional view of a portion of the electrochemical cell assembly of FIG. 35C, taken along line Q-Q shown in FIG. 35C.

FIG. 36A is a perspective view of a portion of an electrochemical cell subassembly, according to an embodiment.

FIG. 36B is an enlarged view of a portion of the electrochemical cell subassembly shown in FIG. 36A.

FIG. 36C is a side perspective view of a cooling plate included in the electrochemical cell subassembly of FIG. 36A, according to an embodiment.

FIG. 37 is a graph illustrating the impact of a thermal interface material (TIM) on housing temperature rise of a battery pack with and without the thermal interface material during charging and discharging cycles at various C-rates.

FIG. 38A is a perspective view of a fixture supporting an electrochemical cell stack including a plurality of electrochemical cells, according to an embodiment.

FIG. 38B is a perspective view of a housing (e.g., external enclosure) configured to contain the electrochemical cell subassembly of FIG. 38A, according to an embodiment.

FIG. 38C illustrates the completed enclosure following installation and laser welding of a top plate, according to an embodiment.

FIG. 38D illustrates the electrochemical cell assembly of FIG. 38C, further including one or more sensing tabs configured for voltage monitoring and control, according to an embodiment.

FIG. 38E illustrates the electrochemical cell assembly of FIG. 38D, further including a cover positioned over the primary tabs and sensing tabs.

FIG. 38F illustrates a perspective view of a feedthrough terminal, according to an embodiment.

FIG. 39A is a top view of a lid sub-assembly configured to be mounted onto the cover of the electrochemical cell enclosure shown in FIG. 38E.

FIG. 39B is a corresponding bottom view of the lid sub-assembly shown in FIG. 39A.

FIG. 40A is a bottom view of a pack cover sub-assembly, according to an embodiment.

FIG. 40B is a top view of the pack cover sub-assembly of FIG. 40A.

FIG. 40C illustrates the completed battery pack with the pack cover sub-assembly fastened to the pack lid and secured to the underlying housing, according to an embodiment.

FIG. 41 is a flow chart of an example method of producing the electrochemical cell assembly, according to an embodiment.

### SUMMARY

In some embodiments, an assembly includes a housing defining an internal volume configured to receive an electrochemical cell stack therein. The electrochemical cell stack includes a plurality of electrochemical cells stacked on top of each other. Each of the electrochemical cells includes at least one tab extending therefrom. The assembly may further include a feedthrough assembly configured to be electrically coupled to the electrochemical cell stack. The feedthrough assembly includes a conductive arm configured to align with and contact a tab of a corresponding electrochemical cell of the plurality of electrochemical cells when the electrochemical cell stack is disposed in the internal volume, and a feedthrough connector coupled to the conductive arm and configured to electrically couple the tab of the corresponding electrochemical cell to an electrical component external to the housing. In some embodiments, the feedthrough assembly is at least partially disposed in the housing. In some embodiments, the feedthrough connector defines a first threaded cavity and a second threaded cavity; and the feedthrough assembly further includes a first threaded fastener configured to be disposed in the first threaded cavity to couple the feedthrough connector to the conductive arm.

In some embodiments, the feedthrough assembly further includes a second threaded fastener configured to be disposed in the second threaded cavity and electrically connect the conductive arm, the feedthrough connector, and the first threaded fastener to the electrical component external to the housing. In some embodiments, an opening is defined in a sidewall of the housing; and the feedthrough assembly further includes a feedthrough plate configured to cover a portion of the opening of the housing, the feedthrough plate defining an aperture configured to receive a corresponding feedthrough connector therethrough. In some embodiments, a cover plate is coupled to the sidewall of the housing to close the opening and substantially hermetically seal the housing. In some embodiments, the second threaded fastener is disposed outside of the inner volume of the housing. In some embodiments, the assembly further includes a fixture disposed in the internal volume of the housing, the fixture defining an inner space configured to receive the electrochemical cell stack and at least one of secure the electrochemical assembly or apply a compressive force on the electrochemical cell stack. In some embodiments, the fixture includes a first plate configured to receive the electrochemical cell stack thereon; a set of arms extending from opposing edges of the first plate at a substantially orthogonal angle relative to the first plate; and a second plate coupled to ends of each of the set of arms opposite the first plate such that the electrochemical cell stack is secured between the first and second plates and the compressive force is exerted on the electrochemical cell stack. In some embodiments, the assembly further includes a controller coupled to the plurality of electrochemical cells in the electrochemical cell stack via the feedthrough assembly. In some embodiments, the assembly further includes a casing defining an inner volume configured to receive the housing, the casing including electrical terminals disposed on a sidewall of the housing, the electrical terminals configured to be electrically coupled to a corresponding tab of one or more of the plurality of electrochemical cells via the feedthrough assembly.

In some embodiments, a feedthrough assembly includes: a conductive arm configured to align with and contact a terminal tab of a corresponding electrochemical cell in an electrochemical cell stack; a feedthrough connector coupled to the conductive arm and configured to electrically couple the terminal tab to an external electrical component; and a busbar electrically coupled to the terminal tab of the electrochemical cell, wherein the conductive arm includes a foil coupled to the busbar and to the feedthrough connector.

In some embodiments, a system includes: a housing defining an internal volume configured to receive an electrochemical cell stack; a plurality of electrochemical cells stacked within the housing; a feedthrough assembly electrically coupled to the electrochemical cell stack; a plurality of cooling plates interposed between at least a portion of the electrochemical cells and configured to transfer heat away from the electrochemical cells; and a plurality of thermal interface materials disposed between the cooling plates and corresponding walls of the housing.

### DETAILED DESCRIPTION

Packing inefficiencies for lithium-ion battery packs can lead to reduced energy density of the battery pack and/or increased manufacturing costs. Energy density at the pack level can be increased by about 10%-20% when a total amount of passive materials in the battery pack (i.e., materials not involved electrochemically) are reduced. Some existing methods eliminate modules (i.e., sets of electrochemical cells packaged together) and directly package mono-cells into battery packs to reduce passive materials in the pack. However, these methods do not resolve inefficiencies and difficulties of packing mono-cells into a battery pack.

The battery pack, or modules that make up the battery pack, may include a mono-cell (i.e., a single electrochemical cell), and each mono-cell may include a respective packaging or housing. The packaging may be formed from or include a metal such as made of aluminum, nickel-plated steel, stainless steel, aluminized pouch material, or some combination thereof. In conventional mono-cell assemblies, a fraction of the cell packaging can either be empty or filled with excess materials. Generally, welds are formed at connection points between. For prismatic and cylindrical cells, external welds may also be used to hermetically seal the housing of the individual electrochemical cell to inhibit moisture ingress. In the case of a pouch cell, a precise heat seal can be made to seal the housing of the electrochemical cell. This hermetic weld or joint may be desirable to ensure that a module or battery pack can function properly and is typically a step which has a higher likelihood of failure, for example, due to tight weld tolerances or clearance, cleanliness, and weld tool precision. As the number of mono-cells in a system increases, the possibility for leakage or incorporation of inoperative cells may also increase.

These mono-cells, which have tolerances associated with parameters such as external dimensions and weldable locations may then be assembled one-by-one into a module or pack. Based on the outer geometry of the mono-cell, methods for assembling the mono-cell packaging into the module or pack may be limited. Once each of the mono-cells is positioned in a final location within the module or pack, challenges may arise including properly fixturing each mono-cell to ensure robustness against vibrations, and in some cases applying uniform pressure across the entire active area of the electrodes included in the electrochemical cells. Material selection is a large field of research in battery packaging as there are a high number of considerations ranging from rigidity to thermal conductivity and fire resistance.

In conventional assembly processes, once the mono-cells or individual electrochemical cells are positioned within the module or pack, secondary and tertiary welding typically may take place depending on the mono-cell design. Subsequent welding steps can add complexity to the module or pack, and as additional parts are included in the assembly, stack-up tolerances may trend upward. In addition to these downsides, welding at the module or pack level adds expensive materials and occupies space which does not contribute electrochemically. Similar to the hermetic welding of mono-cells, each additional weld that is made at the module/pack level also serves as an opportunity for failure in some portion of the module/pack. Moreover, these conventional configurations typically include individual mono-cells with complete casings, contributing to increased weight, reduced volumetric energy density, and lower overall pack performance. Existing methods do not efficiently support both serial and parallel connections within the same compact structure while achieving elevated output voltages above those of individual lithium-ion cells. The aforementioned factors contribute to the difficulty of designing smaller, secondary batteries that implement both serial and parallel connections to achieve useful voltages and energy capacity. Existing methods of battery packaging result in drawbacks including: (1) high cost of manufacturing battery packs; (2) lower total pack capacity; (3) limitations related to possible applications of use; (4) heavier battery packs; (5) higher greenhouse gas (GHG) intensive materials (Al, Cu, Ni, etc.) used; (6) and difficult assembly processes that require high precision parts and equipment at all levels. Accordingly, there is a need for improved battery architectures that allow elevated pack voltage using fewer structural components, while improving electrochemical contribution per unit volume and mass.

Embodiments described herein provide sealed casings for electrochemical cells and electrochemical cell stacks that may reduce excess assembly materials (i.e., passive materials) as well as decrease a number of connection points to be welded. The embodiments described herein relate to an electrochemical cell stack assembly (hereinafter, “stack assembly”) which bypasses mono-cells and goes directly from the electrode level to the pack level. The embodiments described herein reduce complex electrical connection strategies at the pack level while maintaining a similar potential and capacity. Bypassing use of individually packaged mono-cells may reduce expensive, heavy, and flammable organic solvents used in the electrochemical cell assembly. Typically, there are complex stamped wiring structures and sometimes wiring harnesses that add weight, cost, complexity, etc. In contrast, embodiments described herein can reduce materials and components in the stack assembly as well as simplify electrical connections by making parallel connections using simple ultrasonic metal welds and making serial connections using bus bars that connect directly to a Battery Management System (BMS). Embodiments described herein may allow inclusion of multiple monocells in a single package that can be coupled in series, parallel, or any other suitable configuration, and can provide a higher voltage relative to a comparable single electrochemical cell. Embodiments described herein provide electrochemical cell or battery assemblies or packs that have less packaging material, and include individual monocells that have lower energy densities at the pack level, but allow series or parallel connection of the monocells such that the pack has a voltage value that has higher than the individual monocells. This make such assemblies more suitable for commercial applications.

In some embodiments, the stack assembly may include a fixture configured to receive an electrochemical cell stack. The fixture may apply uniform pressure and fixation of the electrochemical cells, which facilitates electrode stack alignment and may enhance performance. Implementing the fixture reduces use of expensive in-fill material that goes between mono-cells, as the stack assembly does not include individually packaged mono-cells. In some embodiments, the stack assembly includes a rigid, housing for hermeticity at the pack level, which may prolong battery life and lessen the burden on the user to properly seal the stack assembly.

Therefore, due to elimination of mono-cells from the stack assembly, packaging may be consolidated, resulting in a reduction of the total number of hermetic welds. In some embodiments, the stack assembly may be hermetically sealed and may be resilient against shock and vibration. The stack assembly may include a feedthrough assembly configured to electrically connect the electrochemical cell stack to a circuitry (e.g., a controller such as a BMS) external to the housing and therefore easily accessible to the user. The stack assembly may simplify the process of module/pack protection and connectivity on the user side, and due to the feedthrough assembly and BMS design, the stack assembly allows for “plug and play” feeling for users.

The stack assembly may accommodate a plurality of voltage levels via adjustments to the feedthrough diameters and internal welding configurations. The stack assembly may be scaled easily, as there are no limitations regarding mono-cell geometry. For example, most cylindrical cells only come in standard sizes (e.g., 18650, 2170, and 4680 formats) and this imposes high cost when adjusting the outer dimensions of the battery pack and/or redesigning the mono-cell. Along with mono-cell redesign, a large amount of assembly process equipment must be assessed and modified (winding, stacking, welding, etc.). With minor changes to the electrode shape and scaling of the packaging material, the stack subassembly described herein can be made to fit a wide range of applications quickly and affordably.

Embodiments of the hermetically sealed electrochemical cell assemblies described herein may provide one or more benefits including, for example: (1) reduce materials and components in stack assembly, thereby reducing manufacturing complexity and cost; (2) maintaining a large total pack capacity; (3) easily scaled manufacturing process, thereby enabling diverse applications of use; (4) reducing overall battery pack weight; (5) reduction in high-cost and unsustainable materials; (6) reducing weld locations, thereby reducing likelihood of cell failure; enhancing pack-level energy density such that lithium iron phosphate (LFP) chemistries may achieve performance metrics (e.g., energy density) at the system level comparable to those of nickel manganese cobalt (NMC) chemistries.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can include a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference herein.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

The term “substantially” when used in connection with the term “hermetic” to define the effect of a barrier layer is intended to convey that the barrier layer inhibits moisture ingress or egress from a surface on which the barrier layer is disposed by greater than about 95%.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

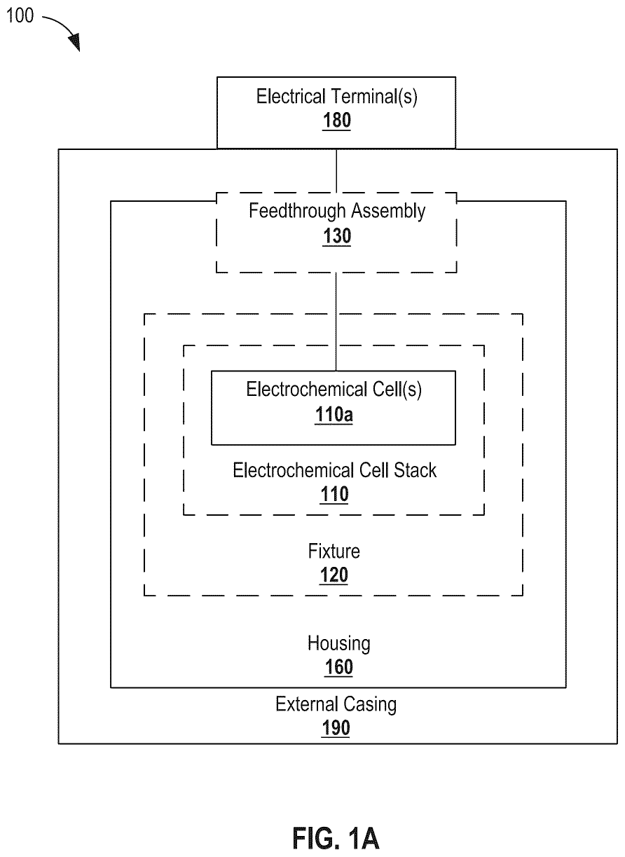

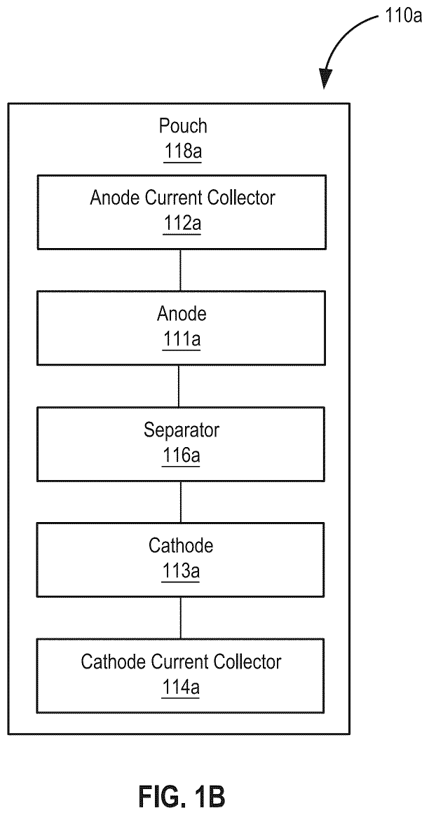

FIG. 1A is a schematic block diagram of a stack assembly 100 including one or more electrochemical cells 110a disposed in a housing 160, the housing 160 being disposed in an external casing 190 including electrical terminals 180 disposed thereon. In some embodiments, the stack assembly 100 may include a plurality of electrochemical cells 110a stacked on top of each other to form an electrochemical cell stack (hereinafter, “cell stack 110”). The stack assembly 100 may optionally include a fixture 120 to secure the cell stack 110 and a feedthrough assembly 130 to electrically connect the cell stack 110 to an electrical component external to the housing 160 (e.g., a BMS and/or the electrical terminals 180).

The electrochemical cells 110a may include any suitable electrochemical cell configured to store electrical energy and deliver electrical energy on demand. For example, FIG. 1B is a schematic block diagram of the electrochemical cell 110a that may be included in the assembly 100. In some embodiments, each of the electrochemical cells 110a included in the stack 110 may be substantially similar to each other. While FIG. 1B shows a particular embodiment of the electrochemical cell 110a that may be included in the assembly 100, this is for illustrative purposes only and the stack 110 can include any other electrochemical cells having any suitable structure or formulation. All such embodiments are envisioned and should be considered to be within the scope of the present disclosure.

It should be noted that while the term “electrochemical cell” is used throughout to describe the structure of the stack assembly 100, in some embodiments, the stack assembly 100 can have an electrode-to-pack configuration, wherein electrode layers are integrated directly into the pack structure rather than being packaged as discrete, standalone cells. Accordingly, in some embodiments, references to “electrochemical cells” may refer to electrode substructures rather than fully enclosed, independent units.

As shown in FIG. 1B, the electrochemical cell 110a includes an anode 111a disposed on an anode current collector 112a, a cathode 113a disposed on a cathode current collector 114a, and a separator 116a disposed between the anode 111a and the cathode 113a.

The anode 111a includes an anode active material. In some embodiments, the anode 111a can include an anode conductive material. In some embodiments, the anode 111a can include a semi-solid anode. The anode 111a is disposed on the anode current collector 112a and is configured to receive electrons therefrom. In some embodiments, the anode current collector 112a can include copper, aluminum, nickel, titanium, any other suitable metal, or any suitable combination thereof.

The cathode 113a includes a cathode active material. In some embodiments, the cathode 113a can include a cathode conductive material. In some embodiments, the cathode 113a can include a semi-solid cathode. The cathode 113a is disposed on the cathode current collector 114a and is configured to communicate electrons thereto. In some embodiments, the cathode current collector 114a can include aluminum, copper, or any other suitable current collector material.

The separator 116a can include any suitable separator that acts as an ion-permeable layer, for example, an ion-permeable membrane. In other words, the separator 116a allows exchange of ions while maintaining physical separation of the cathode 113a and the anode 111a. For example, the separator 116a can be any conventional membrane that is capable of ion transport. In some embodiments, the separator 116a is a liquid impermeable membrane that permits the transport of ions therethrough, namely a solid or gel ionic conductor. In some embodiments the separator 116a is a porous polymer membrane infused with a liquid electrolyte that allows for the shuttling of ions between the cathode 113a and anode 111a electroactive materials, while inhibiting the transfer of electrons.

In some embodiments, the separator 116a can be a microporous membrane that prevents particles forming the positive and negative electrode compositions from crossing the membrane. For example, the membrane materials can include or be selected from polyethylene oxide (PEO) polymer in which a lithium salt is complexed to provide lithium conductivity, or NAFION™ membranes which are proton conductors. For example, PEO based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. In some embodiments, the separator 116a can include polyethylene, polypropylene, polyimide, or any combination thereof. In some embodiments, the separator 116a can be made from a ceramic such as alumina. In some embodiments, the separator 116a can be made from a suitable polymer with ceramic particles dispersed within the separator 116a or deposited on one or both surfaces of the separator 116a.

In some embodiments, a first film can be coupled to the anode current collector 112a and a second film can be coupled to the cathode current collector 114a. The first film and the second film can be coupled together to form a pouch 118a. In some embodiments, the pouch can be composed of polyethylene, polypropylene, polystyrene, polyethylene terephthalate (PET), high density polyethylene (HDPE), low density polyethylene (LDPE), polyvinyl chloride (PVC), polyether ether ketone (PEEK), polybutylene terephthalate (PBT), polyvinylidene fluoride (PVDF), polycarbonate. or any combination thereof. In some embodiments, the pouch can be composed of polyethylene naphthalate (PEN), polysulfone, Nylon, polyphenylene sulfide (PPS), polyimide (PI), polyamide-imide (PAI), polytetrafluoroethylene (PTFE), or any combination thereof. In some embodiments, the pouch can include phenylethylammonium iodide (PEAI), liquid crystal polymer (LCP), epoxy, acrylic, polyoxymethylene (POM), sheet molding compound (SMC), or any combination thereof.

In some embodiments, the pouch 118a can block electrolyte liquid and vapor from escaping to the high voltage series connection points between electrochemical cells 110 in the system. This can prevent corrosion/oxidation. PET film can be effective at blocking the electrolyte fluid. In some embodiments, the films can block the electrolyte liquids and vapors from escaping the electrochemical cell 110a and corroding an integrated heater (not shown) in the system. Some polymers have appropriate molecular formulations to allow small gas molecules to escape during formation (e.g., H₂, H₂O CH₄, C₂H₂) but block effective solid-electrolyte interphase (SEI) formation gases (e.g., CO₂, SO₂, C₃H₄O₃, C₄H₆O₃, C₅H₁₀O₃) as well as electrolyte vapor to ensure good SEI protection during formation. For example, PET can have pores of a desired size to allow the passage of desired gases, but block the passage of undesired gases.

In some embodiments, the pouch 118a can have pores having an average pore diameter of at least about 0.2 nm, at least about 0.3 nm, at least about 0.4 nm, at least about 0.5 nm, at least about 0.6 nm, at least about 0.7 nm, at least about 0.8 nm, at least about 0.9 nm, at least about 1 nm, at least about 2 nm, at least about 3 nm, at least about 4 nm, at least about 5 nm, at least about 6 nm, at least about 7 nm, at least about 8 nm, or at least about 9 nm. In some embodiments, the pouch 118a can have pores having an average pore diameter of no more than about 10 nm, no more than about 9 nm, no more than about 8 nm, no more than about 7 nm, no more than about 6 nm, no more than about 5 nm, no more than about 4 nm, no more than about 3 nm, no more than about 2 nm, no more than about 1 nm, no more than about 0.9 nm, no more than about 0.8 nm, no more than about 0.7 nm, no more than about 0.6 nm, no more than about 0.5 nm, no more than about 0.4 nm, or no more than about 0.3 nm. Combinations of the above-referenced pore diameters are also possible (e.g., at least about 0.2 nm and no more than about 10 nm or at least about 0.5 nm and no more than about 5 nm), inclusive of all values and ranges therebetween. In some embodiments, the pouch 118a can have pores having an average pore diameter of about 0.2 nm, about 0.3 nm, about 0.4 nm, about 0.5 nm, about 0.6 nm, about 0.7 nm, about 0.8 nm, about 0.9 nm, about 1 nm, about 2 nm, about 3 nm, about 4 nm, about 5 nm, about 6 nm, about 7 nm, about 8 nm, about 9 nm, or about 10 nm.

In some embodiments, a coating can be disposed on the pouch to engineer and/or control the size of the pores of the pouch 118a. In some embodiments, the coating can include or be formed from a conductive material. In some embodiments, the coating can be formed from a non-conductive material. In some embodiments, the coating can included or be formed from a combination of conductive and non-conductive materials. In some embodiments, the coating can include Al₂O₃, SiO, SiO₂, MgO MgO₂, ZrO, ZrO₂, TiO, TiO₂, ZnO, ZnO with aluminum, Ta₂O₅, La₂O₃, Mn₃O₄, Nb₂O₅, InGaZnO₄, Pb(Zr, Ti)O₃, Ti₅O₁₂, TiC, SiC, indium tin oxide (ITO), sulfated tin oxide (STO), or any combination thereof. In some embodiments, the coating can include copper, nickel, aluminum, titanium, gold, niobium, chromium, molybdenum, tungsten, tantalum, or any alloy including a combination thereof. In some embodiments, the coating layer can be applied via sputtering, wet coating, dry coating, chemical vapor deposition, plasma-enhanced chemical vapor deposition, or any other suitable application method. In some embodiments, the coating can include a ceramic. In some embodiments, the coating can include boehmite.

In some embodiments, the coating can have a thickness of at least about 500 nm, at least about 1 μm, at least about 1.5 μm, at least about 2 μm, at least about 2.5 μm, at least about 3 μm, at least about 3.5 μm, at least about 4 μm, or at least about 4.5 μm. In some embodiments, the coating can have a thickness of no more than about 5 μm, no more than about 4.5 μm, no more than about 4 μm, no more than about 3.5 μm, no more than about 3 μm, no more than about 2.5 μm, no more than about 2 μm, no more than about 1.5 μm, or no more than about 1 μm. Combinations of the above-referenced thicknesses are also possible (e.g., at least about 500 nm and no more than about 5 μm or at least about 1 μm and no more than about 2 μm), inclusive of all values and ranges therebetween. In some embodiments, the coating can have a thickness of at least about 500 nm, at least about 1 μm, at least about 1.5 μm, at least about 2 μm, at least about 2.5 μm, at least about 3 μm, at least about 3.5 μm, at least about 4 μm, about 4.5 μm, or about 5 μm.

In some embodiments, the pouch 118a of the electrochemical cell does not include metal. In other words, the pouch may include one or more layers formed from non-metallic materials. In some embodiments, the pouch can be excluded.

Referring to FIG. 1A, in some embodiments, the cell stack 110 may include any number of electrochemical cells 110a. For example, the number of electrochemical cells 110a in the cell stack 110 may be in a range of 4 to 400 (e.g., 4, 10, 20, 30, 40, 50, 60, 70, 80, 90, 100, 110, 120, 130, 140, 160, 170, 180, 190, 200, 220, 210, 220, 230, 240, 250, 260, 270, 280, 290, 300, 310, 320, 330, 340, 350, 360, 370, 380, 390, 400, inclusive of all ranges and subranges therebetween). In some embodiments, the electrochemical cells 110a included in the cell stack 110 can be connected in parallel. In some embodiments, the plurality of electrochemical cells 110a can be connected in series. In some embodiments, the plurality of electrochemical cells 110a can be disposed in the cell stack 110 with anodes and anode current collectors on either terminal end of the stack (i.e., a parallel connection). In some embodiments, the electrochemical cells 110a can be disposed in the cell stack 110 with cathodes and cathode current collectors on either terminal end of the stack (i.e., a parallel connection). Unlike conventional mono-cell arrangements that generally include additional casing and interconnection materials, the described cell stack enables both serial and parallel connections within a unified architecture. This allows for voltage multiplication across the stack while maintaining a compact, material-efficient design. As a result, the cell stack 110 can achieve pack-level voltages suitable for commercial and industrial applications without the having discrete, separately housed cells.

In some embodiments, each electrochemical cell 110a may include an anode tab and a cathode tab extending therefrom. Additionally, or alternatively, a plurality of electrochemical cells 110a may be coupled to a respective tab. For example, the assembly 100 may include a plurality of electrochemical cell substacks (hereinafter, “cell substacks”), each cell substack connected to a respective tab. The cell substacks may be configured to be disposed on top of each other to form the cell stack 110. Any number of electrochemical cells may be included in a cell substack. In some embodiments, a number of electrochemical cells in each cell substack may be in a range of 4 to 100, (e.g. 5, 10, 15, 20, 25, 30, 35, 40, 45, 50, 55, 60, 65, 70, 75, 80, 85, 90, 95, or 100 electrochemical cells, inclusive of all ranges and values therebetween). In some embodiments, an odd number of electrochemical cells may be included in each cell substack or the cell stack 110. In some embodiments, an even number of electrochemical cells may be included in each cell substack or the cell stack 110. In some embodiments, the cell stack 110 may include a plurality of cell substacks with each cell substack including between about 20 electrochemical cells and 80 electrochemical cells. In some embodiments, the cell stack 110 may include a plurality of cell substacks with each cell substack including between about 40 electrochemical cells and 60 electrochemical cells.

In some embodiments, the electrochemical cells 110a may be arranged in a plurality of cell substacks, and each cell substack may include an anode tab and a cathode tab extending therefrom. For example, each tab may be configured so that multiple electrochemical cells (e.g., an anode current collector or a cathode current collector of each of the electrochemical cells) are in contact with one tab. The tabs may allow electrical energy to be communicated to and/or withdrawn from the one or multiple electrochemical cells 110a via the single one of the respective tab(s) coupled thereto.

In some embodiments, the assembly 100 may include a fixture 120 defining an inner space configured to receive the cell stack 110 and secure and/or apply a compressive force on the cell stack 110. In some embodiments, the fixture 120 may be configured to apply a uniaxial pressure to the cell stack 110. In some embodiments, fixture 120 may include a first plate (e.g., a bottom plate) configured to receive the cell stack 110 thereon and a set of arms extending from opposing edges of the first plate at a substantially orthogonal angle (e.g., 90°±10°) relative to the first plate. The fixture 120 may further include a second plate (e.g., a top plate) configured to be coupled to ends of each of the set of arms opposite the first plate such that the cell stack 110 may be secured between the first and second plate. In some embodiments, the first plate may serve as an alignment aid during insertion of the electrochemical cells 110a. In some embodiments, parallel cell stacks 110 may be placed using the vertical openings of the fixture 120. For example, the set of arms of the fixture 120 may include vertical spaces or slots therebetween such that the cell stack 110 may be grasped through the vertical spaces as the cell stack 110 is lowered onto the first plate, and/or to allow air flow.

In some embodiments, the fixture 120 may be configured to fit substantially tightly within the housing 160 (i.e., in contact with walls of the housing 160) to limit vibration risk of the cell stack 110. For example, the first plate may be configured to contact a bottom of the housing 160, the second plate may be configured to contact a top of the housing 160, and each side of the fixture may be configured to contact each sidewall of the housing 160 such that the fixture 120 is secured in place. In some embodiments, there may be a clearance or gap between sidewall of the housing 160 and the fixture. In such embodiments, fixture may be secured within the housing via fasteners (e.g., screws, nuts, bolts, etc.) and/or standoffs and/or alignment features may be provided within the housing 160 for positioning and/or securing the fixture 120 and thereby, the cell stack 110 within the housing 160. In some embodiments, a compressive force may be exerted on the cell stack 110 by the first and second plates. For example, once the cell stack 110 is disposed on the first plate, the second plate may be compressed to a pre-determined position and fixed to the first plate, or the electrochemical cell stack may be pre-compressed before positioning between the first and second plates and the spacing between the first and second plates is such that a compressive force is maintained on the cell stack by the first and second plates by inhibiting expansion of the electrodes of the cells included in the cell stack. The second plate may be fixed to the first plate using a variety of methods including, but not limited to welding, mechanical fasteners (e.g., screws, nuts, bolts, rivets), adhesive, snap fitting, etc. Securing the second plate to the first plate may secure the cell stack 110 and may improve interfacial contact between cathodes, separators, and anodes between the electrochemical cells 110a in the cell stack 110.

In some embodiments, the fixture 120 may be configured to apply a compressive force to the cell stack 110 of at least about 0 pounds per square inch (psi), at least about 1 psi, at least about 2 psi, at least about 3 psi, at least about 4 psi, at least about 5 psi, at least about 6 psi, at least about 7 psi, at least about 8 psi, at least about 9 psi, at least about 10 psi, at least about 11 psi, at least about 12 psi, at least about 13 psi, at least about 14 psi, at least about 15 psi, at least about 16 psi, at least about 17 psi, at least about 18 psi, at least about 19 psi. In some embodiments, the fixture 120 may be configured to apply a compressive force to the cell stack 110 of no more than about 20 psi, no more than about 19 psi, no more than about 18 psi, no more than about 17 psi, no more than about 16 psi, no more than about 15 psi, no more than about 14 psi, no more than about 13 psi, no more than about 12 psi, no more than about 11 psi, no more than about 10 psi, no more than about 9 psi, no more than about 8 psi, no more than about 7 psi, no more than about 6 psi, no more than about 5 psi, no more than about 4 psi, no more than about 3 psi, no more than about 2 psi. In some embodiments, the fixture 120 may be configured to apply a compressive force in a range of about 0 psi to about 20 psi, inclusive of all ranges and subranges therebetween. In some embodiments, the fixture 120 may be configured to apply a compressive force between about 0 psi to about 7 psi, inclusive of all ranges and subranges therebetween.

In some embodiments, the fixture 120 may further include a compliant material (e.g., a polymer) configured to be disposed between one or more of the electrochemical cells 110a in the cell stack 110, between cell substacks in the cell stack 110, and/or on the outer faces of the cell stack 110. In some embodiments, the compliant material may include an elastomer such as, for example, silicone, neoprene, rubber, urethane, foam, etc. In some embodiments, the fixture 120 may be formed from a rigid material. For example, the fixture 120 may be formed from or include any suitable material including, but not limited to, a metal, an alloy, a plastic, a polymer, or any other suitable material or combination thereof. In some embodiments, the fixture 120 may include a metal such as iron, aluminum, stainless steel, carbon steel, galvanized steel, copper, brass, zinc, titanium, tin, or any other suitable metal, or a combination thereof. In some embodiments, the fixture 120 may formed from a sheet metal.

In some embodiments, the fixture 120 may further include a first support member and a second support member. In some embodiments, the first support member and the second support member may each be an elongate member (e.g., rods, poles, bar, shaft, rail, etc.) extending substantially orthogonally (e.g., 90°±10°) from the first plate. The first support member may extend from the first side of the first plate, and the second support member may extend from the second side of the first plate opposite the first side. In some embodiments, the first and second support members may include rod stock. In some embodiments, the first and second support members may be configured to couple the fixture 120 to the feedthrough assembly 130, as described in further detail below.

The cell stack 110 may be prepared in a manner that enables pre-charge electrical test and/or formation of the electrochemical cells before the cell stack 110 is disposed in the fixture 120 and/or before the cell stack 110 is disposed in the housing 160. Electrical testing before insertion allows for quality screening and proper pairing of capacities and area specific impedances. Once screening is performed, the cell stack 110 may be coupled to the feedthrough assembly 130.

In some embodiments, the feedthrough assembly 130 may be partially disposed in the housing 160 and configured to electrically connect the electrochemical cell(s) 110a to an electrical component at least partially external to the housing 160. In some embodiments, the feedthrough assembly 130 may include one or more conductive arms configured to align with and contact a tab of a corresponding electrochemical cell 110a or a set of electrochemical cells 110a (i.e., a cell substack). The feedthrough assembly 130 may include any suitable number of conductive arms such that each electrochemical cell 110a, or set of electrochemical cells 110a included in a substack, may be electrically connected or coupled to a respective conductive arm. In some embodiments, the feedthrough assembly 130 may include 1 conductive arm, 2 conductive arms, 3 conductive arms, 4 conductive arms, 5 conductive arms, 6 conductive arms, 7 conductive arms, 8 conductive arms, 9 conductive arms, 10 conductive arms, 11 conductive arms, 12 conductive arms, 13 conductive arms, 14 conductive arms, 15 conductive arms, 16 conductive arms, 17 conductive arms, 18 conductive arms, 19 conductive arms, 20 conductive arms, 30 conductive arms, 40 conductive arms, 50 conductive arms, 60 conductive arms, 70 conductive arms, 80 conductive arms, 90 conductive arms, 100 conductive arms, inclusive of all ranges and subranges therebetween. In some embodiments, the feedthrough assembly 130 may include about 8 conductive arms. In some embodiments, the conductive arm may include a busbar.

The feedthrough assembly 130 may further include one or more feedthrough connectors, each feedthrough connector coupled to a respective conductive arm and configured extend through a wall of the housing to electrically couple a tab of a corresponding electrochemical cell 110a (or set of electrochemical cells) to an electrical component external to the housing 160. In some embodiments, each conductive arm may be configured to articulate (e.g., rotate, slide, move, or otherwise displace) about the feedthrough connector or along with the feedthrough connector, to selectively contact and be electrically coupled to a corresponding tab. For example, each of the conductive tabs may be in first angular orientation when the feedthrough assembly 130 is coupled to the fixture 120 or cell stack 110, in which the conductive arm is distal from a corresponding tab. Once the feedthrough assembly 130 is coupled to the fixture or cell stack 110, each conductive arm can be rotated until each conductive arms is proximate to and contacts the respective tab so as to be electrically coupled thereto.

In some embodiments, the feedthrough connector(s) may define a first threaded cavity and a second threaded cavity. In some embodiments, the first threaded cavity may be inside the inner volume defined by the housing 160, and the second threaded cavity may be outside of the inner volume defined by the housing 160. In some embodiments, the feedthrough connector(s) may define a central region that may at least partially span a wall of the housing 160. In some embodiments, the feedthrough connector(s) may include a cylindrical member defining the first and second threaded cavity and an annular member (e.g., a washer such as a tab washer, lock washer, spring washer, fender washer, etc.) disposed about the cylindrical member. In some embodiments, each feedthrough connector may be coupled to a respective conductive arm to form a feedthrough subassembly. In some embodiments, each feedthrough connector may be coupled to the respective conductive arm via an at least partially threaded fastener (e.g., stud, bolt, stud bolt, or screw), a first end of the stud configured to be coupled to the conductive arm and a second end of the stud configured to be disposed in the first threaded cavity of the feedthrough connector.

In some embodiments, at least one of the conductive arm and the feedthrough connector may be formed via molding. In some embodiments, the conductive arm may be welded to at least a portion of the threaded fastener such that the threaded fastener extends from the conductive arm. In some embodiments, a securement member (e.g., a spring washer, a lock washer, etc.) may be disposed about the threaded fastener and between the conductive arm and the feedthrough connector to help fasten the feedthrough connector to the conductive arm (e.g., prior to welding the threaded fastener to the conductive arm). In some embodiments, the securement member may be any suitable material including copper, brass, steel, etc. Alternatively, or additionally, the feedthrough connector may be any suitable connector such as a rivet and/or a gasket. In some embodiments, the electrochemical cell(s) 110a may be prismatic cells, and the assembly 100 may use pre-assembled lid assemblies. In some embodiments, the feedthrough assembly may include a glass to metal feedthrough. In some embodiments, each feedthrough subassembly may be electrically isolated from other feedthrough subassemblies in the assembly 100. The feedthrough subassemblies may be sealed to a portion of the housing 160 to hermitically seal the assembly 100 and ensure isolation of different parallel and series electrochemical cell connections.

In some embodiments, the assembly 100 may include a number of feedthrough connectors of at least 1 feedthrough connector, 2 feedthrough connectors, 3 feedthrough connectors, 4 feedthrough connectors, 5 feedthrough connectors, 6 feedthrough connectors, 7 feedthrough connectors, 8 feedthrough connectors, 9 feedthrough connectors, 10 feedthrough connectors, 11 feedthrough connectors, 12 feedthrough connectors, 13 feedthrough connectors, 14 feedthrough connectors, 15 feedthrough connectors, 16 feedthrough connectors, 17 feedthrough connectors, 18 feedthrough connectors, 19 feedthrough connectors, 20 feedthrough connectors, 30 feedthrough connectors, 40 feedthrough connectors, 50 feedthrough connectors, 60 feedthrough connectors, 70 feedthrough connectors, 80 feedthrough connectors, 90 feedthrough connectors, 100 feedthrough connectors, inclusive of any ranges and subranges therebetween.

In some embodiments, the feedthrough assembly 130 may further include one or more feedthrough plates configured to cover a portion of the fixture 120 and/or the housing 160. In some embodiments, each feedthrough plate may define one or more apertures configured to receive a portion of a corresponding feedthrough connector therethrough. For example, each feedthrough plate may define a first aperture and a second aperture. In some embodiments, the first and second apertures may be configured such that a portion of a respective feedthrough connector may be disposed through each feedthrough plate in a horizontal direction. In some embodiments, when the feedthrough connector is disposed through an aperture of the feedthrough plate, the conductive arm may be substantially aligned (e.g., at least partially in contact with) a respective tab of an electrochemical cell 110a or set of electrochemical cells 110a.

In some embodiments, the first aperture may be configured to receive a feedthrough connector coupled to a conductive arm that is in turn in contact with an anode tab, and the second aperture may be configured to receive a feedthrough connector coupled to a conductive arm that is in turn in contact with a cathode tab. In some embodiments, when the feedthrough connector is disposed through the aperture of the feedthrough plate, a length of the conductive arm may be configured to extend horizontally along (e.g., substantially parallel to) an inner surface of the feedthrough plate. In some embodiments, the feedthrough plate may include a first portion (e.g., a top portion) and a second portion (e.g., bottom portion) configured to be coupled together to define the first and second aperture. In some embodiments, the first and second portions of the feedthrough plate may be coupled together using any suitable method such as, for example, snap fitting, welding, adhesive, and/or thermal bonding, or any other suitable method.

In some embodiments, the feedthrough plate may further define two or more additional apertures configured to receive the first and second support members from the fixture 120, for example, to facilitate alignment and/or coupling of the feedthrough plates to the fixture 120. In some embodiments, the two or more additional apertures may be configured such that the first and second support members are disposed therethrough in a vertical direction. The support members may help position the feedthrough plates and feedthrough subassemblies for welding to a cover or lid of the housing 160. In some embodiments, the support members may provide support as well as locating features during insertion into the housing 160 and can serve as internal rigid structures to reduce risk from shock and vibration.

In some embodiments, the assembly 100 may include a plurality of feedthrough plates, each feedthrough plate corresponding to a respective electrochemical cell 110a or set of electrochemical cells 110a of cell stack 110. The feedthrough plates may be configured to position and secure the feedthrough connectors, the conductive arms, and/or the tabs. In some embodiments, the plurality of feedthrough plates may be configured to stack together (e.g., on top of one another and/or side by side) such that when the feedthrough plates are coupled to the fixture 120 and the feedthrough connectors are disposed through each of the first and second apertures, the conductive arms may align with a respective electrochemical cell 110a or set of electrochemical cells. For example, the first and second support members may be disposed through the two or more additional apertures such that the feedthrough plates may be slid down the support members and stacked on top of one another to align the apertures, and therefore the feedthrough subassemblies, with a corresponding electrochemical cell 110a or set of electrochemical cells 110a.

The assembly 100 may include a number of feedthrough plates in the range of 1 to about 50, inclusive of all ranges and subranges therebetween. In some embodiments, the assembly 100 may include a number of feedthrough plates of at least 1 feedthrough plate, 2 feedthrough plates, 3 feedthrough plates, 4 feedthrough plates, 5 feedthrough plates, 6 feedthrough plates, 7 feedthrough plates, 8 feedthrough plates, 9 feedthrough plates, 10 feedthrough plates, 11 feedthrough plates, 12 feedthrough plates, 13 feedthrough plates, 14 feedthrough plates, 15 feedthrough plates, 16 feedthrough plates, 17 feedthrough plates, 18 feedthrough plates, 19 feedthrough plates, 20 feedthrough plates, 30 feedthrough plates, 40 feedthrough plates, 50 feedthrough plates, 60 feedthrough plates, 70 feedthrough plates, 80 feedthrough plates, 90 feedthrough plates, 100 feedthrough plates, inclusive of any ranges and subranges therebetween. In some embodiments, the assembly 100 may include 4 feedthrough plates configured to be stacked on top of one another. In some embodiments, the conductive arm, the feedthrough connector, and/or the threaded fasteners may include any suitable conductive material such as, for example, metal, alloys, glass, polymer, etc. Alternatively, or additionally, the feedthrough assembly 130 may further include any other suitable conductive member configured to withdraw electrical output from one or more of the electrochemical cell(s) 110a including, for example, a wire, cable, and/or tab.

In some embodiments, the electrochemical cell subassembly (hereinafter, “cell subassembly”), e.g., including the cell stack 110 disposed in the fixture 120 and coupled to the feedthrough assembly 130, may be disposed into the housing 160. The housing 160 can be formed from a strong and rigid material. In some embodiments, the housing 160 can be formed from iron, aluminum, stainless steel, carbon steel, galvanized steel, alloys, plastics, polymers, any other suitable material, or a combination thereof. In some embodiments, the housing 160 may be coated with corrosion or flame resistance material (e.g., TEFLON®, nylon, aluminum oxide, titanium oxide, corrosion and/or flame resistance paint, etc.). In some embodiments, the housing 160 may be configured to be hermetically sealed after the cell subassembly is disposed therein. In some embodiments, the housing 160 may include an aluminum sheet (e.g., a 2 mm 3003 aluminum sheet) that can be bent and laser welded together. In some embodiments, the housing 160 may be tested for hermeticity prior to assembly. In some embodiments, the housing 160 can be formed from aluminum and may be laser welded to provide a hermetically sealed enclosure. In some embodiments, sidewalls of the housing 160 may have a thickness between about 0.5 mm to about 10 mm, inclusive of all ranges and subranges therebetween.

The housing 160 may have any suitable shape such as, for example, a rectangle, square, oval, circular, any other suitable shape or a combination thereof. The housing 160 may define an opening through which the stack subassembly may be inserted into the internal volume of the housing 160. For example, the housing 160 may include a sleeve including four side walls and a bottom piece monolithically formed, and a cover plate or lid configured to cover the opening. In some embodiments, a support material (e.g., padding, securement material, biasing material, etc.), may be infilled when the cell subassembly is placed inside of the housing 160. After the cell subassembly is disposed inside the housing 160, the cover plate may be hermetically welded to the rest of the housing 160 (e.g., the sleeve). In some embodiments, the cover plate may define one or more apertures configured to receive a portion of a respective feedthrough connector. In some embodiments, the feedthrough connector may either be hermetically welded (e.g., via laser welding) to the cover plate or semi-hermetically sealed with the cover plate using a sealant. In some embodiments, the sealant may include a polymer material such as a polymer gasket. The housing 160 may be configured to reduce permeation therethrough to only the feedthrough portions (e.g., through a space between the feedthrough connector and the housing 160) on the cover plate. In some embodiments, the housing 160 may be configured to accommodate conventional prismatic electrochemical cells. In some embodiments, the cover plate may further include one or more standoff arms coupled thereto and configured to be coupled to an external electronic circuitry such as a controller (e.g., a BMS, printed circuit board (PCB)). In some embodiments, the one or more standoff arms may be pre-welded to the cover plate.

In some embodiments, a second threaded fastener (e.g., screw, bolt, stud bolt, or stud) may be disposed in the second threaded cavity outside the inner volume of the housing 160. In some embodiments, the second threaded fastener may include any suitable material including brass and/or copper. In some embodiments, the second threaded fastener may be configured to secure a contact pad to the cover plate. Each contact pad may be conductive and configured to electrically connect the feedthrough connector to the external electronic circuitry. In some embodiments, a washer (e.g., lock washer) may be used to further secure the second threaded fastener and the contact pad to the cover plate. In some embodiments, a pad size and orientation may depend on the design of the controller, for example, a shape or size thereof. Depending on the application of use, terminal contact pads can be fastened or welded to the isolated terminals and electrically connected to the controller which can be mounted directly to the cover plate.

In some embodiments, the controller may be coupled to the standoff arms of the cover plate of the housing 160. The standoff arms may extend away from the cover of the housing 160 to create a clearance or a space between the controller and conductive materials on the cover plate (e.g., the terminal pads). In some embodiments, a rigid controller cover or lid is sealed to the cover plate using fasteners and gaskets to protect the terminals from liquids. The electrical connection to the end terminals through this cover is entirely flexible and can depend on a user's needs. In some embodiments, the standoff arms may be further configured to couple the cover to the housing 160 with the BMS therebetween. In some embodiments, the controller cover or lid may define one or more apertures such that one or more electrical connectors (e.g., wires, cables, etc.) may be disposed therethrough and coupled to an external component.

In some embodiments, the housing 160 including the stack subassembly may be disposed in an external casing 180. The external casing 180 may include at least two terminals 190 disposed on an outside of the external casing. In some embodiments, the controller may be coupled to the terminals 190 such that electrical energy from each electrochemical cell 110a may accessed at the terminals 190 outside of the external casing 180.

In some embodiments, the external casing 180 may have a width in a range of about 100 millimeters (mm) to about 300 mm, inclusive of all ranges and subranges therebetween. In some embodiments, the external casing 180 may have a width of about 180 mm to about 200 mm, inclusive. In some embodiments, the external casing 180 may have a depth in a range of about 100 mm to about 400 mm, inclusive of all ranges and subranges therebetween. In some embodiments, the depth of the external casing 180 may be about 260 mm to about 280 mm, inclusive. In some embodiments, the external casing 180 may have a height in a range of about 80 mm to about 300 mm, inclusive of all ranges and subranges therebetween. In some embodiments, the height of the external casing 180 may be about 140 mm to about 160 mm, inclusive.

In some embodiments, a total weight of the external casing 180 without the cell subassembly disposed therein may be in a range of about 0.1 kg to about 10 kg, inclusive of all ranges and subranges therebetween. In some embodiments, the total weight of the external casing 180 may be about 0.5 kg to about 1 kg, inclusive. In some embodiments, the assembly 100 may be configured to be used to power a vehicle, and therefore, the external casing 180 may be configured to accommodate size and power needs of the vehicle. For example, the dimensions and/or power output of the assembly 100 may correspond to dimensions of the vehicle configured to receive the assembly 100. In some embodiments, the assembly 100 may reduce manufacturing costs, reduce size of the assembly, may increase reliability, and utilize greener chemistry.

In some embodiments, a number of weld locations in an assembly 100 including 8 feedthrough subassemblies may be in a range of about 1 to about 1,000, inclusive of all ranges and subranges therebetween.

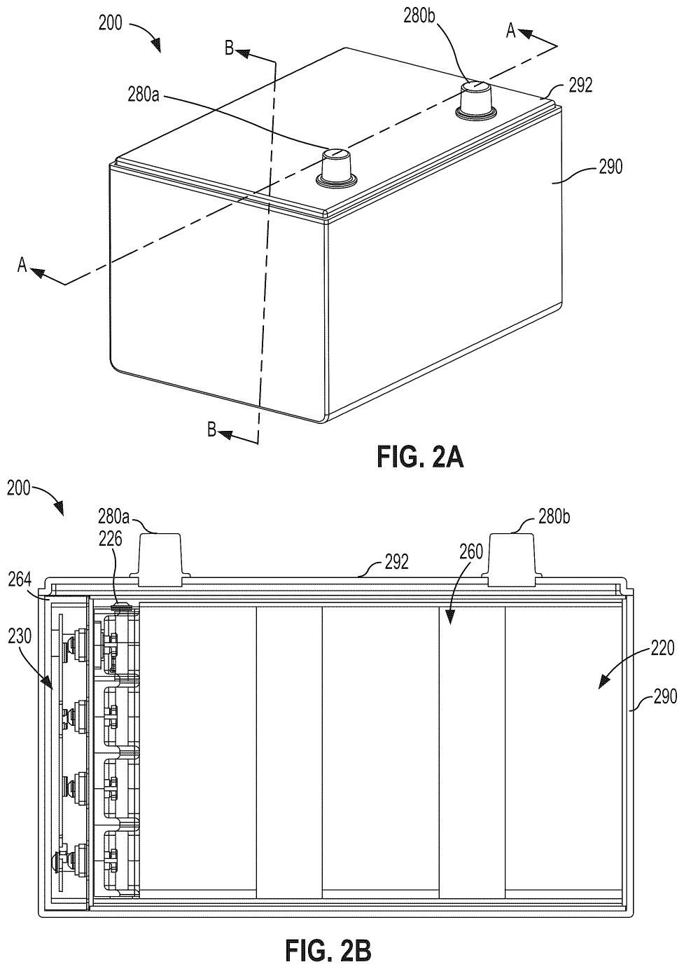

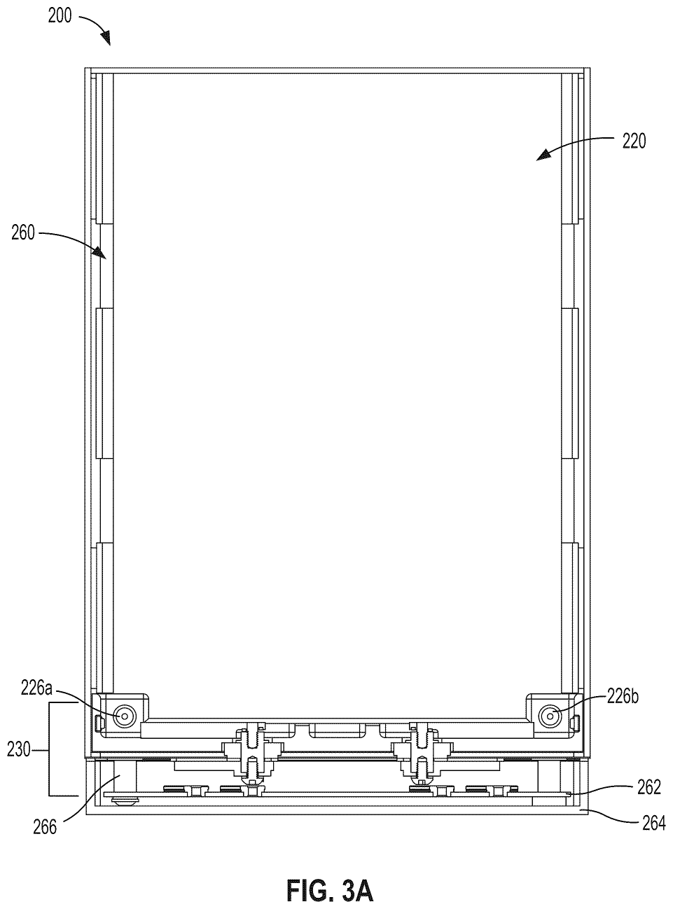

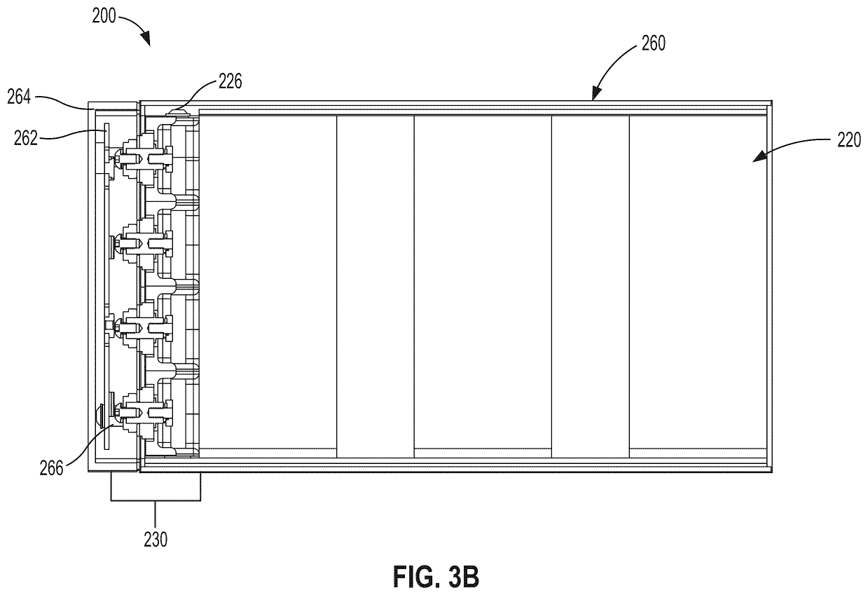

FIG. 2A is a perspective view of an electrochemical cell assembly 200 (also referred to herein as “assembly 200”) showing an external casing 290 including electrical terminals 280a, 280b, according to an embodiment. As shown, the external casing 290 includes a negative terminal 280a and a positive terminal 280b disposed on an outer surface of the external casing 290 (e.g., a top surface 292 of the external casing 290). FIG. 2B is a cross-sectional view of the assembly 200 taken along the line A-A shown in FIG. 2A. The assembly 200 may be structurally and/or functionally similar to the assembly 100, and therefore certain aspects of the assembly 200 are not described in further detail herein. The assembly 200 may include an electrochemical cell stack (also referred to herein as “cell stack”) disposed in a fixture 220 and coupled to a feedthrough assembly 230 to form a cell subassembly. A controller may be coupled to the cell stack via the feedthrough assembly 230, and a controller cover 264 may be disposed thereon to protect the controller. The cell subassembly may be disposed in a housing 260, and the housing 260 may be disposed in the external casing 290. As shown, the housing 260 and the controller cover 264 may be configured to contact sides of the external casing 290 to prevent vibration or movement of the cell subassembly. FIGS. 3A-3B show a top view and a side cross-sectional view taken along the line B-B shown in FIG. 2A, respectively, of the assembly 200 without the external casing 290. The feedthrough assembly 230 may be coupled to the fixture 220 via two vertical support elements 226a, 226b. One or more standoff arms 266 may couple the controller 262 to the cell subassembly with a predetermined clearance.

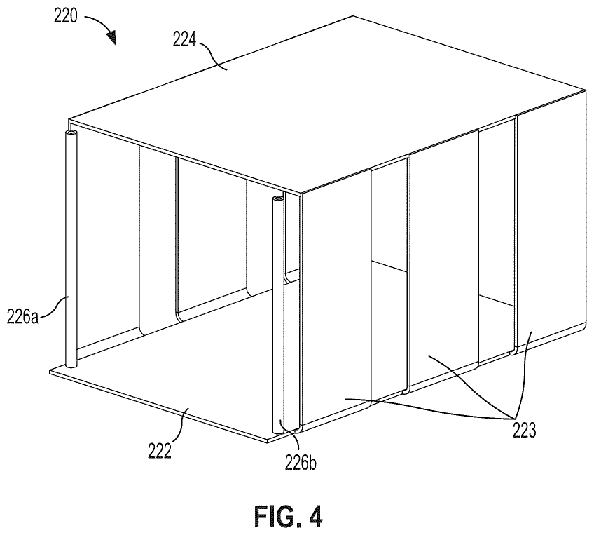

FIG. 4 shows the fixture 220, which is configured to receive the cell stack. The fixture 220 may define an inner space configured to receive the cell stack and secure and/or apply a compressive force on the cell stack. As shown in FIG. 4, the fixture 220 may include a first plate (e.g., a bottom plate) 222 configured to receive the cell stack thereon and a set of arms 223 extending from opposing edges of the bottom plate 222 at a substantially orthogonal angle (e.g., 90°±10°) relative to the bottom plate 222. The set of arms 223 may include a first set of three arms extending from a first edge of the bottom plate 222 and a second set of three arms extending from a second edge of the bottom plate 222 opposite the first edge, and aligned with the first set (e.g., extending parallel to the first set of three arms and aligned therewith). In some embodiments, parallel cell stacks may be placed using the vertical openings of the fixture 220. For example, the set of arms 223 of the fixture 120 may include vertical spaces or slots therebetween such that the cell stack may be grasped through the vertical spaces as the cell stack is lowered onto the bottom plate 222, and/or to allow air flow.

The fixture 220 may further include a second plate (e.g., a top plate) 224 configured to be coupled to ends of each of the plurality of arms 223 opposite the bottom plate 223 such that the cell stack may be secured between the top plate 224 and the bottom plate 222. In this way, the fixture 220 may be configured to apply a uniaxial pressure or compressive force to the cell stack along a vertical axis between the top and bottom plates 224, 222. For example, once the cell stack is disposed on the bottom plate 222, the top plate 224 may be compressed to a pre-determined position and fixed to the plurality of arms 223, and therefore the bottom plate 222, or the cell stack may be pre-compressed before positioning between the top and bottom plates 224, 222 and the spacing between the top and bottom plates 224, 222 is such that a compressive force is maintained on the cell stack by the top and bottom plates 224, 222 by inhibiting expansion of the electrodes of the cells included in the cell stack. The top plate 224 may be fixed to the bottom plate 222 using a variety of methods including, but not limited to welding, mechanical fasteners (e.g., screws, nuts, bolts, rivets, etc.), adhesive, snap fitting, etc. Securing the top plate 224 to the bottom 222 plate may secure the cell stack and may improve interfacial contact between cathodes, separators, and anodes between the electrochemical cells in the cell stack. In some embodiments, the plurality of arms 223 may include a rigid material to support the cell stack and to help maintain the compressive force to the cell stack within a predetermined range.

In some embodiments, the fixture 220 may further include a compliant material (e.g., a polymer) configured to be disposed between one or more of the electrochemical cells in the cell stack, between cell substacks in the cell stack, and/or on the outer faces of the cell stack. In some embodiments, the compliant material may include an elastomer such as, for example, silicone, neoprene, rubber, urethane, foam, etc. In some embodiments, the fixture 220 may be formed from a rigid material. For example, the fixture 220 may be formed from or include any suitable material including, but not limited to, a metal, an alloy, a plastic, a polymer, or any other suitable material or combination thereof. In some embodiments, the fixture 220 may include a metal such as iron, aluminum, stainless steel, carbon steel, galvanized steel, copper, brass, zinc, titanium, tin, or any other suitable metal, or a combination thereof. In some embodiments, the fixture 220 may formed from a sheet metal.

In some embodiments, the fixture 220 may include the first support member 226a and the second support member 226b coupled to the bottom plate 222 of the fixture 220. As shown, the first support member 226a and the second support member 226b may each include an elongate member (i.e., a rod or pole) extending orthogonally from the bottom plate 222. As shown, the first support member 226a extends from a corner of the first side of the bottom plate 222, and the second support member 226b extends from a corner of the second side of the bottom plate 222 plate opposite the first side, but may be located at any suitable location on the fixture. In some embodiments, the first and second support members 226a, 226b members may include rod stock. In some embodiments, the first and second support members 226a, 226b may define an aperture or throughhole (e.g., a threaded aperture or throughhole) configured to receive a fastener (e.g., a screw, bolt, river, etc.) for coupling the feedthrough assembly 230 to the fixture 220.

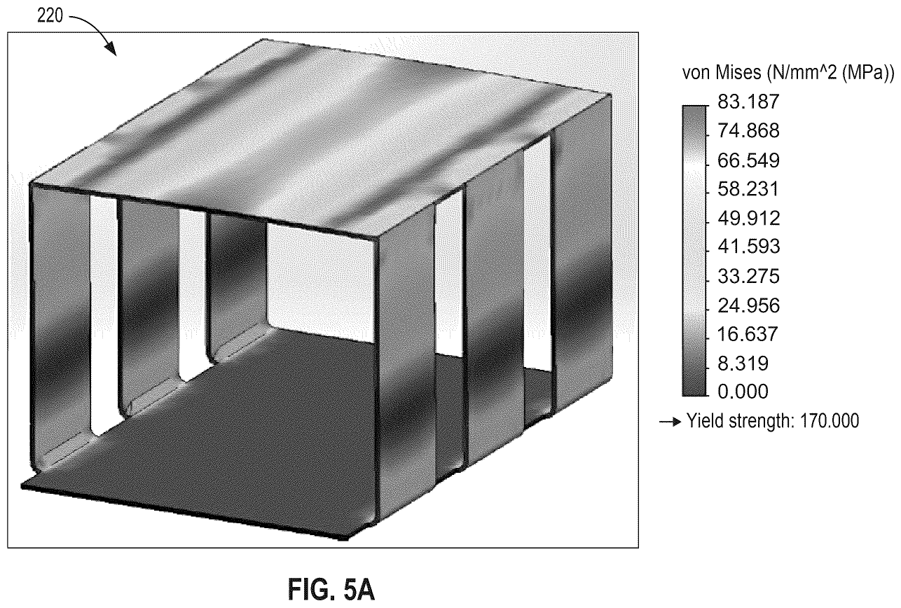

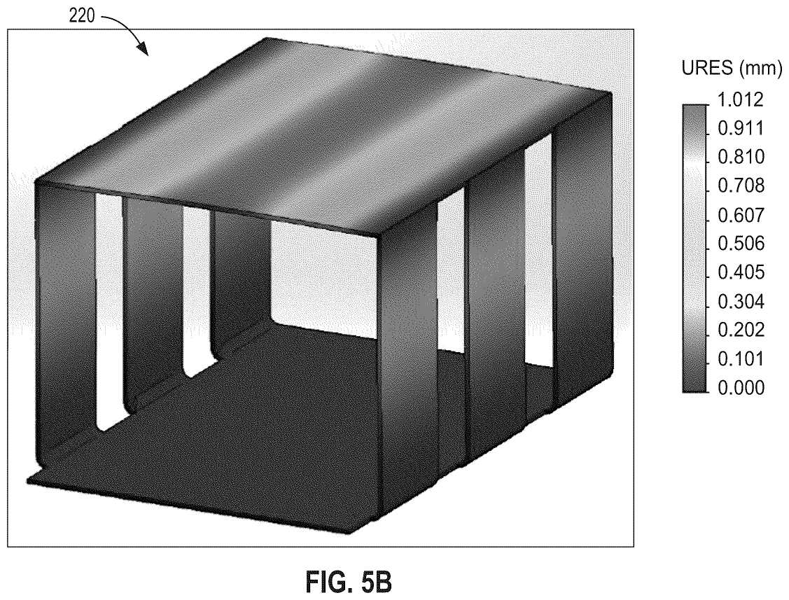

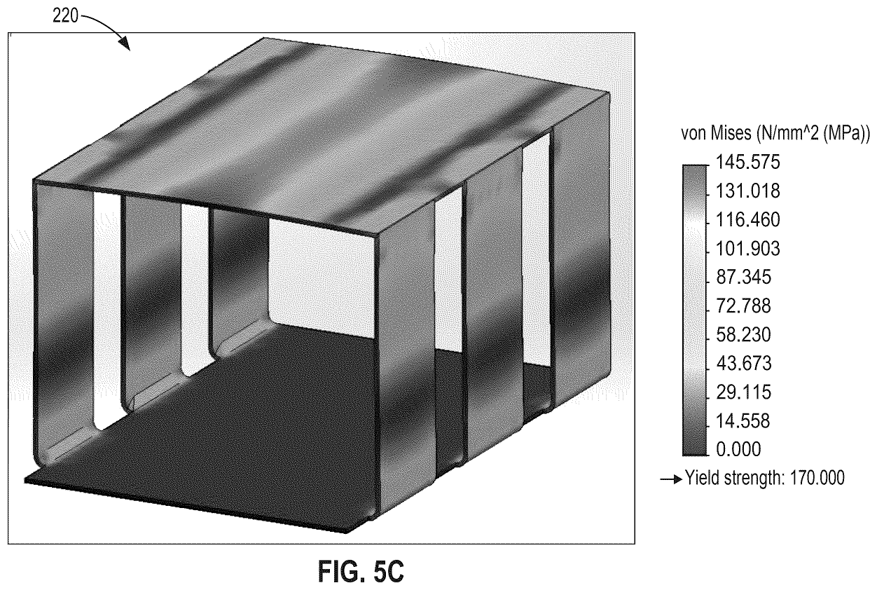

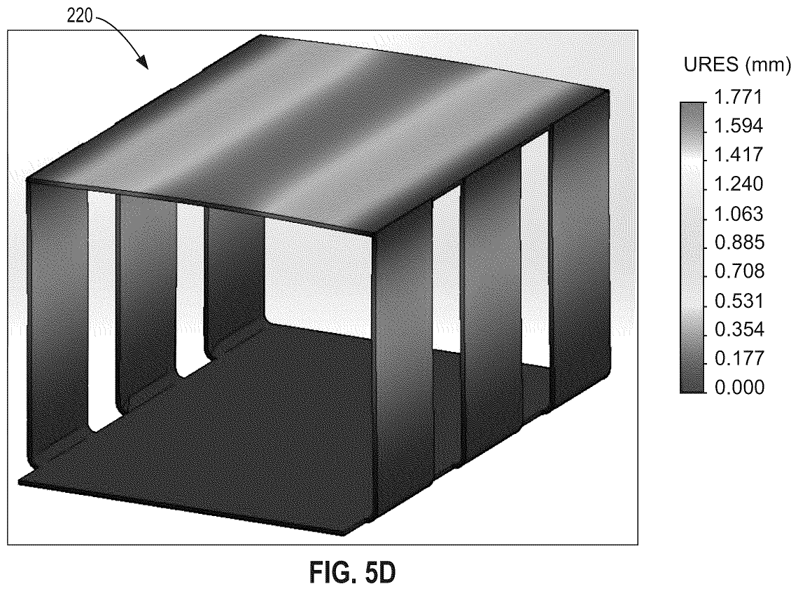

FIGS. 5A-5B show FEA model data of stress and displacement obtained from aa 3D model of the fixture 220, respectively. As shown in FIG. 5A, a stress on the top plate 224 is highest along a center section of the top plate 224. The stress on the set of arms 223 is highest near a top end of each arm of the set of arms 223. A yield strength of the fixture 220, i.e., a maximum level of stress that may be applied to the fixture 220 before the fixture 220 permanently deforms and/or fractures, is about 170 N/mm². In some embodiments, the yield strength of the fixture 220 may be in a range of about 100 N/mm² to about 250 N/mm², inclusive of all ranges and subranges therebetween. As shown in FIG. 5B, a displacement resulting from the stress applied to the fixture 220 is between about 0 mm (e.g., near the edges of the top plate 224) and 1.012 mm (e.g., near the center section of the top plate 224).

FIGS. 5C-5D show FEA modeling data of stress and displacement data, respectively, resulting from a second stress test on the modeled fixture 220. Similar to the modeling data shown in FIGS. 5A-5B, the stress on the fixture 220 is highest along a enter section of the top plate 224 and a top end of each arm of the set of arms 223. The displacement resulting from the stress applied to the fixture 220 is between about 0 mm to about 1.771 mm.

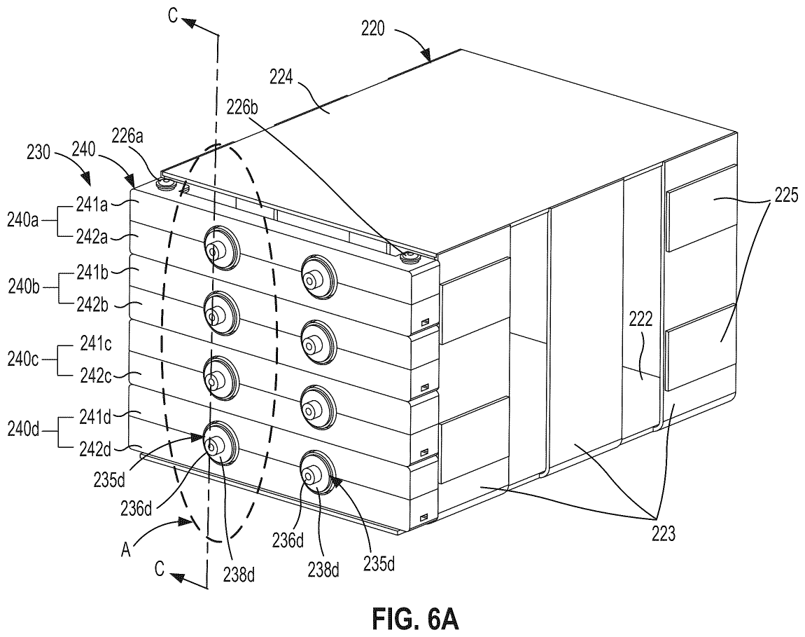

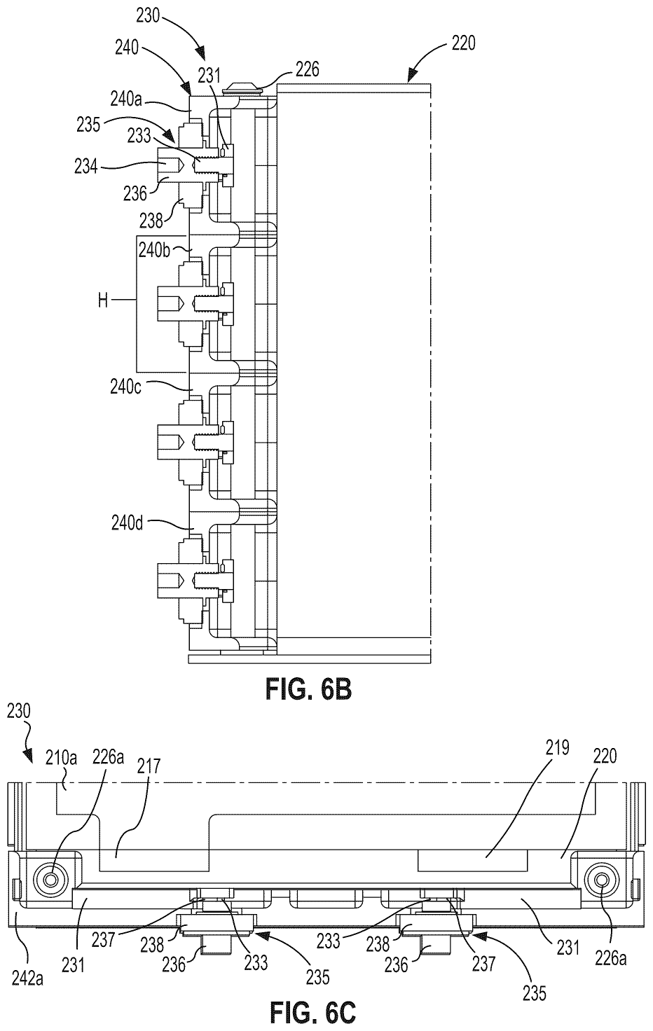

FIG. 6A shows the fixture 220 coupled to the feedthrough assembly 230 to form the cell subassembly. As shown, the feedthrough assembly 230 includes a set of feedthrough plates 240 including a first feedthrough plate 240a, a second feedthrough plate 240b, a third feedthrough plate 240c, and a fourth feedthrough plate 240d. Each feedthrough plate 240a-240d may include a first portion 241a, 241b, 241c, 241d configured to be coupled to a corresponding second portion 242a, 242b, 242c, 242d to form the feedthrough plates 240a-240d. The feedthrough plates 240a-240d may be stacked together to form a continuous plate structure. In some embodiments, a top and/or a bottom surface of each of the feedthrough plates 240a-240d may be welded to an adjacent feedthrough plate to seal the regions at which the feedthrough plates 240a-240d contact one another. While shown as including four feedthrough plates 240a-240d, the feedthrough assembly 230 may include any number of feedthrough plates, for example, 2, 3, 4, 5, 6, 7, 8, 9, 10, or even more.

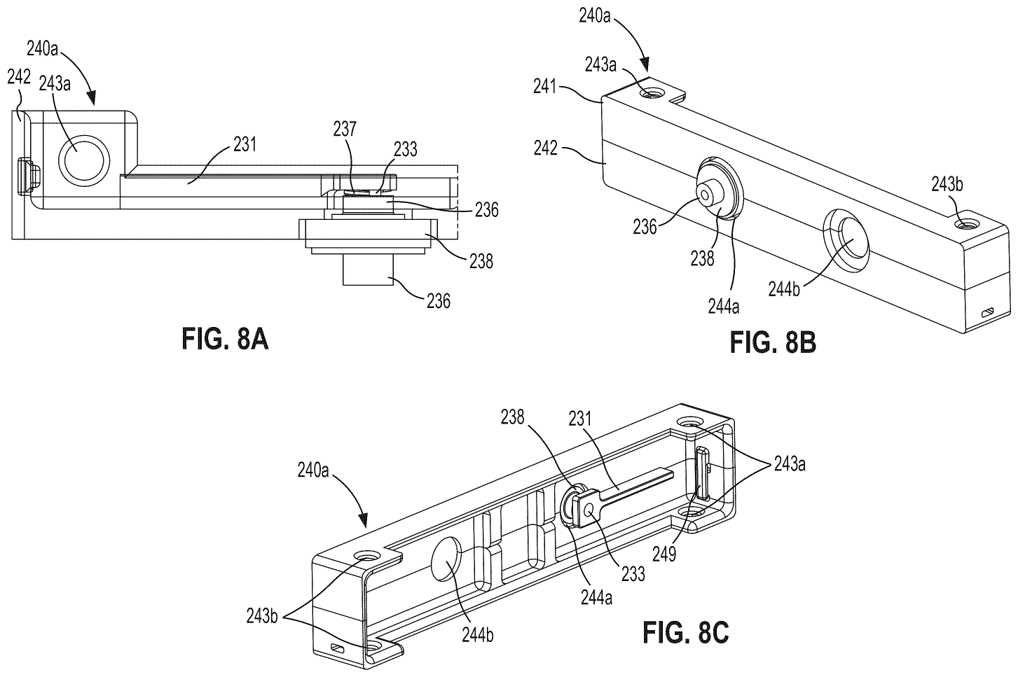

The feedthrough plates 240 may include a first set of apertures, each aperture of the first set of apertures may be configured to receive a respective feedthrough subassembly such that a portion of each feedthrough connector (e.g., feedthrough connector 235) is accessible from outside the cell subassembly (e.g., the side facing away from the fixture 220 and cell stack (not shown)), described in further detail below with respect to FIGS. 8A-8C. As shown, the set of feedthrough plates 240 are collectively configured to receive 8 feedthrough subassemblies. While FIG. 6A shows the feedthrough subassemblies arranged in two parallel vertical columns, it should be appreciated that the feedthrough subassemblies may be arranged in any suitable arrangement such that the conductive arms of the feedthrough subassemblies align with tabs or terminal ends of respective cells or cell substacks in the cell stack.

The feedthrough plates 240 may additionally include a second set of apertures configured to align with, and receive the first and second support members 226a, 226b of the fixture 220 therethrough. The feedthrough plates 240 may be slid over the first and second support members 226a, 226b to position the feedthrough plates 240a-240d relative to the inner space of the fixture 220, and therefore position the feedthrough plates 240a-240d relative to the cell stack when the cell stack is disposed therein. A top end of each of the first and second support members 226a, 226b may be configured to receive a mechanical fastener (e.g., a bolt, screw, etc.) to secure the feedthrough plates 240a-240d in position. In embodiments described herein where a fastener is used to connect or secure components (e.g., support members 226a and 226b), it should be understood that alternative securing methods may be employed. In some embodiments, a weld (e.g., a resistance weld) may be applied to a stopper element, or the support members may be plastically deformed (e.g., bent) to a locking position, thereby eliminating the need for separate fasteners. In some embodiments, the stopper elements may be positioned at and around top portion of the support members,

In some embodiments, one or more arms 223 of the fixture 220 may include one or more compliance structures 225 on an outer surface thereof. The one or more compliance structures 225 may be configured to be disposed between an outer surface of a respective arm 223 and an inner surface of the housing 260 when the electrochemical cell subassembly is disposed in an inner volume of the housing 260. The compliant structure 225 may be configured to absorb vibration or shock impulses that may occur when the assembly 200 is moved abruptly, or to comply with the inner surface of corresponding walls of the housing 260 to secure the fixture 220 within the housing 260. In some embodiments, the bottom plate 222 and/or the top plate 224 may also include compliance structures 225.

FIGS. 6B shows a side cross-sectional view of a portion of the electrochemical cell assembly 200 indicated by the arrow A and taken along the line C-C shown in FIG. 6A. As shown, the feedthrough plates 240a-240d have been disposed along the support members 226a, 266b (e.g., the support members 226 have been disposed through the second set of apertures) and stacked to be in contact with one another. Additionally, the feedthrough connectors (e.g., feedthrough connector 235) have been disposed through the first set of apertures defined by a front side of the feedthrough plates (e.g., feedthrough plate 240a). The feedthrough connector 235 may include a cylindrical portion 236 and an annular portion 238 disposed about the cylindrical portion 236. In some embodiments, the cylindrical portion 236 and the annular portion 248 may be monolithically formed or continuous. In some embodiments, the annular portion 238 may be coupled to the cylindrical portion 236 via welding, friction fitting, adhesive, etc. The cylindrical portion 236 defines a first cavity positioned on an inside of the feedthrough plates 240a (e.g., the side facing toward the fixture 220 and cell stack (not shown)) and a second cavity 234 positioned on an outside of the feedthrough plates 240. A first threaded fastener 233 may be disposed in the first cavity and coupled to the conductive arm 231.

As shown, each aperture from the first set of apertures may be positioned near a vertical center point of each of each of the feedthrough plates 240a-240d such that when the feedthrough connector 235 and conductive arm 231 are coupled to a corresponding feedthrough plate 240a, 240b, 240c, or 240d, thereto are substantially centered vertically relative to the respective feedthrough plates 240a. In some embodiments, each module or cell substack and each feedthrough plate 240a-240d may have heights (e.g., denoted as H in FIG. 6B) corresponding to one another such that the vertical center point of each feedthrough plate 240a-240d, and a position of the conductive arm 231, vertically aligns with at least a portion of a tab extending from a respective module or cell substack.

FIG. 6C is a top view of the portion indicated by the arrow A showing alignment of an electrochemical cell or cell substack with a portion of the feedthrough assembly 230. As shown, the first set of apertures for the feedthrough plate 240a includes a first aperture disposed proximate to a first side of the feedthrough plate 240a, and a second aperture disposed proximate to a second side of the feedthrough plate 240b opposite the first side. The first aperture and the second aperture may be positioned at a predetermined distance from the first and second side respectively, such that when the feedthrough connector 235 is disposed therethrough, the conductive arm 231 coupled to the feedthrough connector 235 is aligned horizontally with at least a portion of a tab 217, 219 of an electrochemical cell 210a or cell substack.

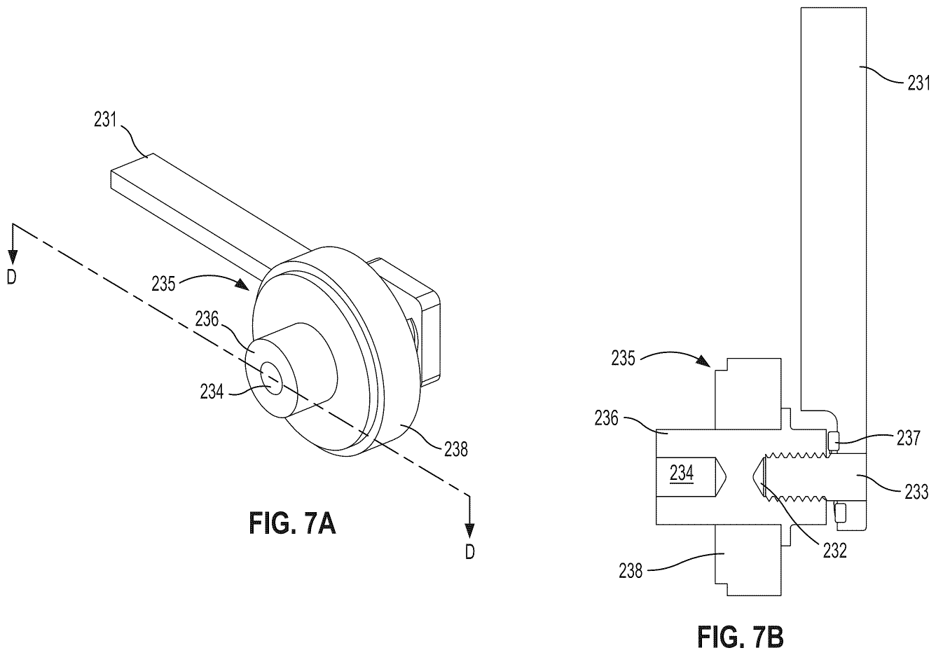

FIGS. 7A shows a perspective view of the conductive arm 231 coupled to the feedthrough connector 235, thereby forming the feedthrough subassembly. FIG. 7B shows a top cross-sectional view of the conductive arm 231 taken along the line D-D shown in FIG. 7A. As shown in FIGS. 7A-7B, when the conductive arm 231 and feedthrough connector 235 are coupled together, the conductive arm 231 extends from the cylindrical portion 236 of the feedthrough connector 235 perpendicularly (or substantially perpendicularly) relative a longitudinal axis of the cylindrical portion 236. The first threaded fastener 233 may be disposed in the first cavity 232 defined by the cylindrical portion 236 of the feedthrough connector 235. In some embodiments, a securement member 237 (e.g., a spring washer, a lock washer, etc.) may be disposed about the first threaded fastener 233 and between the conductive arm 231 and the feedthrough connector 235 to help fasten the cylindrical portion 236 of the feedthrough connector 235 to the conductive arm 231 (e.g., prior to welding the first threaded fastener 233 to the conductive arm 231).

FIGS. 8A is a top view, FIG. 8B is a top, front perspective view, and FIG. 8C is a top, rear perspective view of a feedthrough plate 240a defining a first set of apertures 244a, 244b through which feedthrough subassemblies may be disposed. A first aperture 244a from the first set of apertures and the second aperture 244b from the first set of apertures are substantially aligned vertically on the feedthrough plate 240a. The first aperture 244a may be disposed closer to a first end of the feedthrough plate 240a, and the second aperture 244b may be disposed closer to a second end of the feedthrough plate 240b such that the first aperture 244a may be aligned with a first tab, and the second aperture 244b may be aligned with a second tab.

As shown in FIGS. 8A and 8B, the first aperture 244a and the second aperture 244b each include a first portion having a first radius and a second portion having a second radius smaller than the first radius. The first radius may correspond to a radius of the annular portion 238 of the feedthrough connector 235 and the second radius may correspond to a radius of the cylindrical portion 236 of the feedthrough connector 235. In other words, the first portion may be a groove or indent defined around a rim of the apertures 244a, 244b, that cooperatively form a groove shaped and sized to receive a portion of the annular portion 238 of the feedthrough connector 235 such that the annular portion 238 can be seated therein. Moreover, the second radius may allow the cylindrical portion 236 to be disposed therethrough, but may not allow the annular portion 238 to be disposed therethrough. As such, the feedthrough connector 235, and therefore the conductive arm 231, may be maintained in a predefined position relative to the feedthrough plate 240a. As shown in FIG. 8A, a portion of the conductive arm 231 may be in contact with and extend along an inner surface of the of the feedthrough plate 240a. The second set of apertures defined by the feedthrough plate 240a may include a first pair of vertical apertures 243a on a first side and a second pair of vertical apertures 243b on a second side opposite the first side. The first pair of vertical apertures 243a may be configured to receive the first support member 226a, and the second pair of vertical apertures 243b may be configured to receive the second support member 226.

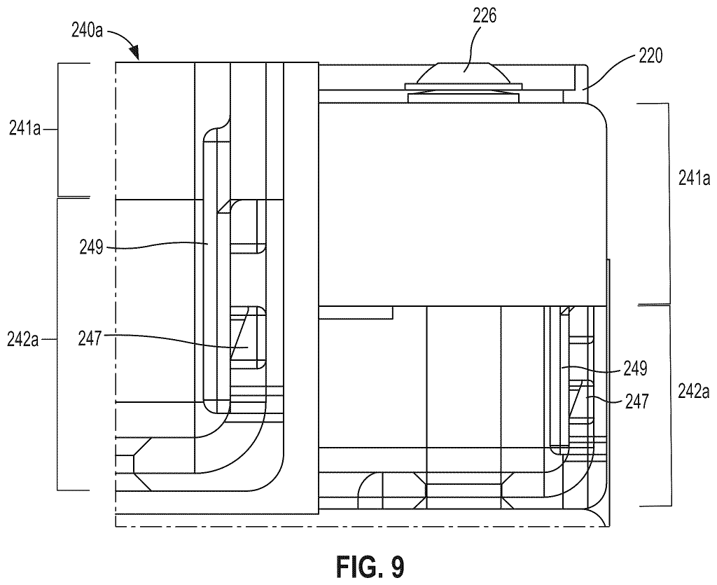

FIG. 9 shows a first portion 241a of the feedthrough plate 240a and a second portion 241b of the feedthrough plate 240a coupled together and secured to the support member 226 of the fixture 220. As shown, the first portion 241a of the feedthrough plate 240a includes a first coupling mechanism 247, 249, and the second portion 242a of the feedthrough plate 240a includes a second coupling mechanism. In some embodiments, the first coupling mechanism 247, 249 and the second coupling mechanism may include shapes that are complimentary to one another. For example, the first coupling mechanism may include an extension 249 extending away from the first portion 241a and engagement member 247 (e.g., a knob, hook, bump, notch, clasp, peg, etc.), and the second coupling mechanism may include a cavity configured to receive the engagement member 247 to facilitate alignment, and/or form a snap fit between the first and second portions 241a, 241b. In some embodiments, after the engagement member 247 is disposed in the cavity of the second portion 242a, the first portion 241a and the second portion 241b may be maintained in contact with another to form the feedthrough plate 240a. In some embodiments, at least a portion of the first and second portions 241a, 242a may be welded together.

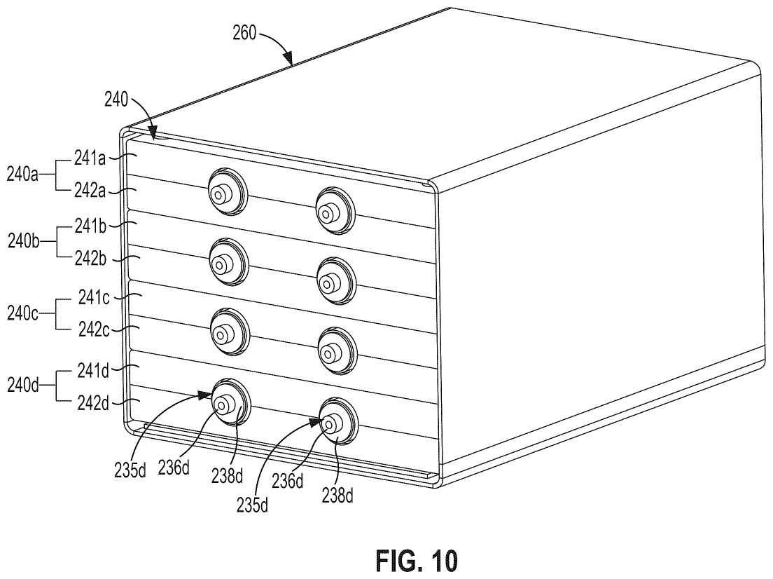

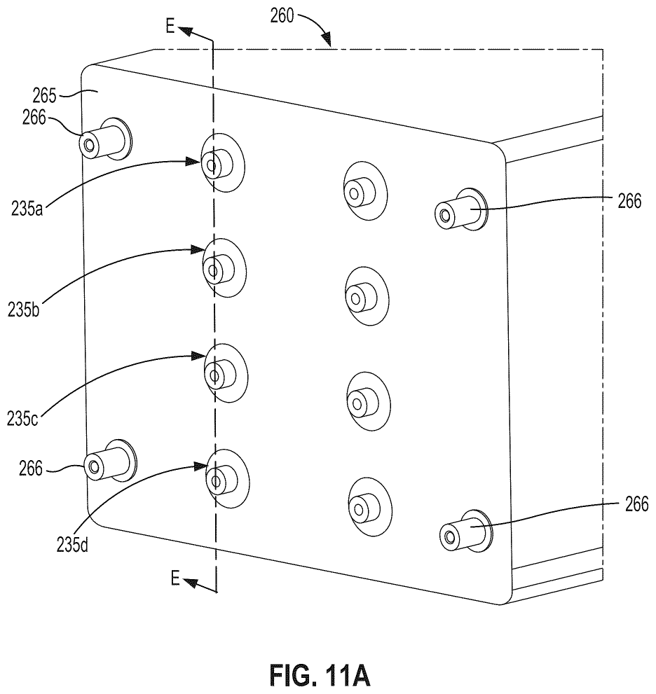

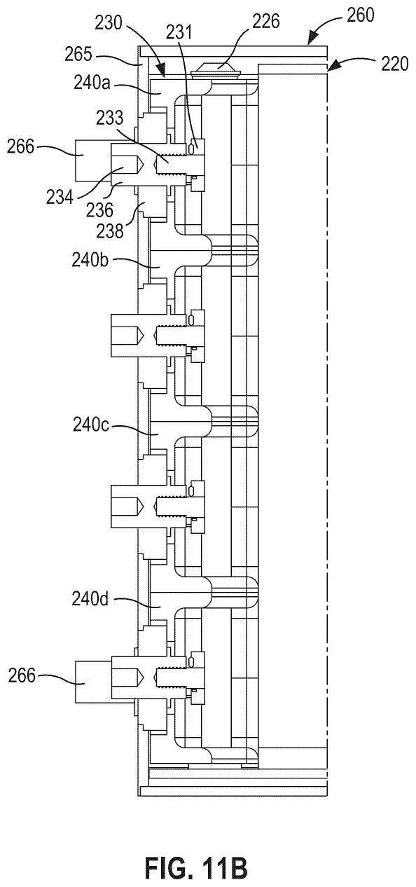

FIG. 10 shows an isometric view of the cell subassembly disposed in the housing 260 such that the set of feedthrough plates 240 cover an opening defined by the housing 260. A portion of the feedthrough connectors (e.g., feedthrough connectors 235d) are accessible from outside the housing 260. FIGS. 11A shows a front perspective view of a portion of the assembly 200 showing a cover plate 265 including 4 standoff arms 266 coupled to the housing 260. In some embodiments, the standoff arms 266 may be pre-welded to the cover plate. In some embodiments, the cover plate 265 may be welded to the housing 260, and the feedthrough connectors 235a, 235b, 235c, 235d may be welded to the cover plate 265 such that the housing 260 is hermetically sealed. FIG. 11B is a side cross-section view of the portion of the assembly 200 taken along the line E-E shown in FIG. 11A. As shown, the feedthrough connectors 235a-235d are disposed through respective apertures defined by the cover plate 265 and may be accessible from outside of the housing 260 and cover plate 265. When the cover plate 265 is coupled to the housing 260, the cover plate 265 and the annular portion 238a-238d of each feedthrough connector 235a-235d may be configured to form a flat surface (e.g., the annular portion 238a-238d of the feedthrough connector) may lay flush with an outer surface of the cover plate 265.

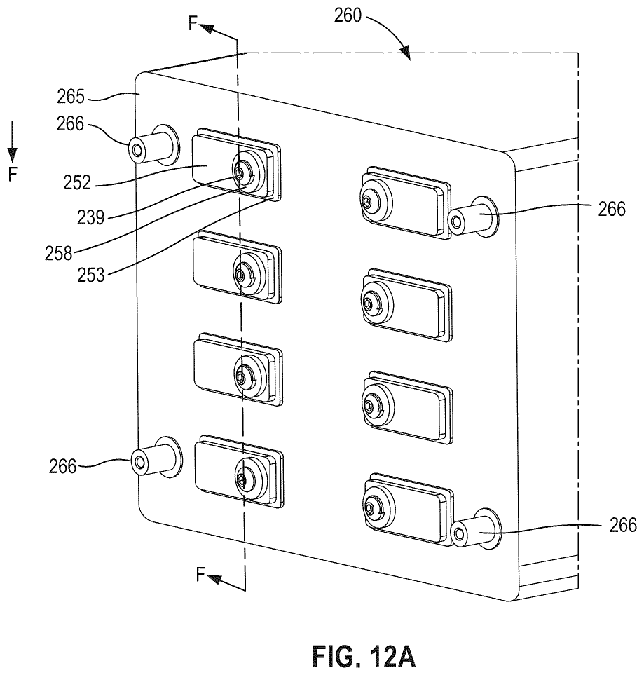

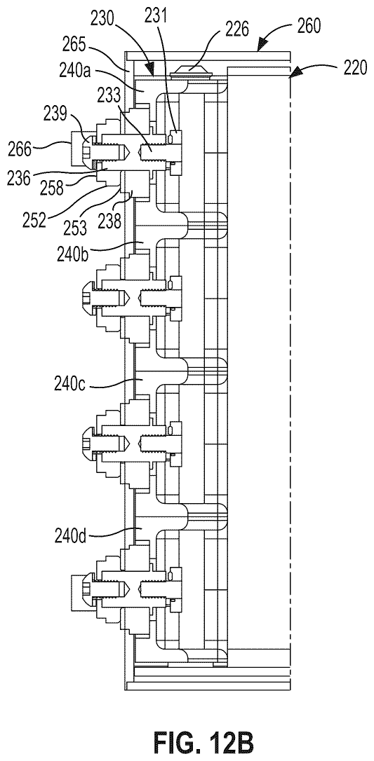

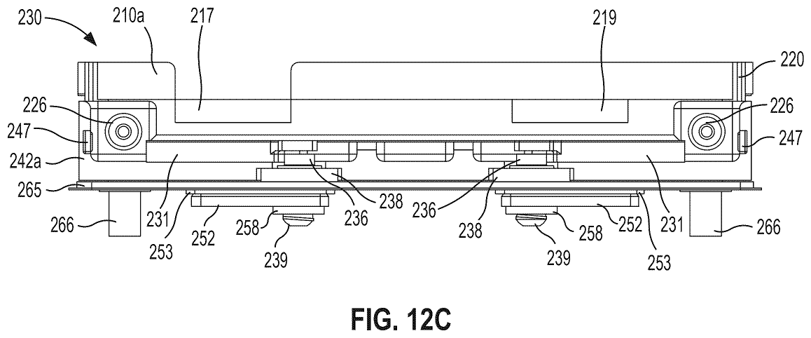

FIGS. 12A-12C show a portion of the assembly 200 showing the cover plate 265 with contact pads 252 coupled via the feedthrough connectors 235 and a set of threaded fasteners 239 disposed in the opening defined by the feedthrough connector 235 to fasten the contact pads 252 to the cover plate 265. As shown in FIG. 12B, a second threaded fastener 239 (e.g., screw, bolt, stud bolt, stud, etc.) may be disposed in the second threaded cavity of the cylindrical portion 236 of the feedthrough connector 235. The second threaded cavity may be disposed outside the inner volume of the housing 260. In some embodiments, a securement plate 253 and the contact pad 252 may be disposed about the cylindrical portion 236 with the securement plate 253 disposed between the contact pad 252 and the cover plate 265. The securement plate 253 may be configured to provide hermetic sealing around corresponding openings in the cover plate 265, and/or serve as compliance members. The contact pad 252 may include a raised portion 258 configured to fit under a head of the second threaded fastener 239 to help secure the contact pad 252 in place on the cover plate 265. In some embodiments, the contact pad 252 may not include a raised portion 258, and a washer (e.g., lock washer) may alternatively be used to further secure the contact pad 252 to the cover plate 265.

Depending on the application of use, contact pads 252 can be fastened or welded to the isolated terminals and electrically connected to the controller which can be mounted directly to the cover plate 265. In some embodiments, the housing 260 is hermetically sealed between the cylindrical portion 236 of the feedthrough connector 235 and the cover plate 265, and the components outside of the cover plate 265 (e.g., the contact pads 252 and external portion of the feedthrough connector) may not be welded to one another. In some embodiments, any one of or all of the components outside of the cover plate 265 may be welded. Each contact pad 252 may be conductive and configured to electrically connect the feedthrough connector 235 to the external electronic circuitry (e.g., the controller). In some embodiments, a pad size and orientation may depend on the design of the controller, for example, a shape or size thereof.

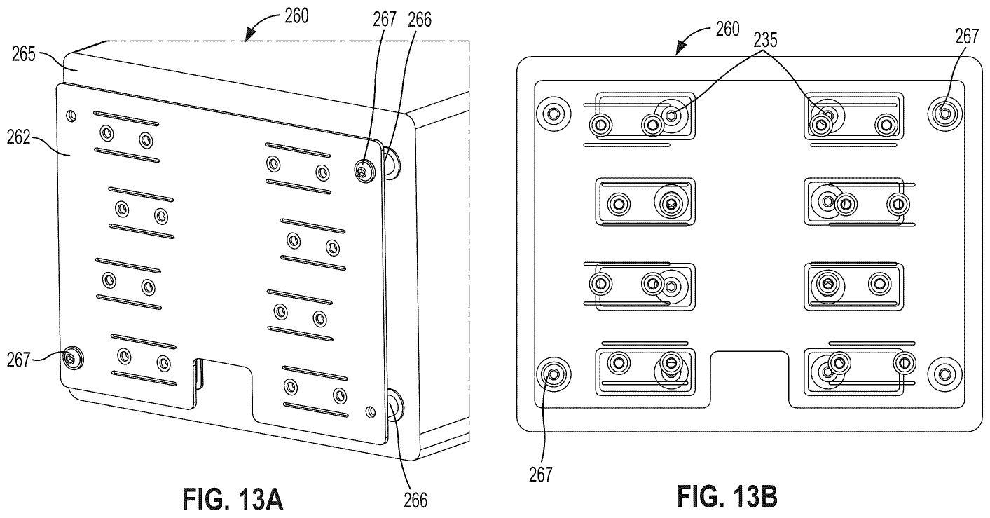

FIGS. 13A is a top, front perspective view, and FIG. 13B is a front view of a controller 262 coupled to the standoff arms 266 of the cover plate 265. The controller 262 may include electronic circuitry, for example, a battery management system (BMS) that may include one or more printed circuit boards (PCB), processors, transistors, logic circuits, memory, etc., and may be coupled to the housing 260 via the standoff arms 266. The standoff arms may extend away from the cover plate 265 of the housing 260 to create a clearance or a space between the controller 262 and conductive materials on the cover plate (e.g., the contact pads 252) (e.g., to inhibit shorts, and/or allow air flow). As shown, the controller 262 may be fastened to the standoff arms 266 via fasteners 267 (e.g., screws) configured to be received by a cavity defined by the standoff arms 266. The fasteners 267 may include a first fastener coupled to a standoff arm 266 in a first corner of the cover plate 265 and a second fastener coupled to a standoff arm 266 disposed in a second corner diagonal from the first corner.

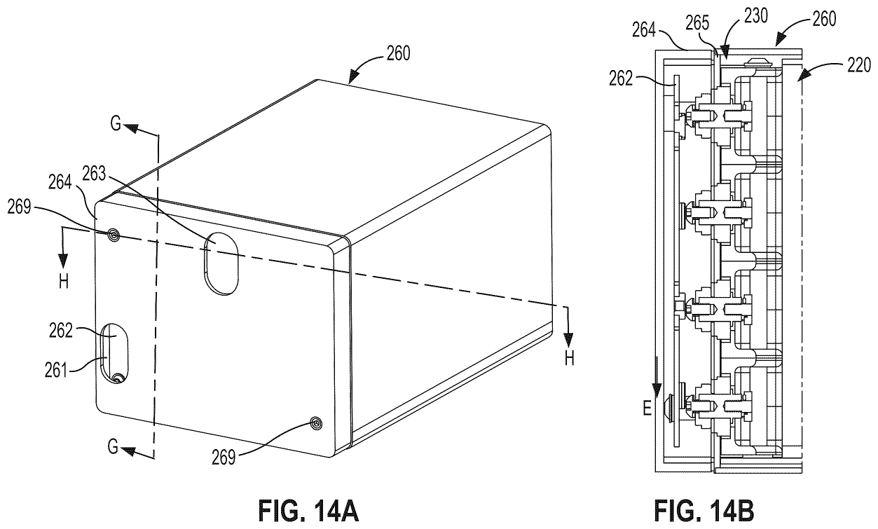

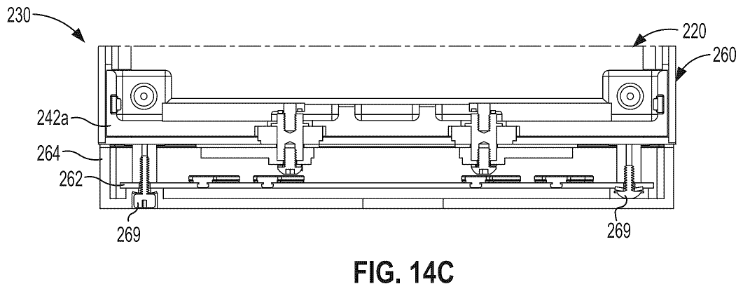

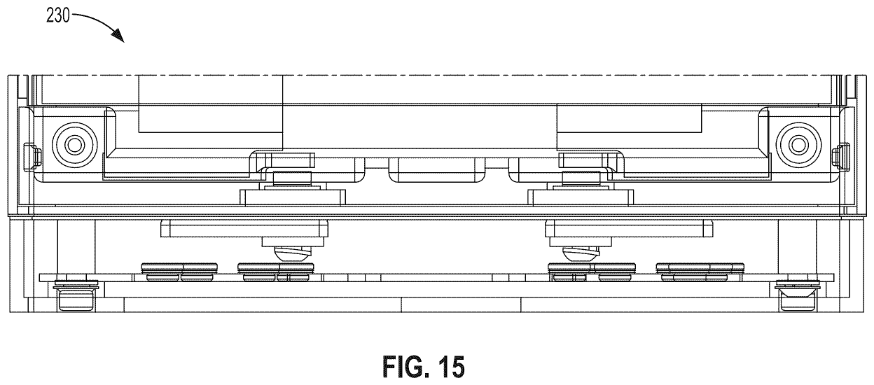

FIGS. 14A-14C show the assembly 200 including a controller cover 264 coupled to the housing 260 over the controller 262. The controller cover or lid 264 may include a rigid material to protect the controller 262 and may be sealed to the cover plate 265 using fasteners or gaskets 269 to protect the terminals from liquids or mechanical damage during handling. The standoff arms may be configured to couple the controller cover 264 to the housing 260 with the controller 262 therebetween. The gaskets 269 may include a first gasket coupled to a standoff arm 266 disposed in a third corner of the cover plate 265 and a second gasket coupled to a standoff arms 266 disposed in a fourth corner diagonal from the third corner. The controller cover 264 may define a first opening 261 and a second opening 263 such that electrical connectors (e.g., wires, cables, etc.) may be disposed therethrough to electrically connect the controller 262 to the electrical terminals (not shown). The electrical connection to the electrical terminals through the controller cover 264 is flexible and can depend on a user's needs. In some embodiments, the controller cover 264 may be welded to the housing 260. In some embodiments, the controller cover 264 may not be welded to the housing 260. FIG. 15 shows a transparent top view of the feedthrough assembly 230 coupling the electrochemical stack to the controller. As shown, the standoff arms extend away from the cover plate such that the controller may fit in a space defined by the controller cover without contacting the contact pads.

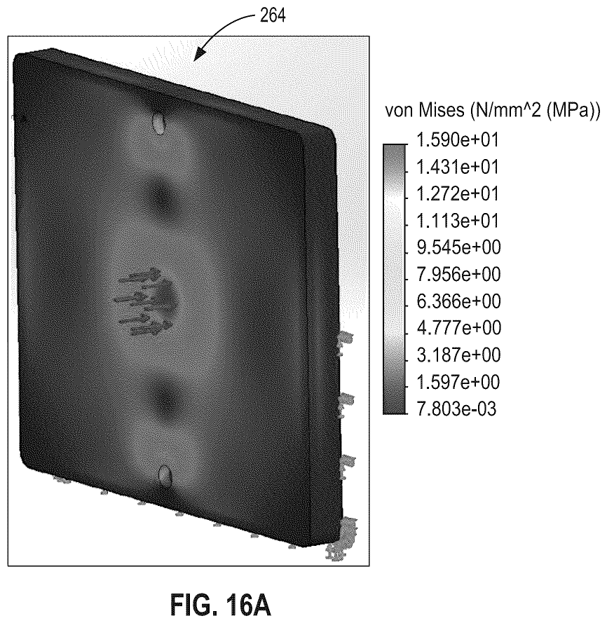

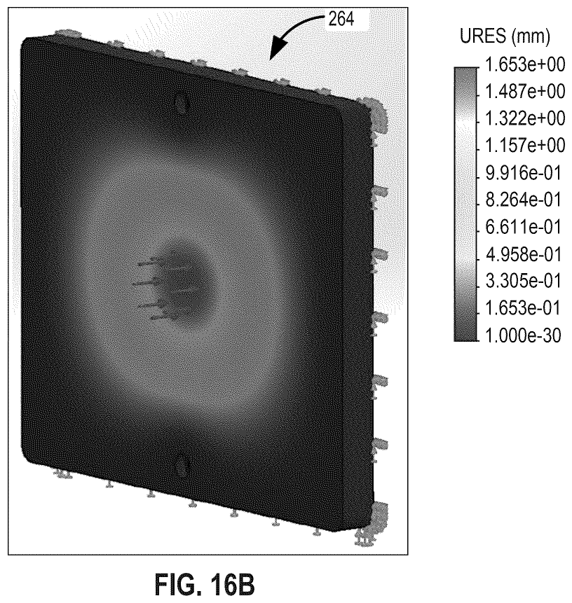

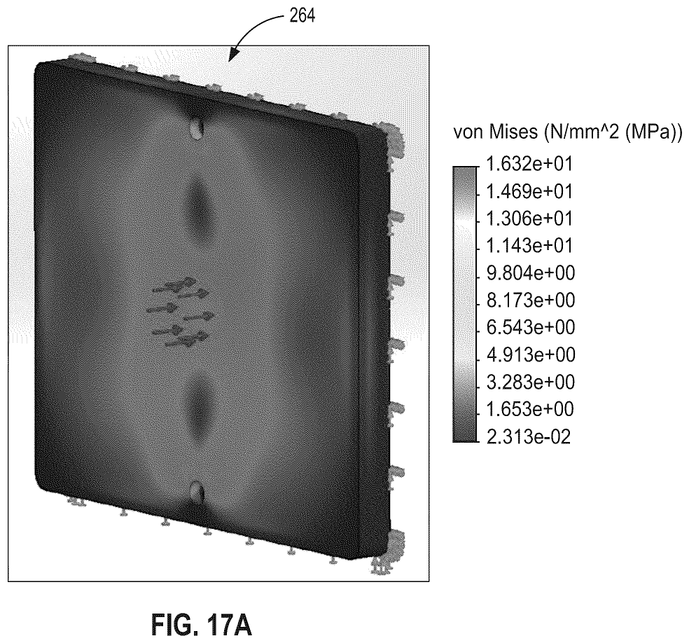

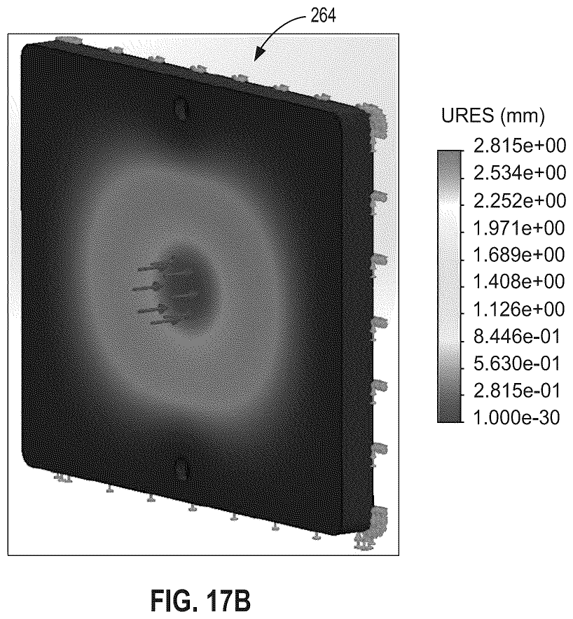

FIGS. 16A-16B show FEA model of stress and displacement data, respectively, experienced by a modeled controller cover 264. As shown in FIG. 16A, a maximum stress on the controller cover 264 is at a center region of the controller cover 264. A direction of the force acting on the controller cover 264 is shown by the arrows (i.e., toward the inner volume of the housing 260 when the controller cover 264 is coupled to the housing). There are two additional peaks in stress directly above and below the center region showing maximum stress resulting from the force. The maximum stress at the center region is about 1.590e⁺¹. As shown in FIG. 16B, a displacement resulting from the stress applied to the controller cover 264 is between about 0 mm (e.g., near the edges of the top plate 224) and 1.63 mm (e.g., at the center region of the controller cover 264). FIGS. 17A-17B show FEA models of stress and displacement data, respectively, resulting from a second stress test on the controller cover 264 resulting from force acting on a central region of the modeled controller cover 264. Similarly, the stress on the fixture 220 is highest at a center region of the cover plate 264. The maximum stress at the center region is about 1.632e⁺¹. The displacement resulting from the stress applied to the controller cover 264 is between about 1.000e⁻³⁰ mm to about 2.815 mm.

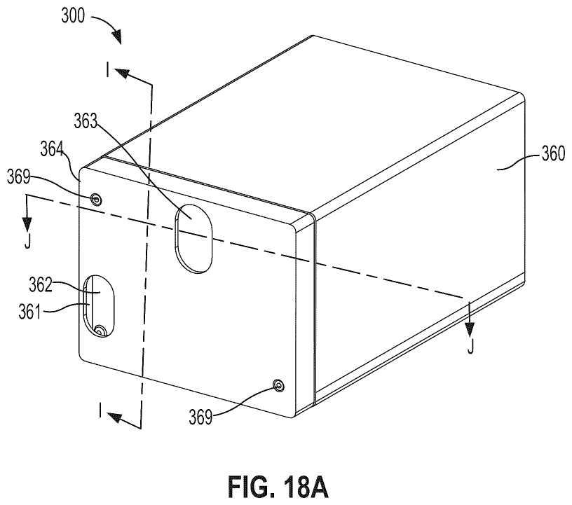

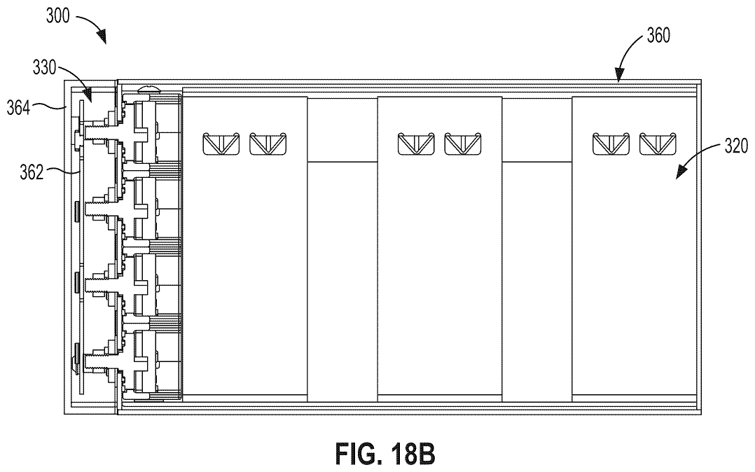

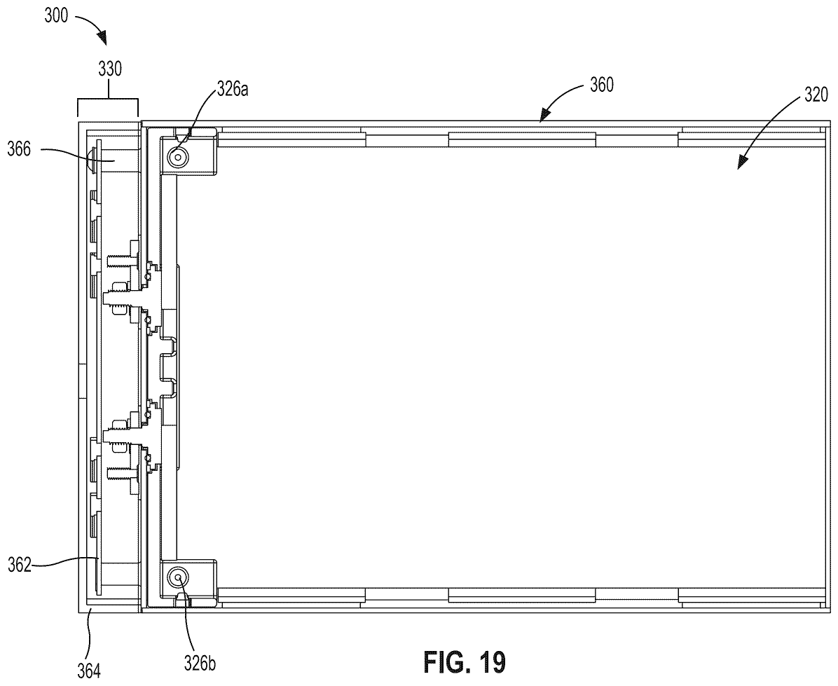

FIG. 18A is a perspective view of an electrochemical cell assembly (hereinafter, “assembly 300”) including a controller cover 364 coupled to a housing 360, according to an embodiment. The electrochemical cell assembly 300 may be structurally and/or functionally similar to the electrochemical cell assembly 100, 200, and therefore, certain details of the electrochemical cell assembly 300 are not described in further detail herein. As shown, the controller cover 364 defines openings 361 and 361 through which the controller 362 may be accessible. The controller cover 364 is coupled to the assembly 300 via one or more fasteners or gaskets 369. FIG. 18B is a cross-sectional view of the electrochemical cell assembly 300 taken along the line I-I shown in FIG. 18A. The assembly 300 may include a cell stack disposed in a fixture 320 and coupled to a feedthrough assembly 330 to form a cell subassembly. The controller 362 may be coupled to the cell stack via the feedthrough assembly 330, and the controller cover 364 may be disposed thereon to protect the controller 362. The cell subassembly may be disposed in the housing 360, and the housing 360 may be disposed in an external casing (not shown). FIG. 19 is a top cross-sectional view taken along the line J-J shown in FIG. 18A. The feedthrough assembly 330 may be coupled to the fixture 320 via two vertical support elements 326a, 326b. One or more standoff arms 366 may couple the controller 362 to the cell subassembly with a predetermined clearance.

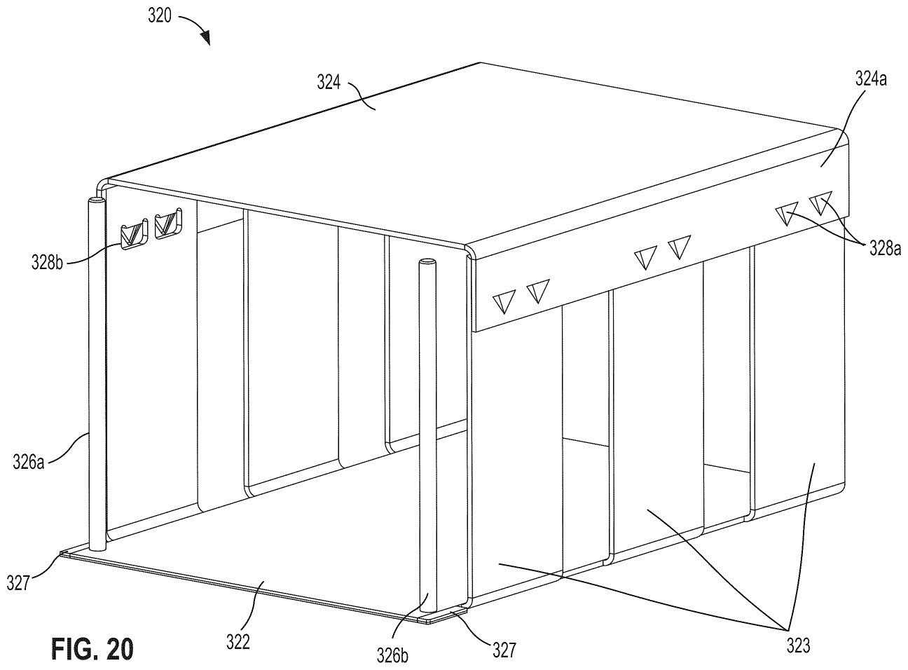

FIG. 20 shows the fixture 320 configured to receive a cell stack, according to an embodiment. As shown, the fixture 320 may define an inner space configured to receive the cell stack and secure and/or apply a compressive force on the cell stack. The fixture 320 may include a first plate (e.g., a bottom plate) 322 configured to receive the cell stack thereon and a set of arms 323 extending from opposing edges of the bottom plate 322 at a substantially orthogonal angle (e.g., 90°±10°) relative to the bottom plate 322. The fixture 320 may further include a second plate (e.g., a top plate) 324 configured to be coupled to ends of each of the plurality of arms 323 opposite the bottom plate 322 such that the cell stack may be secured between the top plate 324 and the bottom plate 322. Fixture 320 may be structurally and/or functionally similar to the fixture 220; however, the fixture 320 may include one or more mechanical fasteners to couple the top plate 324 to the plurality of arms 323. In some embodiments the mechanical fasteners may include one or more snap-fit features to couple the top plate 324 to the plurality of arms 323. In some embodiments, the fixture 320 may include one or more seals (e.g., a gasket) to provide a seal when components are snap-fit together. For example, the fixture 320 may include a seal between the lid 324 and each of the plurality of arms 323.

In some embodiments, the plurality of arms 323 and the top plate 324 may have a portion configured to engage one another to fasten or secure the top plate 324 to the plurality of arms 323. For example, each arm of the plurality of arms 323 may include a surface feature (e.g., one or more indentations, apertures, holes, cut outs, etc.) corresponding to a respective portion of the top plate 324 such that the respective portion of the top plate 324 may be disposed in, on, and/or through the surface feature. In some embodiments, each arm of the plurality of arms 323 includes two surface features each configured to receive a corresponding shape on the top plate 324. For example, as shown in FIG. 20, the top plate 324 may include portions 324a extending orthogonally from transverse edges of the top plate 324 towards the plurality of arms 323 and configured to overlap the arms such that the arms contact or are disposed proximate to corresponding inner surfaces of the portions 324a. Protrusions 328a may be disposed, defined or formed on the portions 324a that extend towards a corresponding arm of the plurality of arms 323 and are configured to be inserted into corresponding apertures 328b defined in the plurality of arms 323, when the top plate 324 is disposed on the plurality of arms 323. The protrusions 328a may engage and snap-fit into corresponding apertures 328b to snap-fit and thereby, secure the top plate 324 to the plurality of arms 323.

In some embodiments, the fixture 320 may include a seal between the surface features of the plurality of arms 323 and the corresponding shapes of the top plate 324. In some embodiments, when the top plate 324 is fixed to the bottom plate 322 via the mechanical fasteners, the fixture 320 may be configured to apply a predetermined compressive force to the cell stack disposed therein. In some embodiments, the surface features may be disposed at a predetermined height along the plurality of arms 323 such that when the top plate 324 is fastened to the plurality of arms 323, there is a predetermined distance between the top plate 324 and the bottom plate 322. In some embodiments, the height of the surface features on the plurality of arms 323 may correspond to a compressive force exerted on the cell stack disposed in the fixture 320. The snap-fit features (e.g., protrusions 328a and apertures 328b) may reduce cost of the cell assembly 300 as well as reduce complexity in the manufacturing process by reducing welding or joining operations. In some embodiments, the fixture 320 may have a small tab 327 on either side of the bottom plate 322 to secure the fixture in the housing 360. The fixture 320 may include a first support member 326a and a second support member 326b configured to couple the fixture 320 to the feedthrough assembly 330.

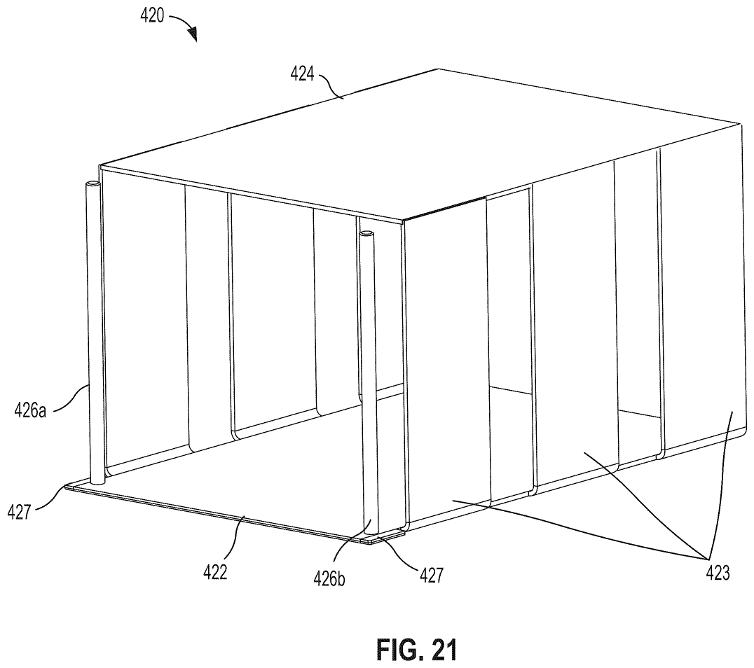

FIG. 21 shows a fixture 420 for receiving an electrochemical cell stack, according to an embodiment. The fixture 420 may include a first plate (e.g., a bottom plate) 422 configured to receive the cell stack thereon and a set of arms 423 extending from opposing edges of the bottom plate 322 at a substantially orthogonal angle relative to the bottom plate 422. The fixture 420 may further include a second plate (e.g., a top plate) 424 configured to be coupled to ends of each of the plurality of arms 423 opposite the bottom plate 422 such that the cell stack may be secured between the top plate 424 and the bottom plate 422. The fixture 420 may include a first support member 426a and a second support member 426b configured to couple the fixture 420 to the feedthrough assembly. The fixture 420 may be structurally and/or functionally similar to the fixtures 120, 220, but fixture 420 may include a small tab 427 on each side of the bottom plate 422 to secure the fixture to the housing. Different from the fixture 320, the top plate 420 may include slots or cut outs shaped and sized to receive a corresponding one of the plurality of arms 423, for example, interface with corresponding slots defined in proximate edges of the corresponding arm of the plurality of arms 423. This may facilitate alignment and securing of the top plate 420 to the plurality of arms 423, and may also facilitate subsequent fastening (e.g., welding, bonding, adhering, etc.) of the top plate 420 to the plurality of arms 423.

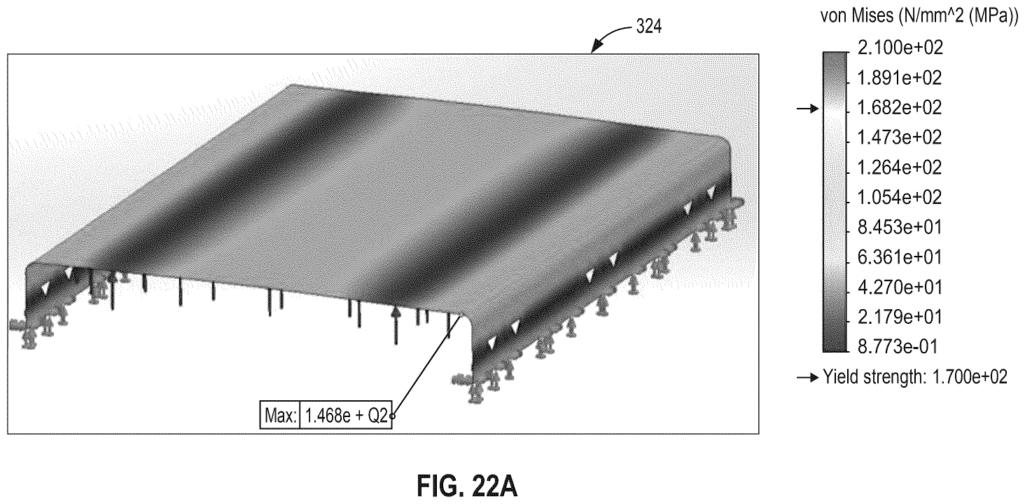

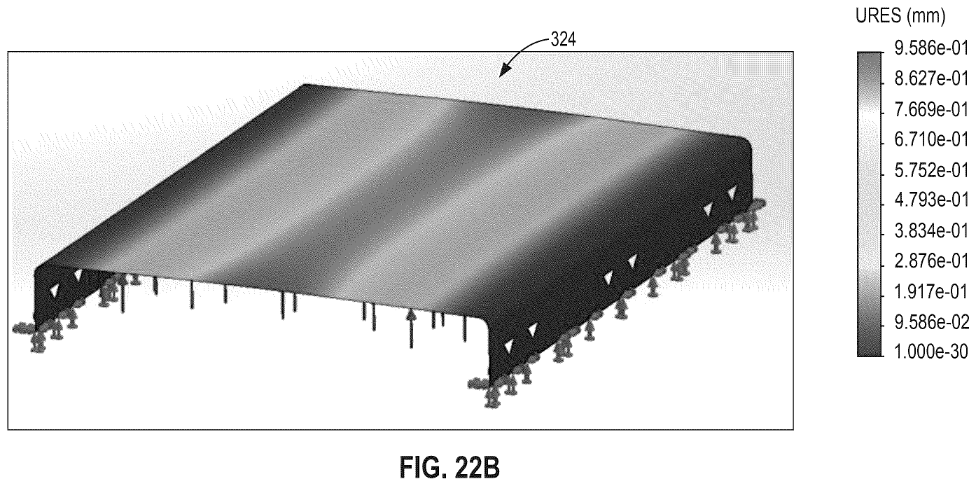

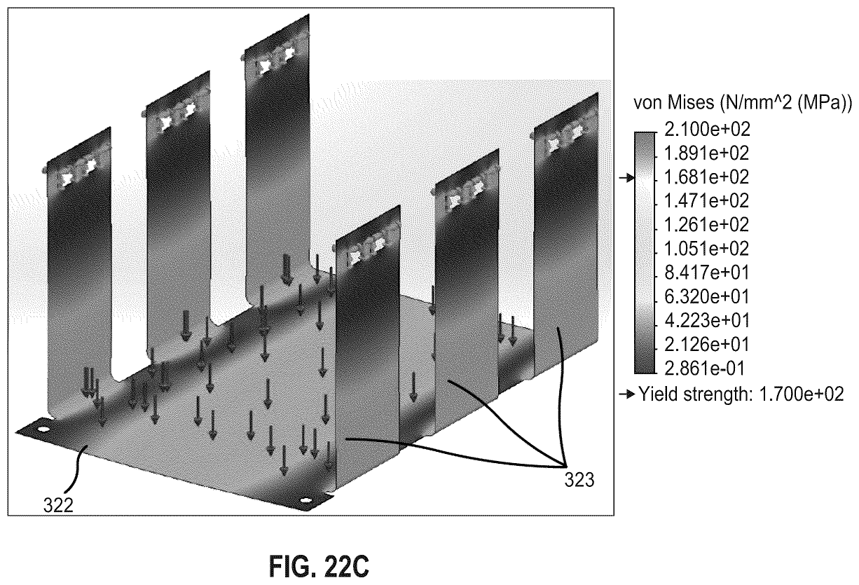

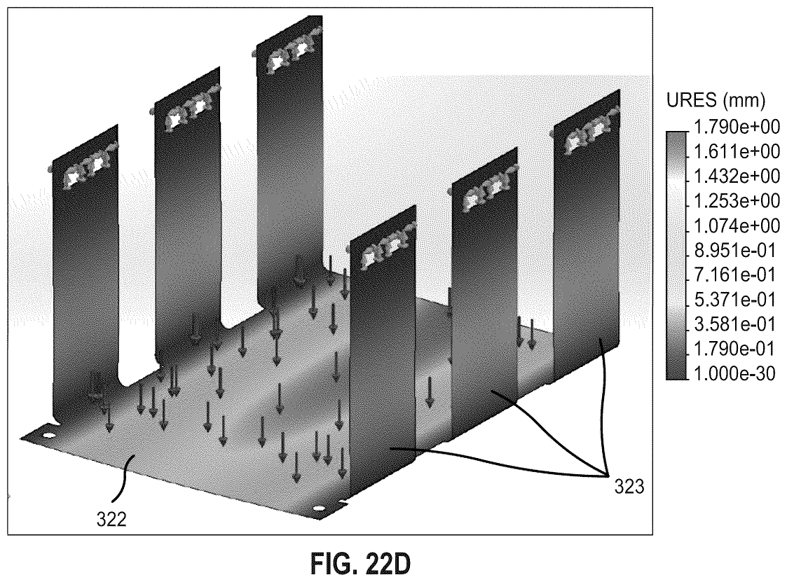

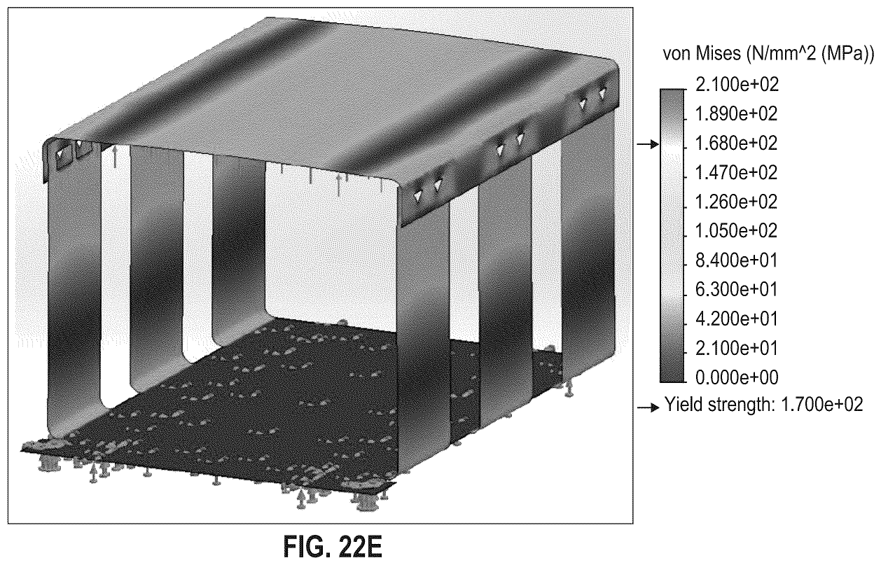

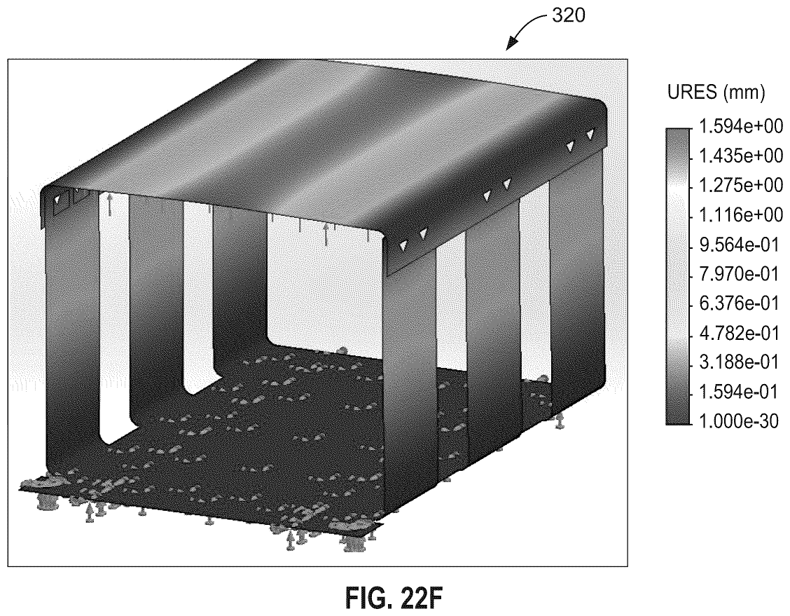

FIGS. 22A-22F show finite element analysis (FEA) modeling data of stress and displacement data obtained from a 3 dimensional (3D) model of the top plate 324 of the fixture 320 (FIGS. 22A and 22B) of FIG. 20 and the bottom plate 322 (FIGS. 22C and 22D) of the FIG. 20 separate from each other, and after being coupled to each other (FIGS. 22E and 22F). As shown in FIGS. 22A, 22C, 22E, a stress on the top plate 324 is highest along each edge and along a center section of the top plate 324 and a stress on the bottom plate 322 is highest along a center section of the bottom plate 322. A yield strength of the fixture 320 is about 170 N/mm². As shown in FIGS. 22B, 22D, a displacement resulting from the stress applied to the fixture 320 is about 0.959 mm near the center section of the top plate 324 and is about 1.79 near the center section of the bottom plate 322 when the components are separate. As shown in FIG. 22F, the displacement from the stress applied to the fixture 320 is about 1.594 mm along the center section of the top plate 324 when the top plate 324 and the bottom plate 322 are coupled to one another. In some embodiments, the applied pressure from fixture 320 can be between about 3 psi to about 10 psi, inclusive of all ranges and subranges therebetween.

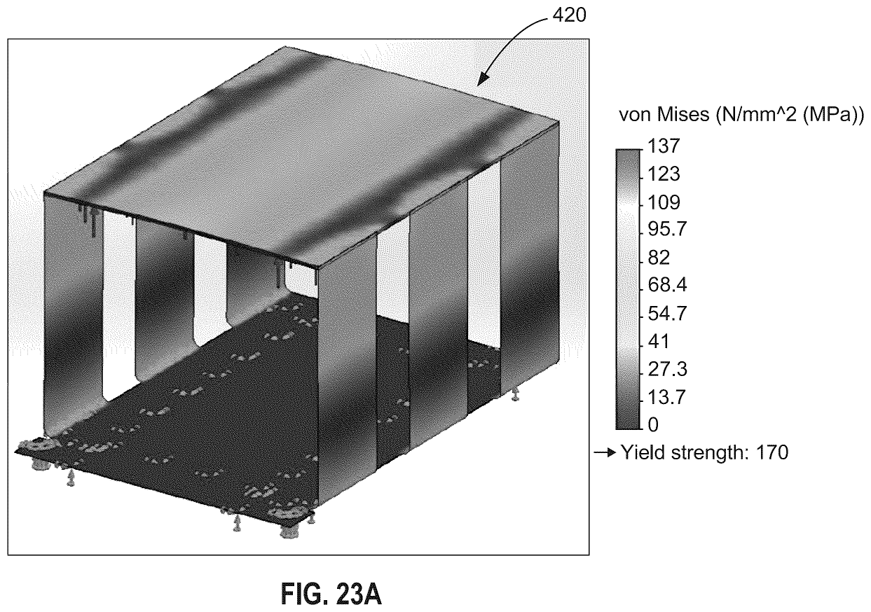

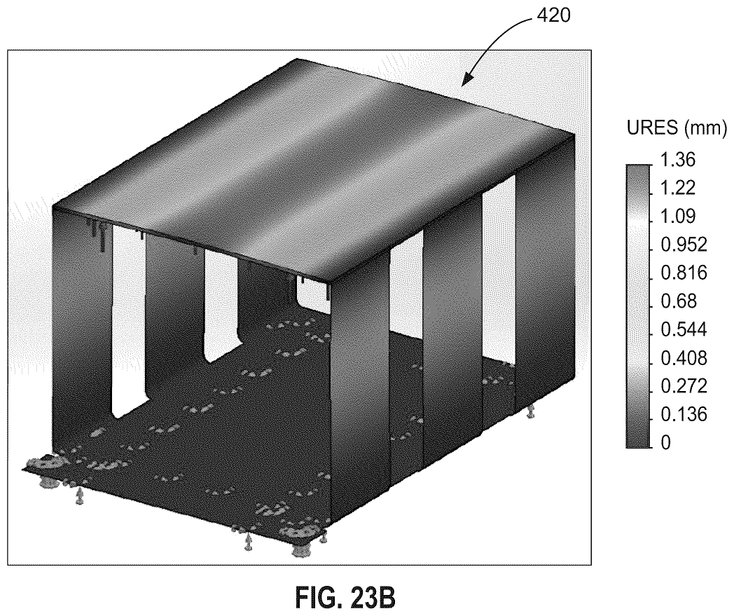

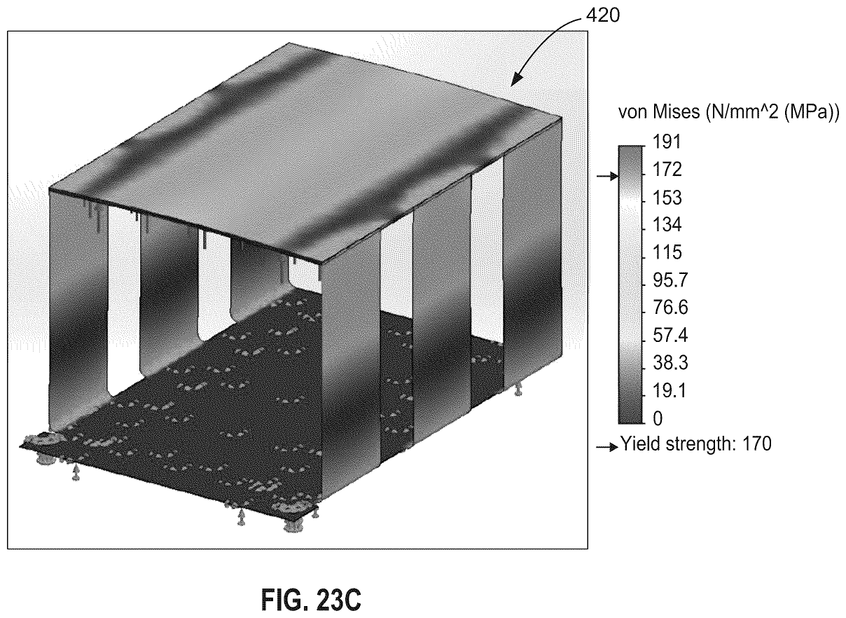

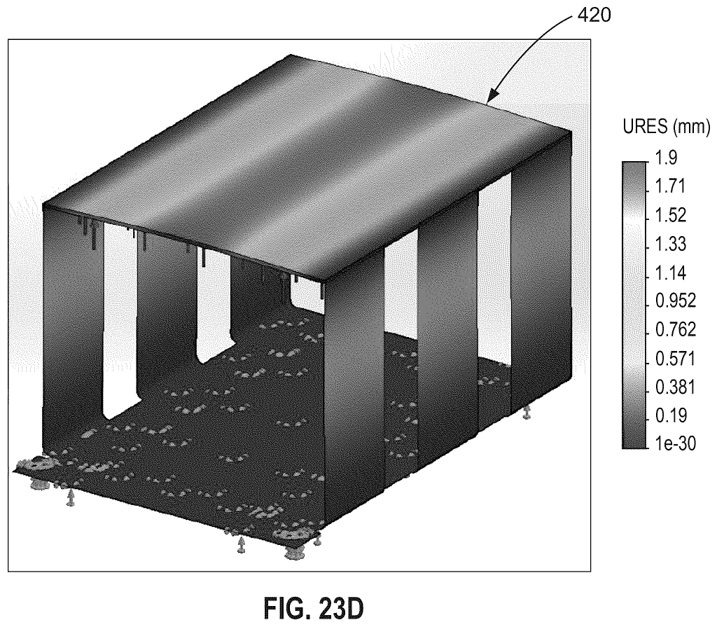

FIGS. 23A-23D show finite element analysis (FEA) modeling data of stress and displacement data obtained from a 3 dimensional (3D) model of the fixture 420 of FIG. 21. As shown in FIGS. 23A and 23C, a yield strength of the fixture 420 is about 170 N/mm². As shown in FIGS. 23B, a displacement resulting from the stress applied to the fixture 420 is about 1.36 mm when a pressure of about 5 psi is applied. As shown in FIG. 23D, a displacement resulting from stress applied is about 1.9 mm when about 7 psi pressure is applied. In some embodiments, the applied pressure from fixture 420 can be between about 3 psi to about 10 psi, inclusive of all ranges and subranges therebetween.

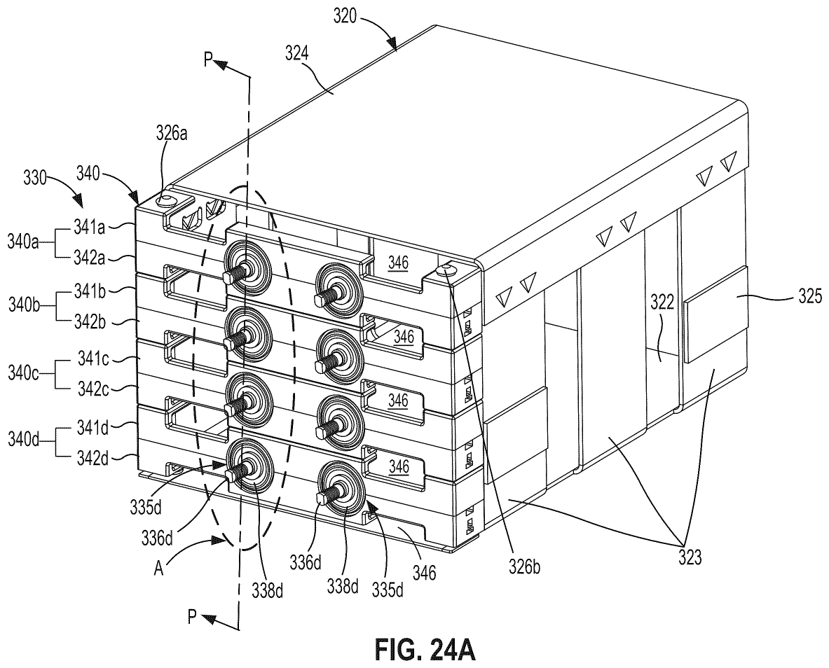

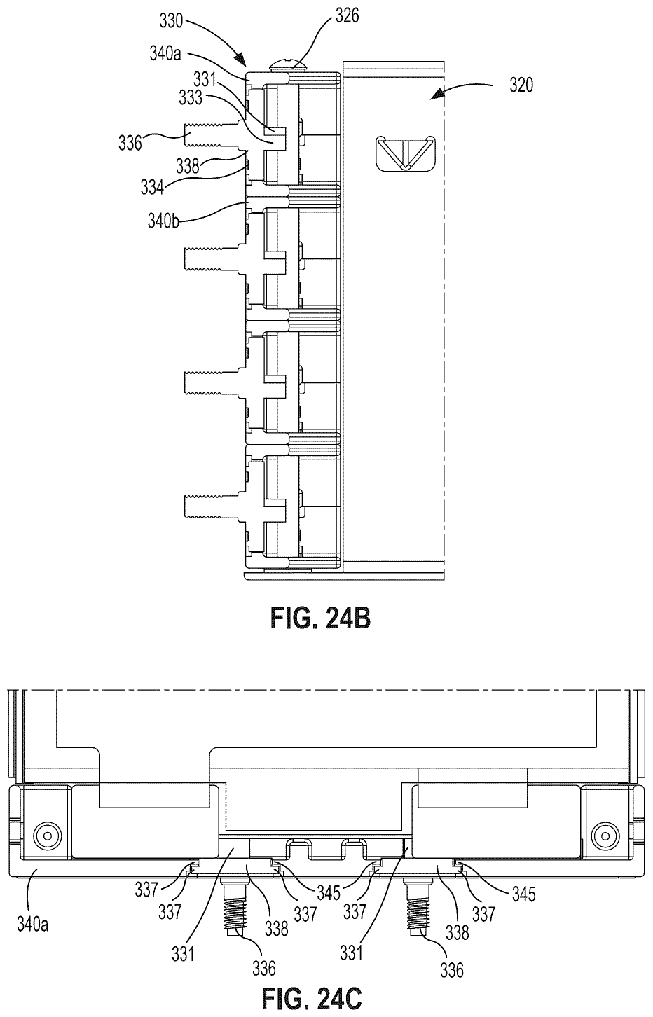

FIGS. 24A-24C shows the fixture 320 coupled to a feedthrough assembly 330 to form the electrochemical cell subassembly. As shown, the feedthrough assembly 330 includes a set of feedthrough plates 340 including a first feedthrough plate 340a, a second feedthrough plate 340b, a third feedthrough plate 340c, and a fourth feedthrough plate 340d. Each feedthrough plate 340a-340d may include a first portion 341a, 341b, 341c, 341d configured to be coupled to a corresponding second portion 342a, 342b, 342c, 342d to form the feedthrough plates 340a-340d. The feedthrough plates 340a-340d may be stacked together to form a continuous plate structure. While shown as including four feedthrough plates 340a-340d, the feedthrough assembly 330 may include any number of feedthrough plates, for example, 2, 3, 4, 5, 6, 7, 8, 9, 10, or even more.

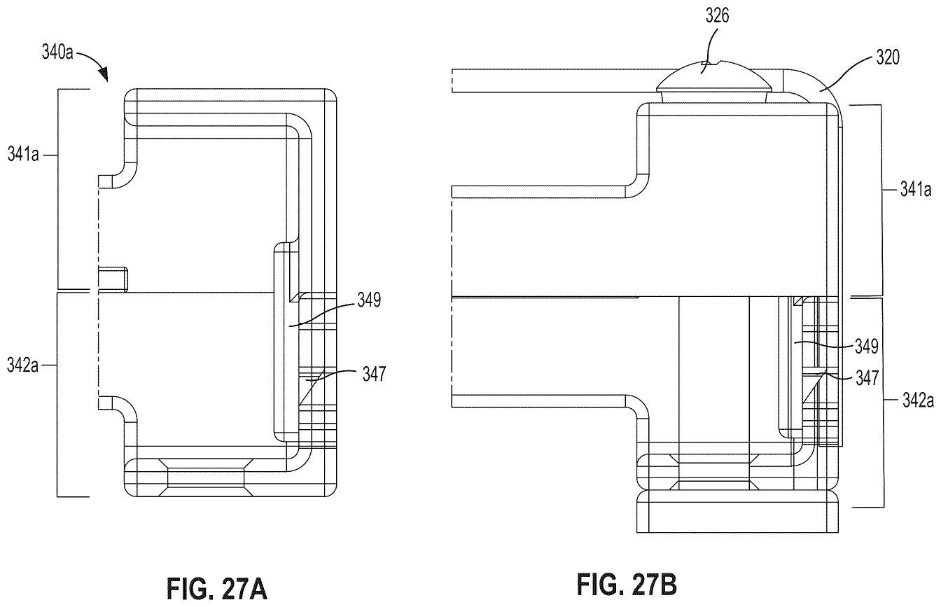

The feedthrough plates 340 may include a first set of apertures configured to receive a respective feedthrough subassembly such that a portion of each feedthrough connector (e.g., feedthrough connectors 335d) is accessible from outside of the cell subassembly. The feedthrough plates 340 may additionally include a second set of apertures configured to align with and receive the first and second support members 326a, 326b of the fixture 320 therethrough. In some embodiments, the feedthrough plates 340a-340b of the feedthrough assembly 330 may be structurally and/or functionally similar to the feedthrough plates 240a-240b of the feedthrough assembly 330; however, the feedthrough plate 340a-340b may define additional openings 346 (e.g., on a front side of the feedthrough plates 340a-340b) in order to reduce an amount of material used to form the feedthrough plates 340a-340d in the feedthrough assembly 330, thereby reducing a weight and/or cost of manufacturing the feedthrough assembly 330. In some embodiments, the openings 346 on the front side of the feedthrough plates 340a-340b may additionally provide easier access to an internal volume of the housing 360, for example, for performing welding or otherwise securing of various components thereof. In some embodiments, the coupling mechanism between the first portion 341a-341d and the second portion 342a-342d may differ, as described in further detail with respect to FIG. 27A and FIG. 27B. In some embodiments, the feedthrough assembly 330 may include fewer unique parts, lower resistance connections, and/or more robust connections.

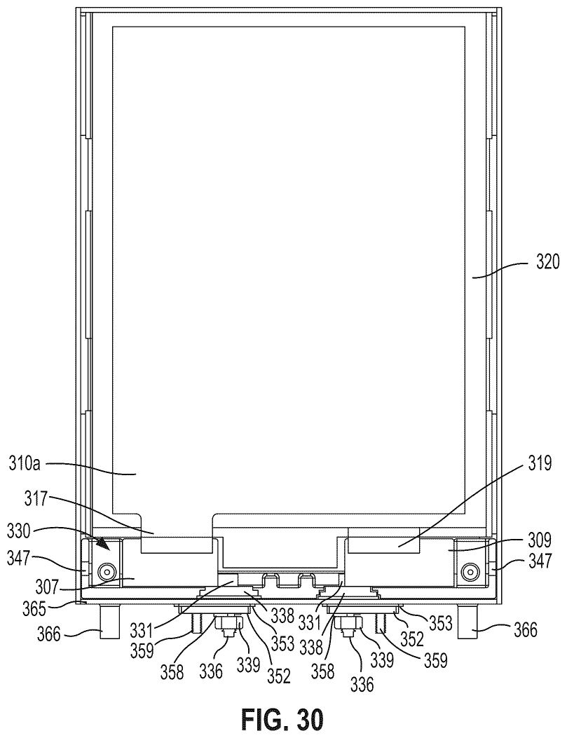

As shown in FIG. 24C, a feedthrough subassembly may be disposed through a respective aperture from the first set of apertures of the feedthrough plate 340a such that the conductive arm 331 aligns with a structure in an internal volume of the housing 360 (e.g., a respective tab or terminal), as described in further detail with respect to FIG. 30.

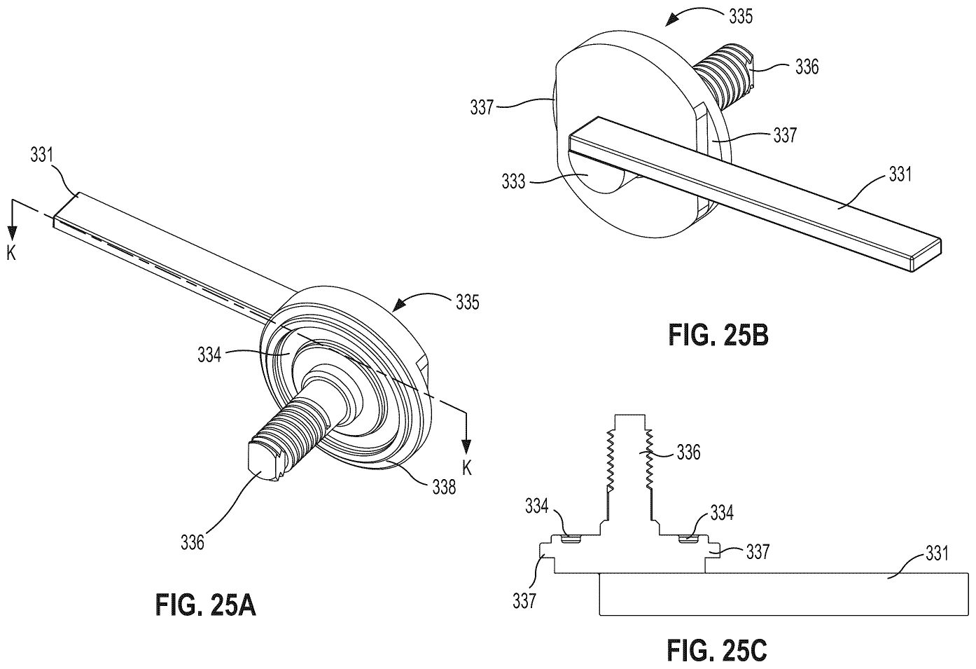

FIGS. 25A-25B shows a perspective view of a conductive arm 331 coupled to a feedthrough connector 335, thereby forming the feedthrough subassembly, according to an embodiment. As shown, the feedthrough connector 335 may include an annular portion 338 and a cylindrical portion 336 (e.g., a threaded fastener). In some embodiments, the feedthrough subassembly may be structurally and/or functionally similar to the feedthrough subassembly described with respect to assemblies 100, 200, and therefore certain details of the feedthrough subassembly are not described in further detail with respect to assembly 300. However, the structure of the feedthrough connector 335 may differ. In some embodiments, the annular portion 338 and the cylindrical portion 336 may be monolithically formed (i.e., the feedthrough connector 335 is monolithically formed). In some embodiments, the annular portion 338 and the cylindrical portion 336 may be coupled to one another via laser welding, adhesive, snap fitting, one or more additional fasteners, etc. In some embodiments, the feedthrough connector 335 may be monolithically formed, and the feedthrough connector 335 may be laser welded to the conductive arm 331. In some embodiments, when the feedthrough connector 335 is disposed through an aperture of a feedthrough plate, the threaded fastener 336 may be configured to extend away from the cell stack (i.e., toward the external environment). As shown in FIGS. 25A and 25C, the annular portion 338 may include a groove or indentation 334 such that a deformable member or seal member (e.g., an O-ring) may be disposed therein when coupling the feedthrough connector 335 to a feedthrough plate. The seal member may be configured to form a seal (e.g., a hermetic seal) between the feedthrough connector 335 and a cover plate of the assembly (not shown).

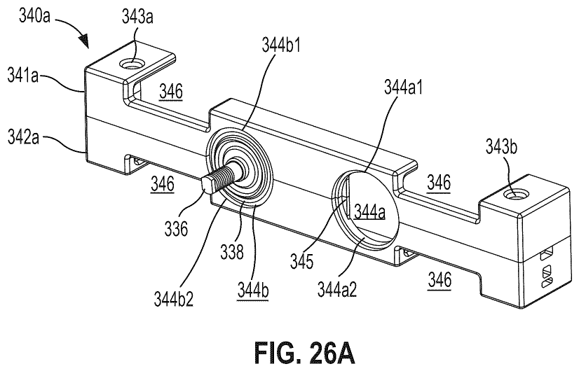

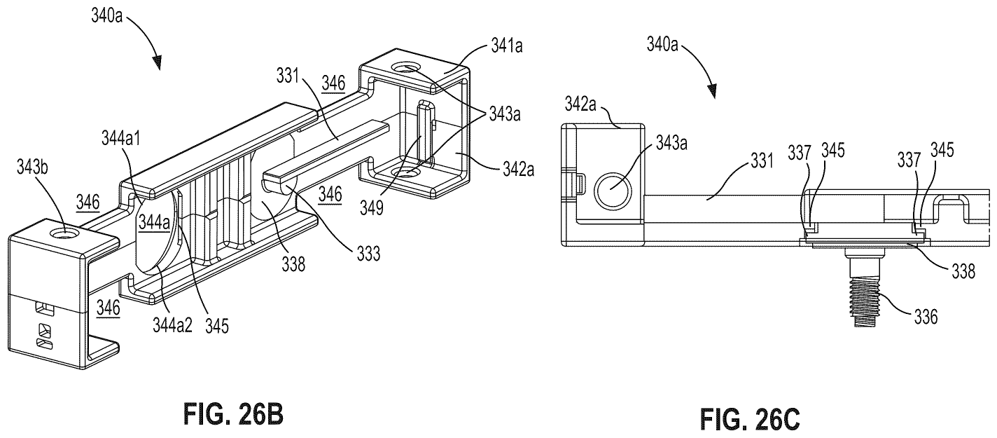

As shown in FIG. 25B, the annular portion 338 may include one or more ledges 337 configured to contact a respective ledge of the feedthrough plate (not shown) such that when the feedthrough connector 335 is disposed through an aperture of the feedthrough plate, the feedthrough connector 335 is prevented from falling through the aperture. In some embodiments, the ledges 337 may prevent rotation of the feedthrough subassembly when forming the assembly 300 (e.g., when welding the feedthrough subassembly to a respective feedthrough plate). For example, the ledges (e.g., ledge 345 shown in FIG. 26B) may be formed by defining grooves in corresponding faces of the annular portion 338 that faces corresponding first apertures defined in corresponding feedthrough plates of the feedthrough plates 340a-340d. The first apertures may be shaped as truncated circles and sized to receive the corresponding face of the annular portion 338 such that the annular portion 338 is substantially fixedly seated in the corresponding first aperture to inhibit or limit rotational movement of the annular portion 338 and thereby, the feedthrough connector 335 (see FIG. 26B).

In some embodiments, the annular portion 338 may include an extension extending from a backside thereof 333 configured to be welded to the conductive arm 331. In some embodiments, the conductive arm 331 may be coupled to the feedthrough connector 335 such that the feedthrough arm is substantially perpendicular to the threaded fastener 336. The feedthrough subassembly of assembly 300 may include less components and/or fasteners than the feedthrough subassembly of assembly 200. For example, the feedthrough connector 335 may be one piece that is injection molded and may be directly welded to the conductive arm 331, thereby reducing a number of components and/or welding points.

FIG. 26A is a top, front perspective view, FIG. 26B is a top, rear perspective view, and FIG. 26C is a top view of a feedthrough plate 340a defining apertures 344a, 344b through which feedthrough connectors 335 are configured to be disposed, according to an embodiment. As shown in FIGS. 26A-26B, a first slot 344a1, 344b1 may be defined in the first portion 341a of the feedthrough plate 340a, and a corresponding second slot 344a2, 344b2 may be defined in the second portion 342a of the second feedthrough plate 340a that aligns with corresponding first slot 344a1, 344b1 of the first portion 341a such that when the two portions 341a and 342a are aligned and coupled together, first apertures 344a1, 344b 1 align with the corresponding second apertures 344a2, 344b2 to form the apertures 344a, 344b. The first set of apertures 344a, 344b may be substantially aligned vertically on the feedthrough plate 340a. The first aperture 344a may be disposed closer to a first end of the feedthrough plate 340a, and the second aperture 344b may be disposed closer to a second end of the feedthrough plate 340b such that the first aperture 344a may be aligned with a first tab of the cell stack, and the second aperture 344b may be aligned with a second tab of the cell stack, as shown in FIGS. 24C and 30.

As shown in FIGS. 26A and 26B, the first aperture 344a and the second aperture 344b each include one or more ledges or shelves 345 positioned on opposite sides of the aperture 344a, 344b. Each ledge or shelf 345 may be configured to align with a respective ledge 347 on the annular portion 338 of the feedthrough connector 335. In other words, the ledge 345 of the aperture 344a, 344b may be configured to contact a ledge of the annular portion 338 such that the annular portion is seated in the aperture 334a, 334b. As such, the feedthrough connector 335, and therefore the conductive arm 331, may be maintained in a predefined position relative to the feedthrough plate 340a. As shown, the feedthrough subassembly may be positioned in the aperture 344a, 344b by disposing the conductive arm 331 through the aperture 344a, 344b from a front side of the feedthrough plate 340a (e.g., a side configured to face away from an internal volume of the housing 360) until the ledges 337 of the annular portion 338 abut the ledges 345 of the aperture 344a, 344b. As such, the ledges 337 and 345 may inhibit rotation of the feedthrough subassembly relative to the apertures 344a, 344b to secure a position of the feedthrough subassembly. As shown in FIG. 26B-26C, a portion of the conductive arm 331 may be in contact with and extend along an inner surface of the of the feedthrough plate 340a. The second set of apertures defined by the feedthrough plate 340a may include a first pair of vertical apertures 343a on a first side and a second pair of vertical apertures 343b on a second side opposite the first side. The first pair of vertical apertures 343a may be configured to receive the first support member 326a, and the second pair of vertical apertures 343b may be configured to receive the second support member 326b.

FIGS. 27A-27B show a first portion 341a and a second portion 342a of the feedthrough plate 340a coupled together and secured to a support element 326 of the fixture 320, according to an embodiment. As shown, the first portion 341a of the feedthrough plate 340a includes a first coupling mechanism 347, 349, and the second portion 342a of the feedthrough plate 340a includes a second coupling mechanism. The first coupling mechanism 347, 349 and the second coupling mechanism may be structurally and/or functionally similar to the first coupling mechanism 247, 249 and the second coupling mechanism of feedthrough plate 240a, and therefore certain aspects are not described again with respect to FIG. 27A and FIG. 27B.

In some embodiments, the first coupling mechanism 347, 349 and the second coupling mechanism may include shapes that are complimentary to one another. For example, the first coupling mechanism may include an extension 349 extending away from the first portion 341a and an engagement member 347 (e.g., a knob, hook, bump, notch, clasp, peg, protrusion, etc.), and the second coupling mechanism may include a cavity configured to receive the engagement member 347 to facilitate alignment, and/or form a snap fit between the first and second portions 341a, 341b. In some embodiments, the first coupling mechanism 347 may differ from the first coupling mechanism 247 in the shape of the engagement member 347. For example, the engagement member 347 may be elongated (e.g., longer) in comparison to the engagement member 247, and the second coupling mechanism of portion 342b may be a deeper cavity than the second coupling mechanism of portion 242b. In some embodiments, after the engagement member 347 may be disposed in the cavity of the second portion 342a, the first portion 341a and the second portion 341b may be maintained in contact with another to form the feedthrough plate 340a. In some embodiments, the engagement member 347 and the second coupling mechanism of portion 342b may form a snap-fit coupling mechanism. In some embodiments, at least a portion of the first and second portions 341a, 342a may be welded together.

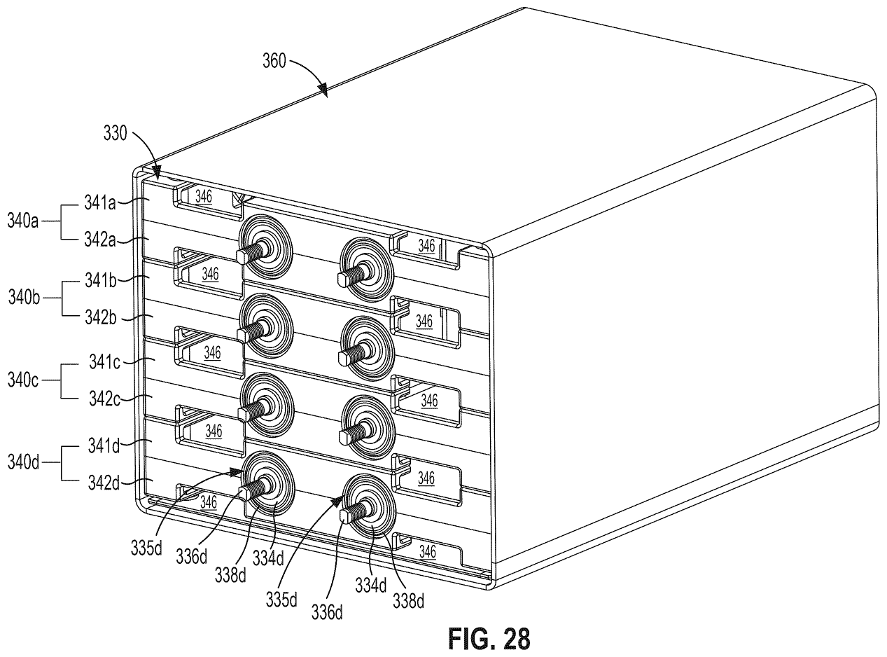

FIG. 28 shows a front perspective view of the electrochemical cell subassembly including the fixture and the feedthrough assembly 330 disposed in a housing 360 such that the set of feedthrough plates 340 at least partially cover an opening defined by the housing 360. A portion of the feedthrough connectors (e.g., feedthrough connectors 335d) are accessible from outside the housing 360.

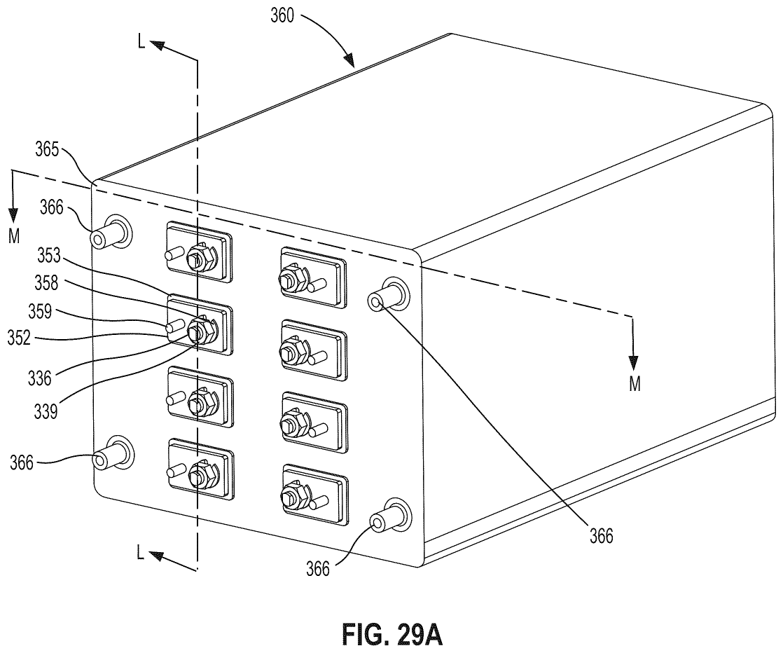

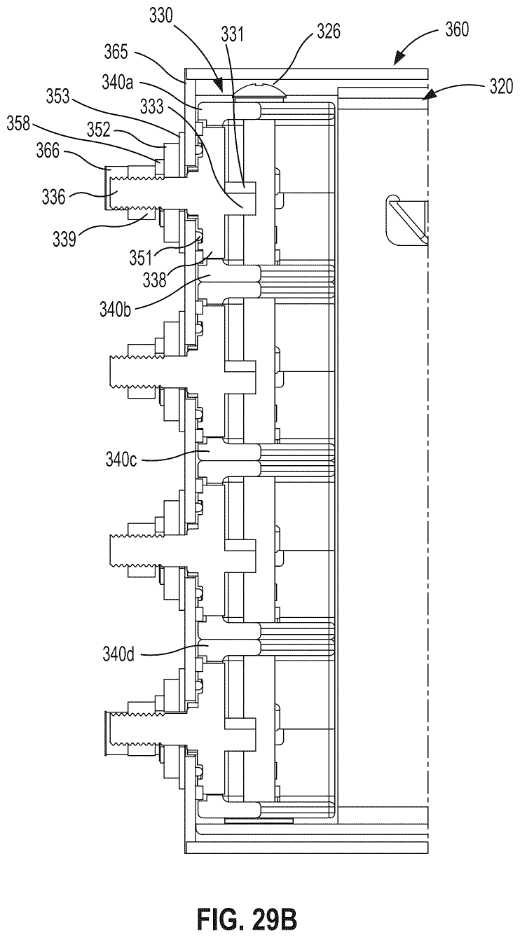

FIG. 29A shows a front perspective view of the electrochemical cell assembly 300 showing a cover plate 365 with contact pads 352 coupled to the feedthrough connectors 335 and standoff arms 366, according to an embodiment. The cover plate 365, standoff arms 366, and the contact pads 352 may be similar to cover plate 265, standoff arms 266, and contact pads 252, and therefore, certain details are not described herein again with respect to FIGS. 28A-29C. However, in some embodiments, different than assembly 200, the cover plate 365 of assembly 300 may be sealed to the housing 360 using a seal and/or a gasket rather than laser welding.

In some embodiments, the contact pads 352 may differ in how they are coupled to the feedthrough connectors 335 and the cover plate 352. In some embodiments, the cover plate 365 may be sealed to the housing 360 using a seal or gasket, and the feedthrough connectors 335 may be sealed to the cover plate 365 using a seal or gasket such that the housing 360 is hermetically sealed. In some embodiments, the feedthrough connectors 335 may be welded to the cover plate 365. In some embodiments, contact pads 352 may be coupled to the feedthrough connectors 335 via a second threaded fastener 339 (e.g., a nut) and a securement member 358 (e.g., a washer). In some embodiments, a securement plate 353 may be disposed between the contact pad 352 and the cover plate 365. In some embodiments, the contact pads 352 may further differ from contact pads 252 in that they have an additional extension extending therefrom. For example, the contact pad 352 may include a threaded portion 359 extending therefrom and configured to couple the contact pad 352 to an external component (e.g., external fastener and/or conductive member).

FIG. 29B is a side cross-section view of the assembly taken along the line L-L shown in FIG. 29A. FIG. 30 is a top cross-section view of the assembly taken along the line M-M shown in FIG. 29A. In some embodiments, a seal 351 may be disposed in the groove of the annular portion 338 to form a seal between an inner surface of the cover plate 365 and the annular portion 338 of the feedthrough connector 335. As shown, the cylindrical portion 336 of the feedthrough connector 335 extends through an opening in the cover plate 365 such that the cylindrical portion 336 is accessible from outside of the housing 360. The securement plate 353 is disposed outside of the cover plate 365 around the cylindrical portion 336, and the contact pad 352 is disposed outside of securement plate 353. A washer 358 may be disposed outside of the contact pad 352 around the cylindrical portion 336 of the feedthrough connector 335. Then, a threaded fastener 339 (e.g., a nut) is coupled to the threaded portion of the feedthrough connector 335 to fasten the contact pad 352 and the securement plate 353 into place on the cover plate 365. The feedthrough connector 335 may be disposed through the feedthrough plate 340a such that the conductive arms 331 are aligned with a respective tab (or terminal end) 317, 319 of an electrochemical cell or cell stack 310a. In some embodiments, each electrochemical cell in a cell stack may include first tab 317 and a second tab 319. The tabs 317, 319 of each electrochemical cell in the cell stack may be electrically coupled via a first collective tab 307 and a second collective tab 309. In some embodiments, each tab 317, 319 is in direct contact with a respective conductive arm 331. In some embodiments, each collective tab 307, 309 corresponding to a cell stack is in direct contact with a respective conductive arm 331.

Depending on the application of use, contact pads 352 can be fastened or welded to the isolated terminals and electrically connected to the controller which can be mounted directly to the cover plate 365. In some embodiments, since the housing 360 is hermetically sealed between the annular portion 338 (e.g., an annular seal disposed in the groove or via laser welding) and the cover plate 365, the components outside of the cover plate 365 (e.g., the contact pads 352 and external portion of the feedthrough connector) may not be welded or sealed to one another. In some embodiments, any one of or all of the components outside of the cover plate 365 may be welded. Each contact pad 352 may be conductive and configured to electrically connect the feedthrough connector 335 to the external electronic circuitry (e.g., the controller). In some embodiments, a pad size and orientation may be selected based on the design of the controller, for example, a shape or size thereof.

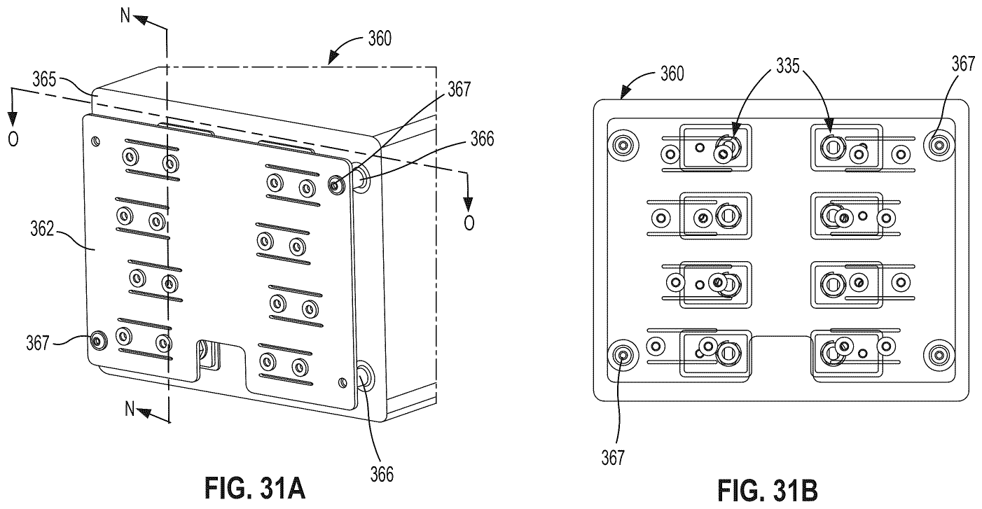

FIG. 31A is a front perspective view, and FIG. 31B is a front view of a controller 362 coupled to the standoff arms 366 of the cover plate 365, according to an embodiment. The controller 362 may be substantially similar to the controller 262, and therefore certain details of the controller 362 are not described herein again with respect to FIGS. 31A-31B. The standoff arms 366 may extend away from the cover plate 365 of the housing 360 to create a clearance or a space between the controller 362 and conductive materials on the cover plate 365 (e.g., the contact pads 352) (e.g., to inhibit shorts, and/or allow air flow).

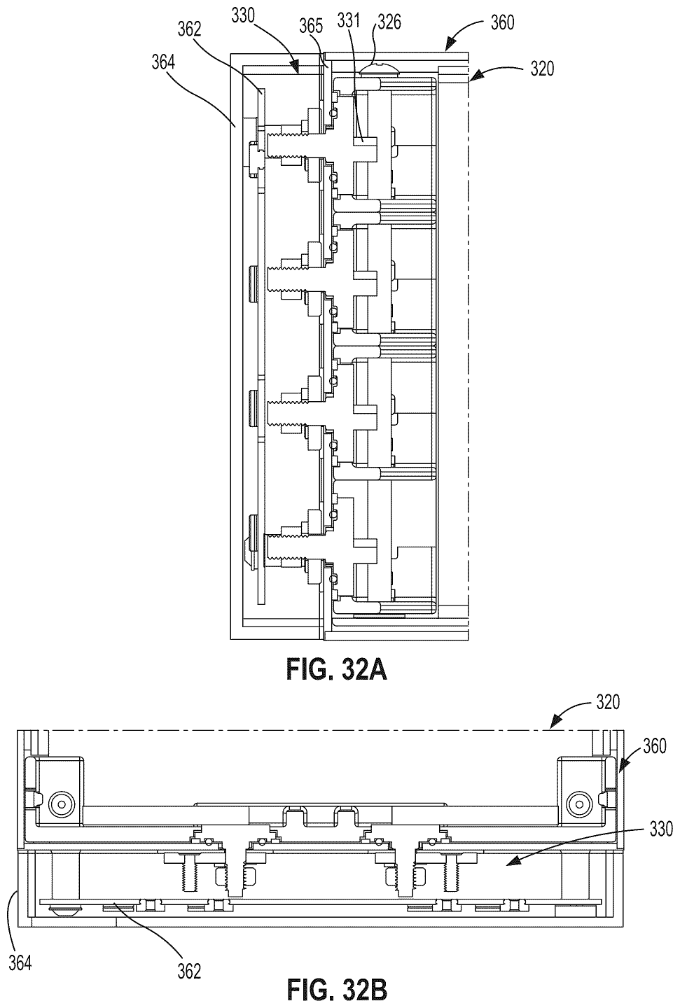

FIG. 32A is a side cross-section view of the assembly 300 taken along the line N-N showing a controller cover 364 coupled to the housing 360 over the controller 362, according to an embodiment. FIG. 32B is a top cross-section view of the portion of the assembly 300 taken along the line O-O. As shown, the controller cover or lid 364 may include a rigid material to protect the controller 362, and may be sealed to the cover plate 365 using fasteners or gaskets 369 to protect the terminals from liquids or mechanical damage during handling. The controller cover 364 may be substantially similar to controller cover 264, and therefore the details of the controller cover 364 are not described herein with respect to FIGS. 32A-32B.

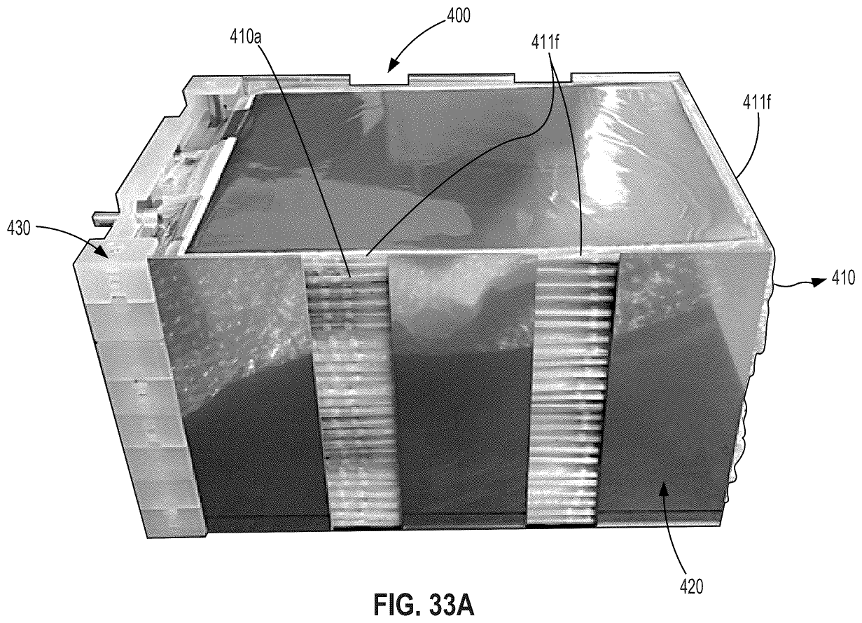

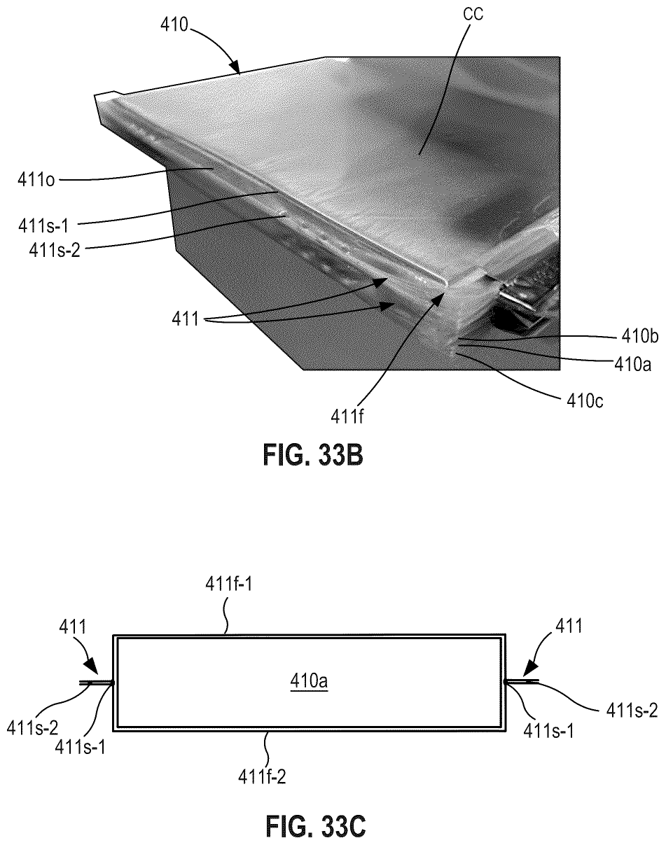

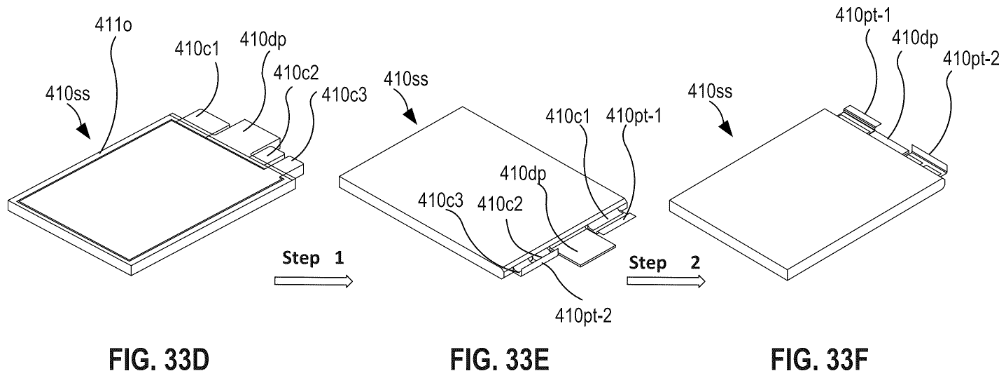

FIG. 33A shows an image of a stack assembly 400 including an electrochemical cell stack 410 disposed in a fixture 420 and coupled to a feedthrough assembly 430 to form an electrochemical cell subassembly, according to an embodiment. The electrochemical cell stack 410 includes a plurality of electrochemical cell substacks, each including one or more electrochemical cells 410a. The electrochemical cells 410a may include any suitable type of electrochemical cells configured to store electrical energy and deliver electrical energy on demand. For example, FIG. 1B schematically illustrates an embodiment of an electrochemical cell 110a that may be included in the stack assembly 400. In some embodiments, each of the electrochemical cells 410a within the stack 410 may be substantially similar to one another, although variations in form factor, capacity, chemistry, or other design features are contemplated. It should be understood that FIG. 1B shows only one example of an electrochemical cell structure, and that any suitable cell construction or formulation may be utilized, all of which are within the scope of the present disclosure.

In some embodiments, the fixture 420 may include a laser-welded pressure fixture and/or an internal mechanical structure configured to maintain substantially uniform pressure across the stack 410 during the processes of assembly, welding, and operation. The electrochemical cell assembly 400 may be structurally and/or functionally similar to the electrochemical cell assemblies 100, 200, and 300 described herein, and therefore certain structural or operational details may be omitted for brevity. In some embodiments, the stack assembly 400 differs from the assemblies 100, 200, and 300 in that each electrochemical cell 410a includes a carrier or backing film 411f that is disposed (e.g., laminated) onto the current collector surfaces of the electrodes. However, in some embodiments, the backing film may be applied selectively to only a subset of electrodes or cells within the electrochemical cell stack 410, rather than to all electrodes or cells. That is, in some embodiments, the backing film may not be used on every electrode or cell; instead, it may be applied to a select number of electrochemical cells based on performance goals, material use, or manufacturing considerations.

FIG. 33B is a side perspective view of a portion of the electrochemical cell stack 410 removed from the fixture 420, and FIG. 33C is a schematic illustration of an electrochemical cell 410a of the electrochemical cell stack 410 disposed in an enclosure formed by backing films 411f that are sealed at their edges, according to an embodiment. As shown in FIG. 33B-33C, in some embodiments, a first electrochemical cell 410a includes a first backing film 411f-1 disposed on at least one surface of an anode current collector and a second backing film 411f-2 (collectively referred to herein as “backing films 411f”) disposed on at least one surface of a cathode current collector, for example, on opposing surfaces of the electrochemical cell 410a. The first electrochemical cell 410a may be disposed between the second 410b and third 410c electrochemical cells within the electrochemical cell stack 410. In some embodiments, the surface of the cathode current collector on which the second backing film 411f is disposed faces the second electrochemical cell 410b, and the surface of the anode current collector on which the first backing film is disposed faces the third electrochemical cell 410c. That is, in some embodiments, the carrier or backing films 411f can disposed on the outer-facing surface of each electrode's current collector, the surface opposite to the active material layer and the separator. Thus, the backing films 411f may be used to physically and electrochemically adjacent electrochemical cells from each other (e.g., the first electrochemical cell 410a from the second and third electrochemical cells 410b and 410c). In some embodiments, enclosing the electrodes with the backing films in this manner serves to trap or confine a precise quantity of electrolyte adjacent to the active materials, thereby mitigating or preventing unintended migration of the electrolyte into other regions of the battery pack and helping maintain localized electrolyte environments that are electrochemically and environmentally stable.

In some embodiments, one of the first or second backing films 411f-1 and 411f-2 may be omitted. In some embodiments, edges of the backing films 411f extend laterally beyond at least one edge of the respective current collector to form an overhanging portion 411o. In some embodiments, the backing films 411f extend beyond all edges of the current collector CC, forming a perimeter of overhanging film material that forms an overhanging region 411o. In some embodiments, at least a portion of the overhanging region 411o of the backing films 411f is welded or fused together at a first sealing region 411s-1 to partially or fully seal (e.g., hermetically seal) the first electrochemical cell 410a. In some embodiments, the sealing process involves plastic welding, thermal fusion, ultrasonic welding, fusion bonding, or adhesive-based bonding. The sealing of the backing films around one or more electrodes can enable the confinement of electrolyte near the electrode surfaces, thereby reducing exposure of the electrolyte to internal electrical connections and elevated potentials across series-connected cells. This confinement may mitigate or prevent corrosion and degradation while improving gravimetric energy density by eliminating the need for flooding the entire pack with liquid electrolyte.

In some embodiments, a plurality of electrochemical cells 410a, 410b, 410c are disposed adjacent to one another within the electrochemical cell stack 410, with each cell including at least one backing film (e.g., two backing films, each disposed on a respective CC) extending beyond the current collector. In some embodiments, adjacent electrochemical cells (e.g., at least two, at least three, at least five, at least eight, at least ten, at least fifteen adjacent electrochemical cells) are joined by welding or fusing together the overhanging region 411o of their respective backing films 411f. In some embodiments, the backing films 411f of adjacent electrochemical cells (e.g., 410a-410c) are joined at one edge, at two opposing edges, or at all surrounding edges. In some embodiments, such welded configurations result in the formation of electrochemical cell substacks 411 in which unit cells 410a are mechanically and/or environmentally sealed to one another. The fused regions may provide structural stability, environmental sealing (e.g., moisture and gas barrier), and mechanical alignment within the stack.

In some embodiments, in addition to the first sealing region 411s-1, second sealing regions 411s-2 may be formed at predetermined locations in the overhanging regions 411o outwards of the first sealing region 411s-1. The second sealing region 411s-2 can include weld operations between adjacent cells of backing films 411f. In some embodiments, ultrasonic welding is employed to bond the adjacent overhanging backing films 411o, forming welds that secure the relative position of the electrochemical cells 410a-c within the stack. For example, application of external pressure on the stack 410 may cause the electrode materials (e.g., semi-solid cathode and/or anode material) of the electrochemical cells 410a-c to displace or move laterally, which is undesirable as it can cause misalignment or make portions of electrode material unavailable for electrochemical communication. Including the second sealing region 411s-2 may serve as a securement feature to advantageously inhibit sideways movement of the electrode materials.

In some embodiments, the second sealing region 411s-2 include plastic welds formed by melting a low-melting-point adhesive layer included within the backing films, while the structural polymer layers of the films remain substantially unmelted. This selective melting may preserve mechanical integrity and dimensional stability of the films, while achieving strong weld bonds between cells.

In some embodiments, the backing films 411f may include one or more polymer materials, including but not limited to polypolyethylene terephthalate (PET), polyethylene naphthalate (PEN), polyimide (PI), polyamide (PA), polypropylene (PP), polyethylene (PE), polycarbonate (PC), or fluoropolymer materials such as ethylene tetrafluoroethylene (ETFE) or polytetrafluoroethylene (PTFE). In some embodiments, the backing films 411f may include polyester. In some embodiments, the backing films 411f may include multilayer laminates of two or more different polymer materials to optimize mechanical, thermal, and barrier properties. In some embodiments, an adhesive layer can be disposed between adjacent backing films. In some embodiments, the adhesive layer may include a low-melting-point adhesive material such as ethylene vinyl acetate (EVA), polyurethane (PU)-based adhesives, amorphous polyester adhesives, polyolefin-based hot melt adhesives, or acrylic-based adhesives, wherein the adhesive material has a melting point lower than about 150° C., such as lower than about 120° C., lower than about 100° C., or lower than about 80° C., or lower than about 50° C. to facilitate localized welding without damaging the polymer structural layers.

In some embodiments, the backing films 411f can have a thickness of at least about 1 μm, at least about 5 μm, at least about 10 μm, at least about 20 μm, at least about 30 μm, at least about 40 μm, at least about 50 μm, at least about 75 μm, at least about 100 μm, at least about 150 μm, at least about 200 μm, or at least about 225 μm. In some embodiments, the backing film can have a thickness of no more than about 250 μm, no more than about 225 μm, no more than about 200 μm, no more than about 175 μm, no more than about 150 μm, no more than about 125 μm, no more than about 100 μm, no more than about 75 μm, no more than about 50 μm, no more than about 30 μm, no more than about 20 μm, no more than about 10 μm, or no more than about 5 μm. Combinations of the above-referenced thicknesses are also possible (e.g., at least about 5 μm and no more than about 50 μm, or at least about 10 μm and no more than about 30 μm, inclusive of all values and ranges therebetween). In some embodiments, the backing film 411f can have a thickness of about 10 μm to about 30 μm, or about 20 μm to about 50 μm, depending on application-specific mechanical flexibility and sealing requirements.

In some embodiments, the second sealing region 411s-2 may include spot welds 411s formed at selected locations of the overhanging regions 411o (e.g., via ultrasonic welding), that mechanically secure adjacent electrochemical cells (e.g., 410a-410c). FIG. 33B depicts such welded stack regions. In some embodiments, the number and distribution of spot welds forming the second sealing region 411s-2 may vary according to design parameters such as the number of unit cells 410a in the substack 411, mechanical handling loads, or required alignment tolerances. For instance, denser spot weld patterns may be used for taller substacks or in applications requiring superior mechanical robustness. In some embodiments, continuous weld lines rather than spot welds may be employed for enhanced gas sealing between layers. In some embodiments, an adhesive layer melts during ultrasonic welding, while the structural polymeric backing films 411f remain substantially unmelted, preserving their mechanical integrity.

In some embodiments, the selection of materials and welding methods allows individual unit cells 410a or substacks 411 to be separated, if necessary, after assembly. Since ultrasonic welding selectively melts only the adhesive layers without permanently bonding the polyester carriers, mechanical separation of welded stacks can be achieved under controlled shear stress without significant film damage.

In some embodiments, the substacks may be disposed within the fixture 420 or module casing, wherein welding (e.g., laser welding) is utilized to join a metallic case lid to a case body, providing a final moisture-sealed and gas-sealed enclosure. In some embodiments, laser welding is selected to reduce thermal exposure to adjacent polymeric materials while providing robust structural attachment.

The integration of backing films 411f and welding or joining operations into the electrochemical stack 410 may reduce or eliminate the use of conventional battery pouches, clamps, or rigid alignment fixtures. In some embodiments, the use of backing films 411f enables enhanced electrode alignment, reduced lithium plating risk, improved cycle life, simplified assembly, and higher packing efficiency. In some embodiments, the combined use of backing films 411f and localized welding results in greater mechanical cohesion, moisture and gas sealing, and uniform electrochemical performance across the stack 410.

FIGS. 33D-33F illustrate an example embodiment of a process for fabricating or preparing a substack 410ss that forms a portion of the electrochemical cell stack 410, as discussed with respect to FIGS. 33A-33C. In some embodiments, the substack 410ss includes a first tab 410c1 extending from a first current collector (not shown). The first current collector may be configured to serve as either an anode or a cathode, depending on the overall electrochemical architecture. In some embodiments, the first current collector is an anode current collector, and the first tab 410c1 may be formed from copper or a copper-based alloy. Alternatively, when the first current collector is a cathode current collector, the first tab 410c1 may be formed from aluminum or other electrically conductive materials compatible with cathode chemistries.

The substack 410ss also includes a second tab extending from a second current collector (not shown), which may be positioned on the opposite face of the electrochemical cells relative to the first current collector. Similar to the first current collector, the second current collector may be an anode or a cathode current collector. In the illustrated embodiment of FIG. 33D, the second tab includes two tab segments 410c2 and 410c3. These segments may arise from different layers within the substack or may represent parallel tabbing for current collection efficiency. In some embodiments, tabs 410c2 and 410c3 may be electrically and mechanically connected, for example, to function as a single terminal.

A degas port 410dp is disposed between the first tab 410c1 and the second tab segments 410c2 and 410c3. The degas port 410dp is configured to provide a pathway for the evacuation of gases generated within the electrochemical cells 410a during formation or conditioning processes. After degassing, the port may be sealed to prevent loss of electrolyte or ingress of atmospheric gases or moisture.

In some embodiments, each electrochemical cell within the substack 410ss includes a backing film disposed on at least one of the current collectors of the cell, as described with respect to FIGS. 33A-33B. Accordingly, the electrochemical cell stack may include overhanging regions 411o of the backing film that extend beyond the current collectors of the stack.

As shown in FIG. 33D, the fabrication process for the substack 410ss may begin with electrochemical cells that include untrimmed tabs and open degas ports. Referring to FIG. 33E, in a first fabrication step (step 1), the tabs 410c1-c3 are trimmed to a predetermined length, and the degas port 410dp may be preliminarily sealed or positioned for future trimming. The first tab 410c1 is welded to a first primary tab 410pt-1, while the second and third tab segments 410c2 and 410c3 are welded to a second primary tab 410pt-2. The welds (not shown) between the foils and primary tabs may be accomplished using resistance welding, ultrasonic welding, laser welding, or other suitable techniques. In some embodiments, the first primary tab 410pt-1 is associated with the anode terminal, and the second primary tab 410pt-2 is associated with the cathode terminal. These welds are configured to collect current from the internal layers of the substack through the tabs 410c1-c3 and deliver it to the respective primary tabs 410pt-1 and 410pt-2. However, the arrangement may be reversed in alternate configurations.

In some embodiments, the substack 410ss undergoes an electrical screening or electrochemical formation process in a subsequent step (step 2). During this stage, electrochemical reactions may occur within the cells, potentially generating gases. To accommodate gas release, the degas port 410dp may be trimmed or opened. This operation provides safe venting of internal pressure and helps prevent damage to the seal structure during subsequent processing or operation.

After the formation and gas evacuation steps, a final sealing step (step 2) can be performed. In some embodiments, the overhanging regions 411o of the backing films of each electrochemical cell may be welded together such that the electrochemical cells within the substack 410ss are physically held together through the welded portions, forming a sealed substack. As a result, the substack 410ss can be at least partially or fully sealed.

Further, in step 2, the degas port 410dp can be trimmed and sealed to create a hermetically enclosed substack. In some embodiments, heat sealing may be used, for example, by applying a heated platen press to the overhanging edge regions 411o of the substack to bond thermoplastic films or adhesives. In other embodiments, ultrasonic sealing techniques may be employed to achieve localized fusing of the sealing layers. The completed seal provides electrolyte containment and inhibits ingress of external contaminants such as moisture or oxygen.

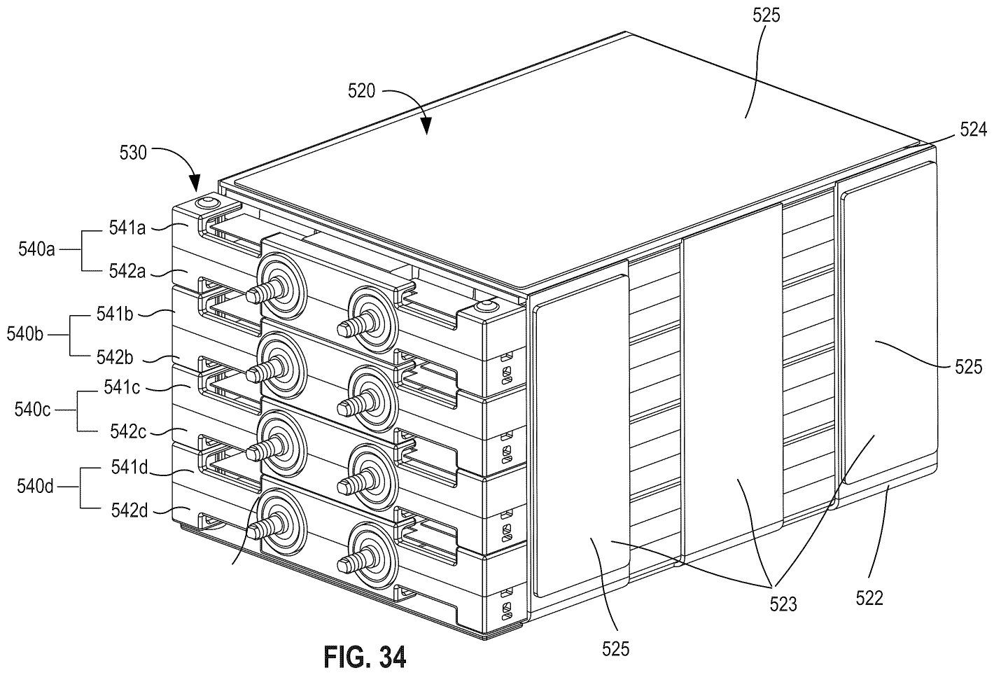

In some embodiments, FIG. 34 illustrates an electrochemical cell subassembly including a fixture 520 coupled to a feedthrough assembly 530, according to an embodiment. The fixture 520 includes one or more compliance structures 525 disposed along an outer surface of the fixture 520. The feedthrough assembly 530 includes a plurality of feedthrough plates 540, such as a first feedthrough plate 540a, a second feedthrough plate 540b, a third feedthrough plate 540c, and a fourth feedthrough plate 540d. Each feedthrough plate 540a-540d may include a first portion 541a, 541b, 541c, 541d configured to be coupled to a corresponding second portion 542a, 542b, 542c, 542d, forming an assembled feedthrough plate. While four feedthrough plates are shown in FIG. 34, in some embodiments, the feedthrough assembly 530 may include any number of feedthrough plates, for example, two, three, four, five, six, seven, eight, nine, ten, or more.

The electrochemical cell subassembly, or a part or portion thereof depicted in FIG. 34, may be structurally and/or functionally similar to the electrochemical cell subassembly, or part or portion thereof, described in any one of the foregoing embodiments. For example, the fixture 520 of the electrochemical cell subassembly of FIG. 34 may be similar to or substantially the same as the fixture 220 depicted in FIG. 6A.

The fixture 520 may define an inner volume configured to receive a cell stack and secure the cell stack under a compressive force. The fixture 520 may include a first plate, such as a bottom plate 522, configured to support the cell stack thereon, and a plurality of arms 523 extending from opposing edges of the bottom plate 522, generally at an orthogonal angle (e.g., approximately 90°±10°) relative to the bottom plate 522. A second plate, such as a top plate 524, may be coupled to ends of the plurality of arms 523 opposite the bottom plate 522 to enclose and compress the cell stack. The arms 523 may include vertical spaces or openings therebetween to permit parallel placement of multiple cell stacks and to enable airflow for thermal management. In some embodiments, the number of arms 523 may vary, and the fixture 520 may include, for example, four, six, eight, or another suitable number of arms depending on the application requirements.

In some embodiments, one or more of the arms 523 of the fixture 520 may include one or more compliance structures 525 disposed on outer surfaces thereof. In some embodiments, each arm 523 may include a compliance structure 525, whereas in other embodiments, only selected arms 523 or alternating arms 523 may include compliance structures 525. Additionally, in some embodiments, the bottom plate 522 and/or the top plate 524 may include compliance structures 525 disposed on surfaces facing outward toward an external housing or casing. The compliance structures 525 may be configured to be positioned between an outer surface of the respective fixture component and an inner surface of a housing when the electrochemical cell subassembly is disposed within an inner volume of the housing (not shown in FIG. 34).

In some embodiments, the compliance structures 525 may be configured to absorb vibration or shock impulses that may occur when the electrochemical cell subassembly is subjected to mechanical shock, vibration, or abrupt movement. The compliance structures 525 may further be configured to comply with irregularities or dimensional variations of the inner surface of a housing, thereby improving the mechanical retention of the fixture 520 within the housing and maintaining stable positioning of the cell stack.

In some embodiments, additionally, or alternatively, to providing mechanical compliance, the compliance structures 525 may serve a thermal management function. For example, the compliance structures 525 may be configured to conduct heat from the internal electrochemical assembly outward toward the housing to improve heat dissipation.

In some embodiments, the compliance structures 525 may be applied in various physical forms, depending on the specific design and assembly requirements. For example, the compliance structures 525 may be provided in the form of a pre-cut sheet or pad configured to be attached to the outer surfaces of the arms 523, top plate 524, or bottom plate 522 of the fixture 520. In other embodiments, the compliance structures 525 may be applied as a moldable or flowable material having a putty-like texture that can conform to complex geometries of the fixture 520 and housing surfaces. In some embodiments, the compliance structures 525 may be formed by dispensing viscous materials, such as, for example, a viscous paste, gel, or semi-solid gel on desired and/or inner surfaces of the fixture 520, and subsequently cured, compressed, or otherwise processed in situ to achieve a desired layer of the compliance material that serves as a mechanical and/or thermal interface between the fixture 520 and the housing. The use of a moldable, deformable, or flowable compliance material may facilitate improved gap filling, greater conformability to surface irregularities, and enhanced mechanical damping properties compared to pre-formed pads or sheets. Furthermore, the compliance structures 525, whether in sheet, pad, or paste form, may be engineered to achieve targeted thermal conductivity, mechanical compliance, thickness, and adhesion characteristics to obtain desired performance of the electrochemical cell subassembly during operation.

The compliance structures 525 may be coupled to the fixture 520 components by adhesive bonding, mechanical fastening, or overmolding processes. In certain embodiments, the compliance structures 525 may vary in thickness, material composition, or placement depending on the thermal and mechanical requirements of specific regions of the fixture 520. For example, thicker or more compliant structures may be placed on areas expected to encounter higher vibration loads, while thinner, more thermally conductive structures may be placed in regions prioritized for heat transfer.

In some embodiments, the compliance structures 525 may be formed from thermally conductive, elastomeric materials. Examples of suitable materials include silicone-based elastomers, thermally conductive gap filler pads, phase change materials, and other compliant thermal interface materials. The compliance structures 525 may be implemented as flexible sheets, pads, or coatings having a predetermined thickness and compressibility. In some embodiments, the compliance structures 525 may exhibit high thermal conductivity, such as greater than about 1 W/mK, combined with a relatively low Shore hardness to ensure effective mechanical compliance and gap filling.

In some embodiments, the compliance structures 525 may include thermally conductive gap-filling pads configured to occupy a gap between the fixture 520 and adjacent components (e.g., a housing, an external casing, etc.). The thermally conductive gap-filling pads may assist in enhancing the thermal uniformity of the electrochemical cell pack, particularly during high-rate charging and discharging cycles, by facilitating more efficient heat conduction from the cell stack to a surrounding housing, where the heat can be dissipated or radiated away. Accordingly, the compliance structures 525 may enhance both the mechanical robustness and thermal management performance of the electrochemical cell subassembly.

In some embodiments, the compliance structures 525 may include thermally conductive pads coated by a smooth material (e.g., a shiny and/or reflective material), for example, to facilitate insertion of the fixture 520 into the housing, protect the compliance structures from scratches, cuts, or otherwise damage during insertion, and/or increase thermal conduction and/or increase heat reflectivity. In some embodiments, the compliance structures 525 may include thermally conductive pads coated with a metalized polymer film. In some embodiments, the compliance structures 525 may further include a metalized polymer film disposed on a surface of the compliance structures, wherein the surface is oriented away from the fixture 520.

In some embodiments, one or more of the arms 523 of the fixture 520 may include one or more thermal interface pads (not shown) disposed on outer surfaces thereof. In some embodiments, each arm 523 may include a compliance structure 525, whereas in other embodiments, only selected arms 523 or alternating arms 523 may include thermal interface pads. Additionally, in some embodiments, the bottom plate 522 and/or the top plate 524 may include thermal interface pads disposed on surfaces facing outward toward an external housing or casing. The thermal interface pads may be configured to be positioned between an outer surface of the respective fixture component and an inner surface of a housing when the electrochemical cell subassembly is disposed within an inner volume of the housing (e.g., the housing 360). In some embodiments, the thermal interface pads may include a polymer. In some embodiments, the thermal interface pads may include a polymer film. The thermal interface pads, in some embodiments, can be a composite or a laminated structure. In some embodiments, the thermal interface pads can include (e.g., coated with) a metallized polymer film. The thermal interface pads are configured to facilitate more efficient heat conduction from the cell stack to the surrounding housing, where the heat can be dissipated or radiated away.

In some embodiments, alternatively or in addition to disposing the compliance structures 525 and/or thermal interface pads on the fixture 520, the compliance structures 525 and/or thermal interface pads may be disposed within the electrochemical cell stack. For example, the compliance structures and/or thermal interface pads may be positioned between each adjacent electrochemical cell, between every other cell, or according to a configuration selected to optimize thermal conduction and mechanical compliance. In some embodiments, the internal placement of such structures within the cell stack facilitates heat dissipation away from individual cells and enhances overall thermal management of the electrochemical cell assembly.

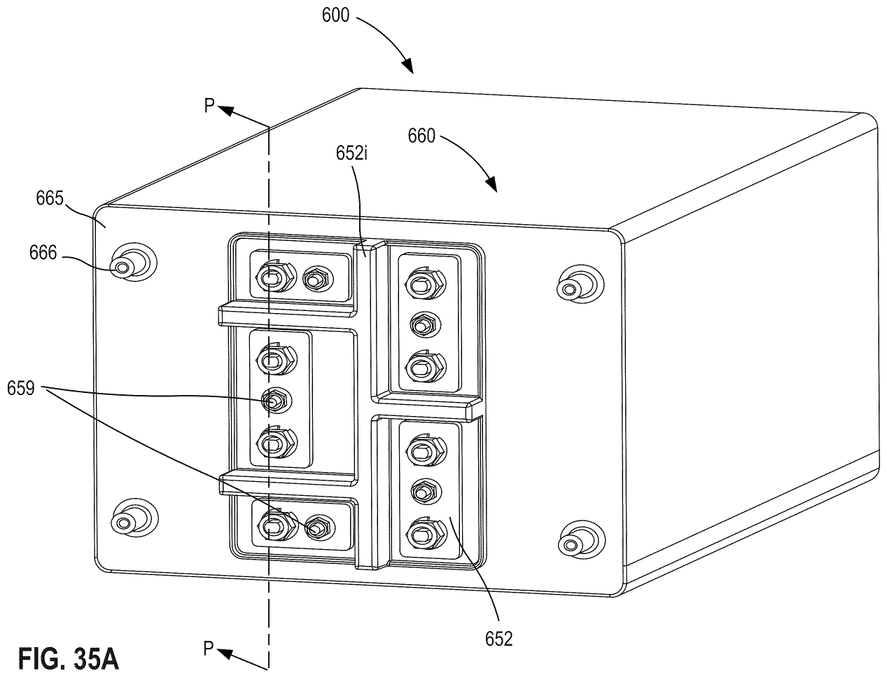

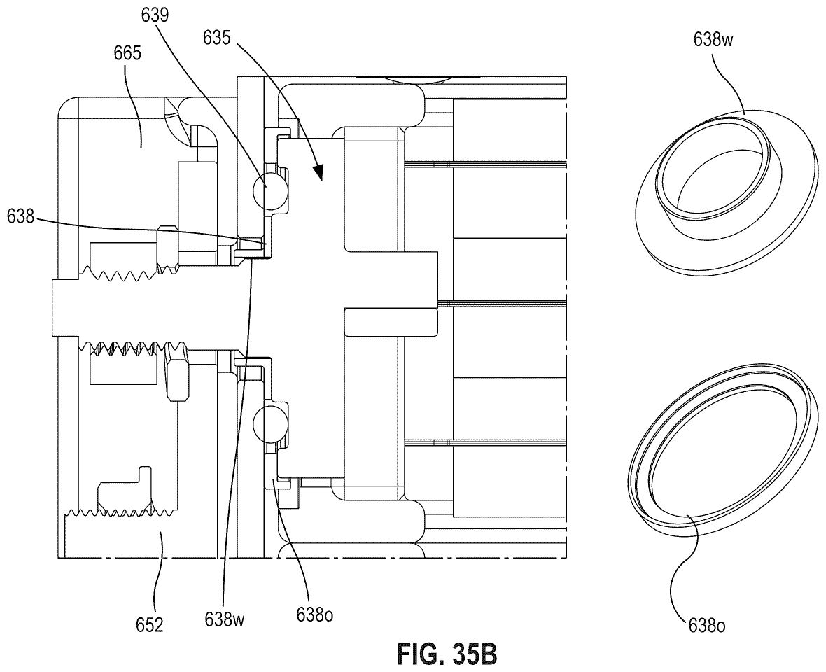

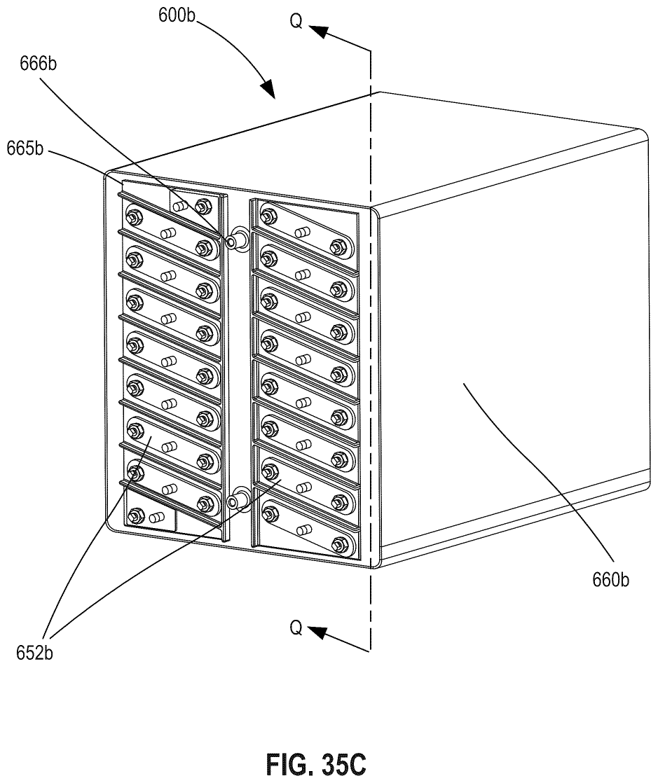

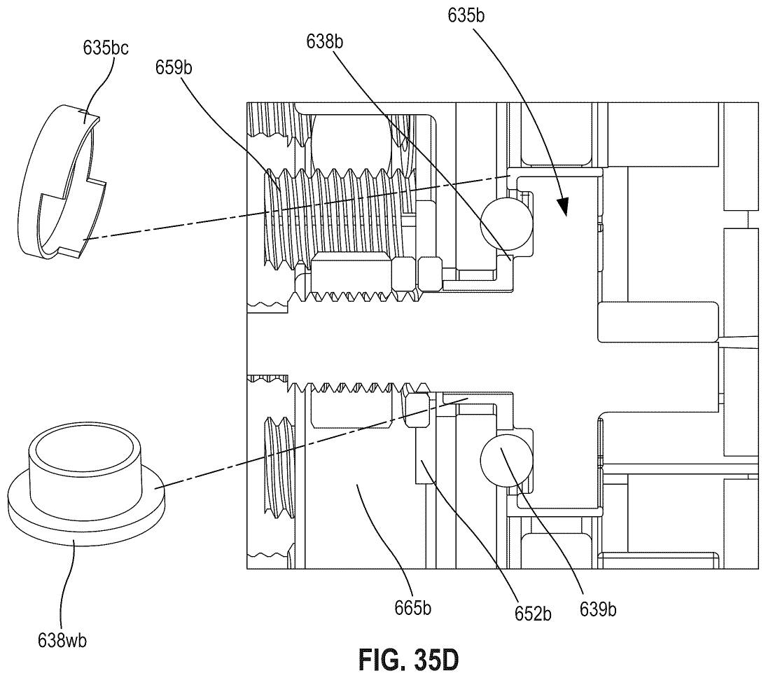

FIG. 35A illustrates a front perspective view of an electrochemical cell assembly 600 including a cover plate 665 having a plurality of contact pads 652, each electrically coupled to a corresponding feedthrough connector and mechanically supported by standoff arms 666, in accordance with various embodiments. The electrochemical cell assembly 600 is disposed in a housing 660. In some embodiments, the feedthrough subassembly may be structurally and/or functionally similar to the feedthrough subassemblies previously described with reference to assemblies 100, 200, and 300. Accordingly, certain features pertaining to the feedthrough subassembly are omitted for clarity.

The electrochemical cell assembly 600 may include an insulator fixture 652i, which is configured to physically isolate adjacent contact pads 652 from one another, thereby preventing electrical shorting or crosstalk between terminals. In some embodiments, the insulator fixture 652i may be formed from an electrically insulating and impact-resistant material, including but not limited to, glass, molded plastic, elastomeric rubber, a composite material, etc.

As further depicted in FIG. 35A, contact pads 652 are positioned and electrically interconnected such that a plurality of electrochemical cells (not shown) disposed within the housing 660 may be connected in series. In some embodiments, the contact pads 652 differ from previously described contact pads 352 with respect to the manner of coupling to the feedthrough connectors 635 and cover plate 665. For example, the contact pads 652 may include an outwardly extending threaded portions 659, secured to the contact pads 652 via fasteners (e.g., a nut, a washer). In some embodiments, the contact pads 652 may include an outwardly extending threaded portion 659, configured to interface with an external component, such as a conductive member, terminal connector. The threaded portion 659 may receive a nut, compression lug, or other external fastener, thereby enabling robust electrical and mechanical coupling to the external component. In some embodiments, the terminal arrangements on the cover plate 665, including the orientation of the contact pads 652 on the cover plate 665, can facilitates alignment and direct connection with corresponding battery management system (BMS) interface terminals.

FIG. 35B provides a side cross-sectional view of the electrochemical cell assembly 600, taken along line P-P shown in FIG. 35A to show a portion of a feedthrough connector 635 included in a feedthrough assembly of the cell assembly 600. The feedthrough connector 635 may include an annular portion 638. In some embodiments, the annular portion 638 includes a groove or recess configured to receive a deformable seal member 639. The seal member 639 may include an O-ring, lock washer, spring washer, or other compliant component formed from EPDM rubber, silicone, or another elastomeric material. In some embodiments, the seal member 639 is configured to provide electrical insulation and environmental sealing between the inner surface of the cover plate 665 or corresponding portion of a feedthrough assembly including the feedthrough connector 635, and the feedthrough connector 635.

In some embodiments, the annular portion 638 can include two concentrically arranged circular grooves. A first groove, having a relatively larger volume or cross-sectional width (e.g., diameter), may be configured to receive a deformable seal member 6380, such as an O-ring. A second groove, having a relatively smaller volume or cross-sectional width (e.g., diameter) and positioned concentrically with or adjacent to the first groove, may be configured to receive a mechanical stabilization component 638w, such as a lock washer or spring washer. In some embodiments, the dual-groove configuration of the annular portion 638 can facilitate both sealing and mechanical stabilization. This arrangement may reduce the number of unique parts used, improve sealing integrity, and/or enhance vibration resistance during operation.

FIG. 35C illustrates a front perspective view of an electrochemical cell assembly 600b, in accordance with various embodiments. The electrochemical cell assembly 600b includes a cover plate 665b having a plurality of contact pads 652b disposed thereon. Each contact pad 652b is electrically coupled to a corresponding feedthrough connector, and the cover plate 665b is mechanically supported by a set of standoff arms 666b. The electrochemical cell assembly 600b is disposed within a housing 660b, which may be formed of a rigid material such as aluminum or steel to provide structural support and environmental protection.

In some embodiments, the electrochemical cell assembly 600b may be structurally and/or functionally similar to the feedthrough subassemblies previously described with reference to electrochemical cell assembly 600. Accordingly, to avoid redundancy, detailed descriptions of the feedthrough structure are omitted for clarity.

Notably, the spatial configuration of the contact pads 652b in assembly 600b differs from that of assembly 600. In some embodiments, rubber insulators can be positioned around or beneath the terminal structures to improve electrical insulation, enhance operator safety, and reduce the number of unique parts required in the assembly.

A mechanically locking feature may be integrated into an internal fixture to secure components without requiring welding or additional process steps. Such a mechanical interlocking can reduce manufacturing complexity, shorten assembly time, and/or enhance structural stability under thermal or mechanical loads.

FIG. 35D provides a side cross-sectional view of the electrochemical cell assembly 600b, taken along line Q-Q shown in FIG. 35C to show a portion of a feedthrough connector 635b included in a feedthrough assembly of the cell assembly 600b. The feedthrough connector 635b may include an annular portion 638b. In some embodiments, the annular portion 638b includes a groove or recess configured to receive a deformable seal member 639b. The seal member 639b may same as or similar to the seal member 639b described with respect to FIGS. 35A and 35B.

In some embodiments, the annular portion 638 can include two concentrically arranged circular grooves. A groove may be configured to receive a mechanical stabilization component 638wb, such as a lock washer or spring washer. In some embodiments, an insulator 635bc (e.g., a rubber or a plastic insulator) can be disposed on and around the annular portion 638. This arrangement may reduce the number of unique parts used, improve sealing integrity, and/or enhance vibration resistance during operation.

As shown in FIG. 35D, the contact pads 652b can be electrically coupled to one or more external busbar(s) 659b. The external busbars can be configured to provide direct series electrical connections between adjacent cell assemblies. The use of external busbar(s) 659b (e.g., copper busbars) can reduce contact resistance and further reduces the total number of unique components employed.

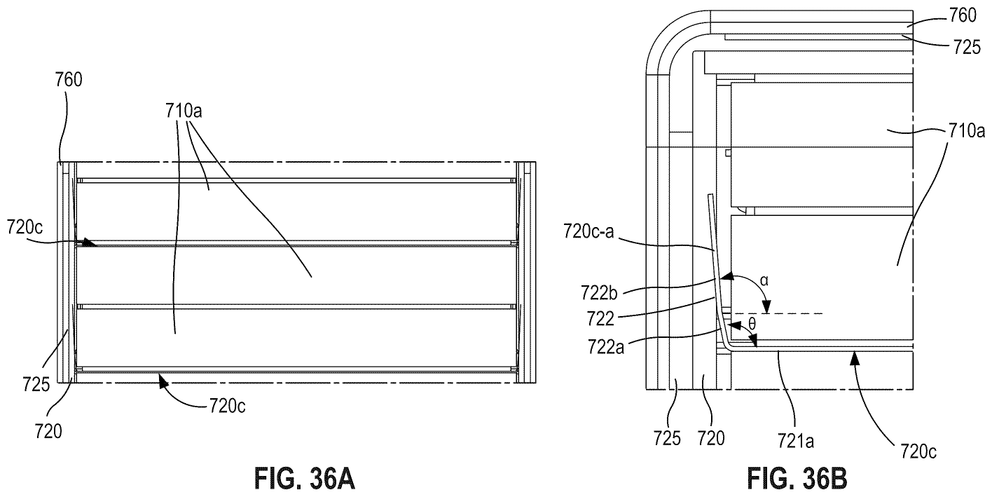

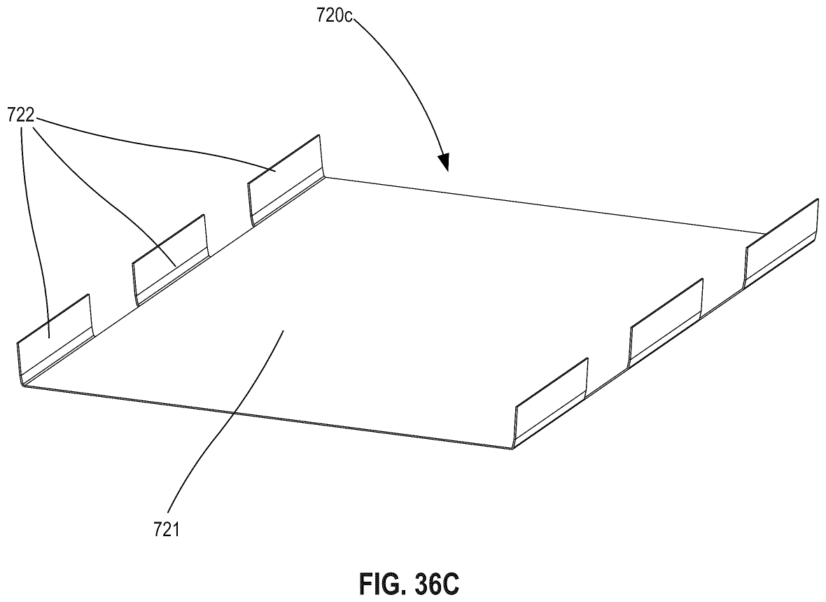

FIGS. 36A and 36B illustrate a portion of an electrochemical cell subassembly including cooling plates 720c in accordance with certain embodiments. FIG. 36B illustrates an enlarged view of a portion of the subassembly shown in FIG. 36A showing a portion of a cooling plate 720c. The subassembly comprises a plurality of electrochemical cells 710a disposed within a fixture 720, and a plurality of cooling plates 720c interposed between adjacent electrochemical cells 710a or adjacent electrochemical cell substacks to form a vertically stacked cell stack. The cooling plates 720c are configured to operate as heat spreaders and to facilitate indirect thermal transfer from the internal electrochemical cells to an external enclosure (e.g., an external sink), such as an aluminum housing, via the fixture 720 and, in some embodiments, through one or more compliance structures 725 and/or thermal interface materials (TIMs). The compliance structure 725 may be disposed between the fixture 720 and the housing 760. In some embodiments, the compliance structure 725 can be disposed on an outer surface of the fixture 720, an inner surface of the housing 760, or both.

In some embodiments, the electrochemical cell subassembly, or components thereof, may be structurally and/or functionally similar to subassemblies described in preceding embodiments. For example, the fixture 720 may be substantially similar to the fixture 320 shown in FIG. 6A. In some embodiments, one or more compliance structures 725 (e.g., thermal gap-filling pads) may be disposed on surfaces of the fixture 720 to enhance thermal transfer to an external enclosure (e.g., the housing 760).

In some embodiments, the cooling plates 720c are positioned between adjacent electrochemical cells 710a or substacks of the electrochemical cells 710a and are configured to act as heat spreaders. The cooling plates 720c may transfer thermal energy indirectly to an external housing 760, such as an aluminum case, through conduction paths established via the fixture 720, which may be formed of thermally conductive material (e.g., stainless steel), and optionally through thermal interface materials (e.g., thermal pads or gap-filling gels). In some embodiments, the thermal interface materials includes any material configured to enhance thermal conductivity between adjacent components by reducing thermal resistance at the interface. In some embodiments, the thermal interface material may include thermally conductive pastes, pads, gels, phase change materials, or elastomers, and may optionally include fillers to improve heat transfer. The thermal interface material may be disposed between surfaces such as cooling plates, fixtures, and enclosures to facilitate indirect heat transfer away from heat-generating components.

In some embodiments, the cooling plates 720c rely on a spring force to maintain contact with surrounding components. For instance, as shown in FIG. 36C, each cooling plate 720c may include a first planar portion 721 configured to receive or contact a flat surface of the cell stack 710, and a set of arms 722 extending upward from opposite lateral edges of the planar portion 721. In some embodiments, the arms 722 may extend at an angle between approximately 100°±10° and 170°±10° relative to the planar portion 721 in an unbent or relaxed configuration. As shown in FIG. 36B, upon insertion into the fixture 720, the arms 722 may deflect inward, producing an interference fit with adjacent structural walls. This interference contact may reduce mechanical gaps, promote uniform compression, and improve thermal conduction.

Expanding further, in some embodiments, each of the arms 722 may include a first portion 722a extending at a first angle θ from the corresponding lateral edge of the planar portion 721, and a second portion 722b extending at a second angle a different from the first angle from the first portion 722a. In some embodiments, the first angle θ is in a range of about 100° to about 150° relative to the planar portion 721, while the second angle a is in a range of about 95° to about 145°, relative to the first portion 721, or a plane that's parallel to the first portion 721. In some embodiments, the second angle a may be smaller than the first angle θ. In operation the arms 722 may act as a biasing member (e.g., spring) urging the planar portion 721 towards the corresponding surface of the corresponding electrochemical cell 710a to enhance contact and thereby, enhance thermal dissipation therefrom. For example, the first portion 722a may be bent sufficiently outwards such that the second portion 722b forms an interference fit with a corresponding surface of the fixture 720 when the cell stack is inserted in the fixture 720. The interference fit causes at least the second portion 722b to contact the fixture 720 and bend inwards, thus exerting a biasing force on the first portion 722a, which in turn exerts a corresponding downward biasing force on the planar portion 721.

Additionally, the arms 722 may be configured to conduct heat from the planar portion to the fixture to dissipate heat. In some embodiments, the thermal interface material (e.g., a thermally conductive gel or any other thermal interface material described herein) may be disposed between the second portion 722a and the corresponding surface of the fixture to enhance heat transfer, serve as a compliance material to fill any gaps between the second portion 722b and the fixture, and/or provide a high friction surface to inhibit inadvertent sliding of the second portion 722b relative to the corresponding surface of the fixture 720 during operation.

FIG. 36C shows, the cooling plates 720c in a relaxed, uncompressed or unbent state before insertion into the fixture 720. During assembly, the arms 722 may deflect upon insertion to conform to the interior geometry of the fixture 720, producing spring-like mechanical pressure that enhances thermal contact. The deflected geometry may be engineered by selecting specific bend angles for the cooling plate arms to achieve a nominal interference condition, as described herein. In some embodiments, the bend angles may be experimentally determined to produce controlled deflection against the vertical wall surfaces of the fixture.

In some embodiments, the fixture 720 may be absent, and heat may be directly from the cooling plates 720c to the housing 760 (e.g., an aluminum enclosure). In such configurations, direct contact may be established between the cooling plate 720c and the housing 760 along the bottom face of the pack, and one or more thermal pads may be applied to the end faces (e.g., top and bottom) of the cell stack to further support heat transfer.

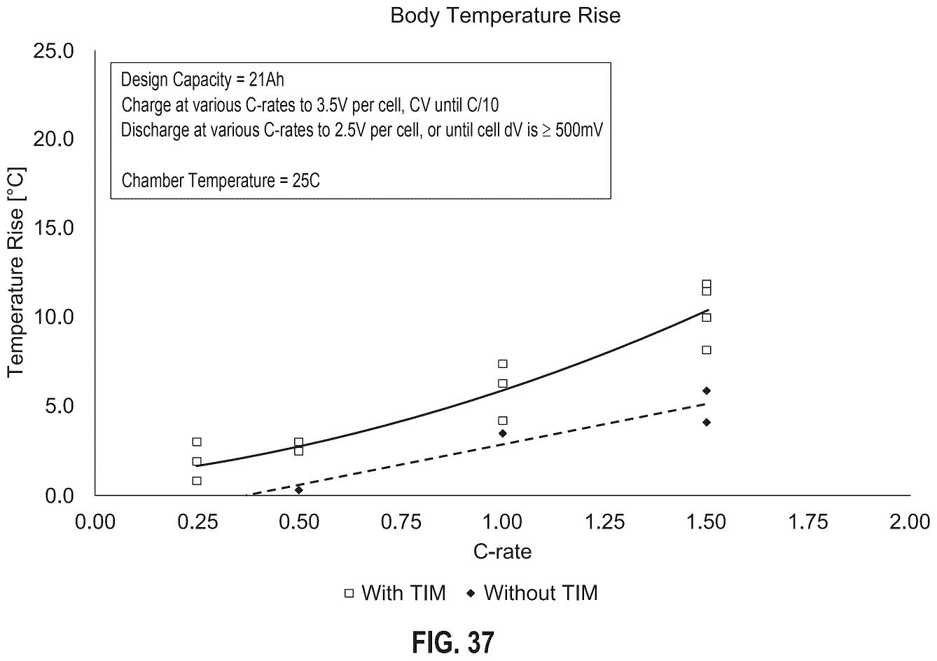

FIG. 37 illustrates the impact of a thermal interface material (TIM) on the body temperature rise (e.g., housing or outer enclosure temperature rise) of a battery pack during charging and discharging cycles. The graph compares temperature rise with and without TIM at various C-rates. The data from the 48V prototype build indicates that the body temperature of the housing rises differently depending on whether TIM is used. The test setup involved capacity checks and discharge rate capability tests based on a 21 Ah design capacity. The maximum temperatures observed at the pack's positive terminal show that the pack, which did not use TIM between the cooling plate side walls and the stainless-steel fixture, had a lower body temperature compared to packs with TIM. This suggests that heat transfer from the unit cell to the cell stack enclosure is less efficient without TIM, as expected. Accordingly, this data demonstrates that the use of TIM significantly increases the heat transfer from the electrochemical cells to the housing of the battery packs, indicating improved thermal management.

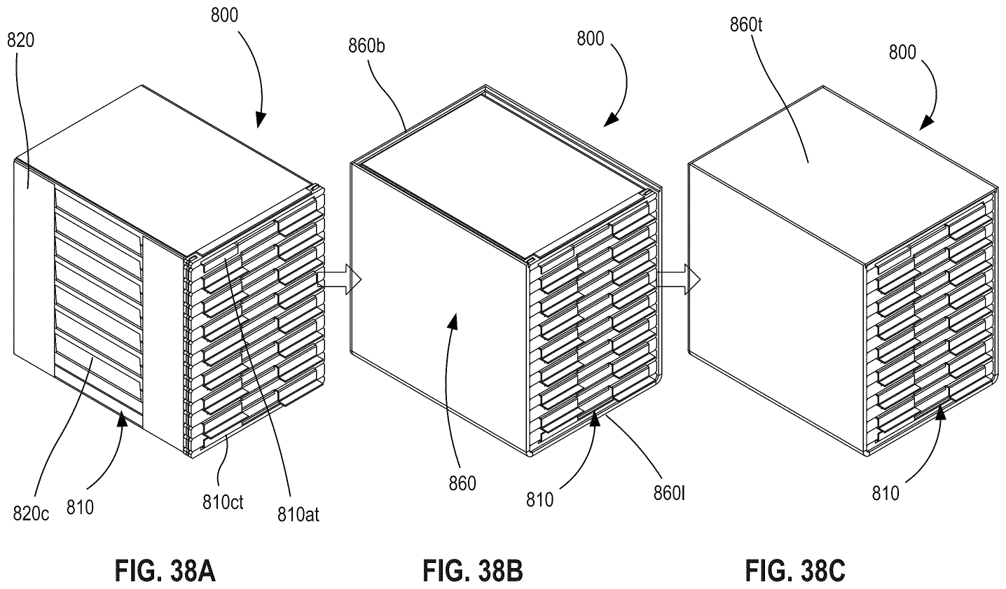

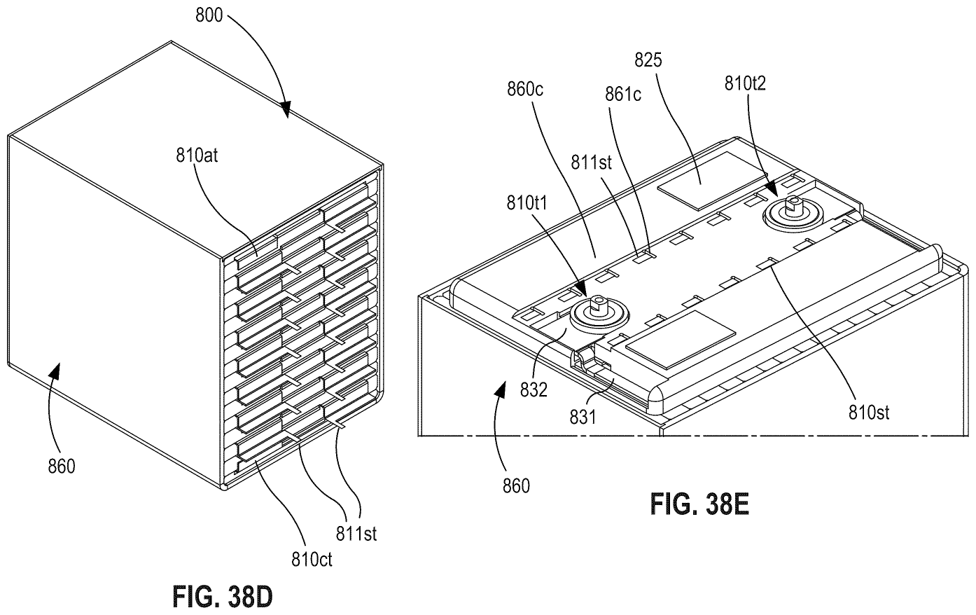

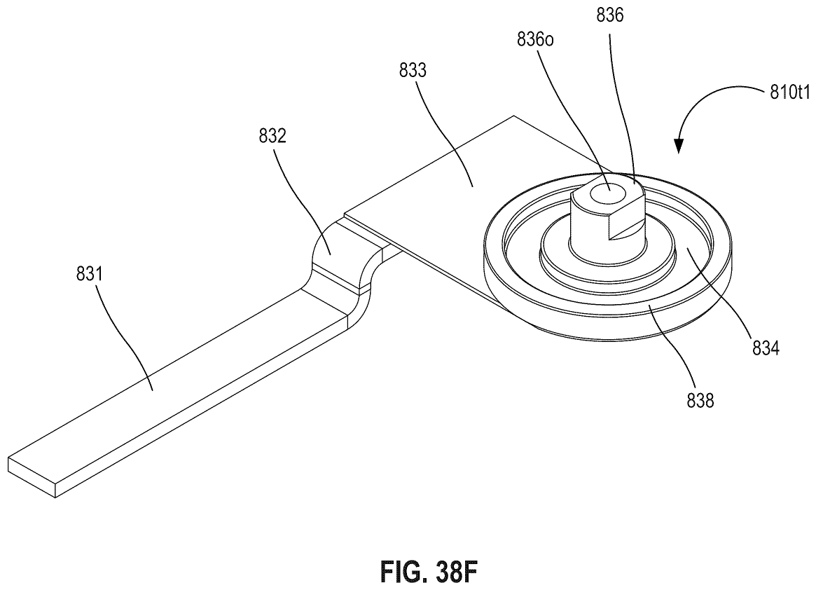

FIGS. 38A-38C illustrate various components of an electrochemical cell assembly 800 (hereinafter, “assembly 800”) including a fixture 820 and associated housing structures, according to an embodiment. The electrochemical cell assembly 800 may be structurally and/or functionally similar to the electrochemical cell assembly 100, 200, 300 and therefore, certain details of the electrochemical cell assembly 800 are not described in further detail herein.

FIG. 38A illustrates a fixture 820 supporting an electrochemical cell stack 810 including a plurality of electrochemical cells. The stack 810 includes anode tabs 810at and cathode tabs 810ct extending from respective electrodes of the electrochemical cells. Each tab 810at and 810ct is configured to be electrically coupled to a feedthrough assembly (not shown) and may be folded into a predetermined shape during the stacking process. In some embodiments, the folding of the tabs 810at or 810ct is position-dependent within the stack 810 and may be performed using custom tooling. The electrochemical cell stack 810 may be divided into parallel substacks, each including, for example, 2, 3, 4, 5, 6, 7, 8, 9, 10, 15, 20, or more electrode layers. Cooling plates 820c are interposed between adjacent substacks or unit cells. In some embodiments, one cooling plate 820c can be disposed between every two parallel stacks except for the bottom two stacks. The fixture 820 may also include a fixture structure formed from a thin (e.g., 0.5 mm) aluminum sheet, into which the electrode layers are stacked. Plastic support or spacers may be positioned between primary tabs to align and locate them within the fixture 820 structure. The supports may include one unique part for each end of the stack and two alternating parts for the central regions.

FIG. 38B illustrates a housing 860 (e.g., an external enclosure) configured to house or contain the electrochemical cell subassembly including the stack 810 disposed in the fixture 820. The housing 860 includes a lower plate 8601 and a back plate 860b that is coupled (e.g., welded, bonded, joined, adhered, etc.) to the lower 8601. In some embodiments, the housing 860 may be formed from 4 mm-thick aluminum sheet metal. The components of the housing 860 may be manufactured as separate parts and subsequently joined. However, in some embodiments, the lower plate 8601 and back plate 860b may be monolithically formed (e.g., via casting, molding, or stamping). After insertion of the electrochemical cell subassembly into the housing 860, a top plate 860t is urged towards the housing 860 such that it compresses the stack 810a, until it contacts corresponding surfaces or edges of the housing 860 and is coupled thereto. In some embodiments, a series of overlapping laser welds may be used to seal the housing 860 along the seams.

FIG. 38C further illustrates the completed enclosure following top plate 860t installation and coupling. Upon sealing the enclosure, electrical interconnection between adjacent parallel substacks can be achieved using, for example, ultrasonic welding tooling. In some embodiments, a custom ultrasonic welding tool may be used, which can be configured to join dissimilar primary tabs extending from each substack to form series connections within the battery pack. In some embodiments, the housing 860 and the cell subassembly may be further enclosed within an external casing that includes electrical terminals configured for integration with an external circuitry.

FIG. 38D illustrates the electrochemical cell assembly of FIG. 38C, further including one or more sensing tabs 810st configured for voltage monitoring and control, in accordance with some embodiments. In some embodiments, a sensing tab 810st includes a small conductive tab electrically coupled to one of the internal electrode layers of an electrochemical cell. The sensing tab 810st is not configured to carry high current like the main terminal tabs 810at, 810ct but is instead used to monitor the voltage of individual cells or substacks for integration with a battery management system (BMS). In some embodiments, the sensing tabs 810st includes nickel-plated copper. The sensing tabs 810st can be incorporated into weld regions along with the primary tabs 810at, 810ct and may be configured to interface with a flexible sensing printed circuit board (FPCB), which is not shown in the figure.

FIG. 38E illustrates the electrochemical cell assembly of FIG. 38D, further including a cover positioned over the primary tabs 810at, 810ct (not shown), and sensing tabs 810st. The electrochemical cell assembly of FIG. 38E includes feedthrough terminals 810t1 and 810t2 that are in electrical connection with the primary tabs 810at, and 810ct. In some embodiments, the primary tab 810at is in electrical connection with the feedthrough terminal 810t1. In some embodiments, In some embodiments, the primary tab 810ct is in electrical connection with the feedthrough terminal 810t2. Alternatively, in some embodiments, the primary tab 810at is in electrical connection with the feedthrough terminal 810t2. In some embodiments, the primary tab 810ct is in electrical connection with the feedthrough terminal 810t1. The cover 860c is formed from an electrically insulating material, such as plastic. The cover 860c is configured to align with the stack when the pack is oriented vertically, and is placed such that the sensing tabs 810st extend through openings 861c in the cover. The cover 860c includes openings (e.g., slots, apertures, holes) 861c that align with complementary extension arms 811st extending from the sensing tabs 810st supports to ensure proper alignment and to prevent displacement due to mechanical shock or vibration. In some embodiments, the extensions arms 811st may be inserted through corresponding openings 861c and folded to lay flat on an outer surface of the cover 860c.

In some embodiments, the sensing tabs 810st can be bent approximately 90 degrees outward to facilitate bonding with the flexible printed circuit board (PCB) as shown in FIG. 38E. Micro-TIG welding or other fine-scale bonding methods may be used to attach each sensing tab 810st to a corresponding trace on the FPCB (not shown). In some embodiments, a wiring harness (also not shown) is subsequently bonded to each sensing tab 810st (e.g., the extension arms 811st) to route voltage signals to a feedthrough terminal subassembly. In some embodiments, feedthrough terminals 810t1, 810t2 are configured to provide sufficient current-carrying capacity while remaining flexible enough to maintain a seal against the top plate 860t, for example, following laser welding of the top plate 860t to the housing 860. In some embodiments, feedthrough terminals 810t1, 810t2 are configured to be in electrical contact with a conductive arm 831 that is electrically connected to primary terminal tabs 810at, and 810ct. The conductive arm 831 can be same as or similar to the conductive arms described above with respect to multiple embodiments. The conductive arm 831, in some embodiments, can be electrically connected to the feedthrough terminals 810t1, 810t2 via a busbar 832 (e.g., a copper foil, a copper plate).

In some embodiments, the conductive arm 831 (FIG. 38F) can be provided to electrically couple internal cell stack terminals 810at, 810ct to external battery terminals while maintaining environmental sealing. The feedthrough terminals 810t1 and 810t2 can be configured to pass through an opening in the battery housing and establish an electrical interface with external systems. In some embodiments, the terminals 810t1 and 810t2 may include surface features or geometries to retain sealing elements or enhance bonding with additional sealing components. In some embodiments, the terminals 810t1 and 810t2 may be configured to be received by an aperture defined by a surface of a feedthrough plate, that is substantially same as or similar to the feedthrough plates of the foregoing embodiments.

In some embodiments, the feedthrough terminals 810t1 and 810t2 may be further integrated with glass-to-metal seals, overmolded polymer seals, or other hermetically sealing structures to improve the long-term environmental integrity of the assembly.

FIG. 38F illustrates a perspective view of the feedthrough terminal 810t1 of FIG. 38E, according to some embodiments. The terminal feedthrough 810t1 includes a conductive arm 831 electrically coupled to the terminal feedthrough 810t1 through the busbar 833. In some embodiments, the conductive arm 831 is also a busbar. In some embodiments, the conductive arm includes a conductive body configured to serve the function of a busbar, structurally interfacing with the conductive arm 831 and the feedthrough connector 835. In some embodiments, the feedthrough terminal 810t1 is substantially the same as, or similar to, the feedthrough connector described in connection with one or more of the foregoing embodiments. In some embodiments, the feedthrough terminal 810t1 is configured to be received within an aperture defined by a feedthrough plate, wherein the feedthrough plate may correspond to any of the feedthrough plate configurations described in one or more preceding embodiments.

In some embodiments, the feedthrough terminal 810t1 is configured to electrically couple the terminating primary tabs 810t1 and 810t2) to external battery terminals. The feedthrough terminal 810t1 can provide a pathway for current to travel from the internal electrochemical cell stack to external electrical interfaces, while maintaining mechanical integrity and environmental isolation.

In some embodiments, the feedthrough terminal 810t1 includes a cylindrical portion 836 (or a similar geometry such as a rounded rectangle or other form with curved edges) and an annular portion 838. The cylindrical portion 836 may be dimensioned to extend through an aperture formed in a feedthrough plate or housing cover. The cylindrical portion 836 may include an axially extending cavity 8360, which may be configured to reduce weight, facilitate alignment during assembly, or accommodate internal features. The annular portion 838 may include a circumferential groove 834, within which a seal member such as an O-ring may be disposed. The seal member can be configured to form a hermetic or environmental seal between the feedthrough connector and the surrounding plate or housing, thereby inhibiting the ingress of moisture, gas, or particulates.

In some embodiments, the conductive arm 831 is configured to electrically connect to the primary terminating tabs 810at of the cell stack. In some embodiments, the conductive arm 831 is formed from a high-conductivity material, such as copper, copper alloy, or nickel-plated copper, and may be joined to the tabs via a welding process such as ultrasonic welding, resistance welding, or laser welding. The conductive arm 831 can provide a mechanically rigid and low-resistance pathway from the cell stack to the connector.

The bus bar 833 can provide electrical continuity between the conductive arm 831 and the terminal feedthrough 810t1 while allowing for mechanical flexibility. In some embodiments, the busbar 833 includes one or more layers of thin conductive foils that are stacked, laminated, or bonded together. Each foil layer may have a thickness of about 0.003 inches, although in some embodiments, the thickness may fall within a range of 0.001 inches to 0.010 inches. In some embodiments, one end of the foil stack is welded to the conductive arm 831, and the opposite end is welded to the feedthrough terminal.

As illustrated in FIG. 38F, the bus bar 833 may be mechanically and electrically connected to the conductive arm 831 through a bent or angled section 832. In some embodiments, the bent portion 832, the bus bar 833, and the conductive arm 831 can be integrally formed as a single, continuous piece. Alternatively, these components may be manufactured separately and then joined together, for example, by welding, brazing, or another suitable joining technique.

In some embodiments, gap-filling pads 825 are positioned on top of the series cover 860c prior to or after cover 860c installation. The pads 825 can be configured to close the mechanical gap between a lid (as shown in a subsequent figure) and the internal components, providing physical stability and improving thermal contact within the sealed enclosure.

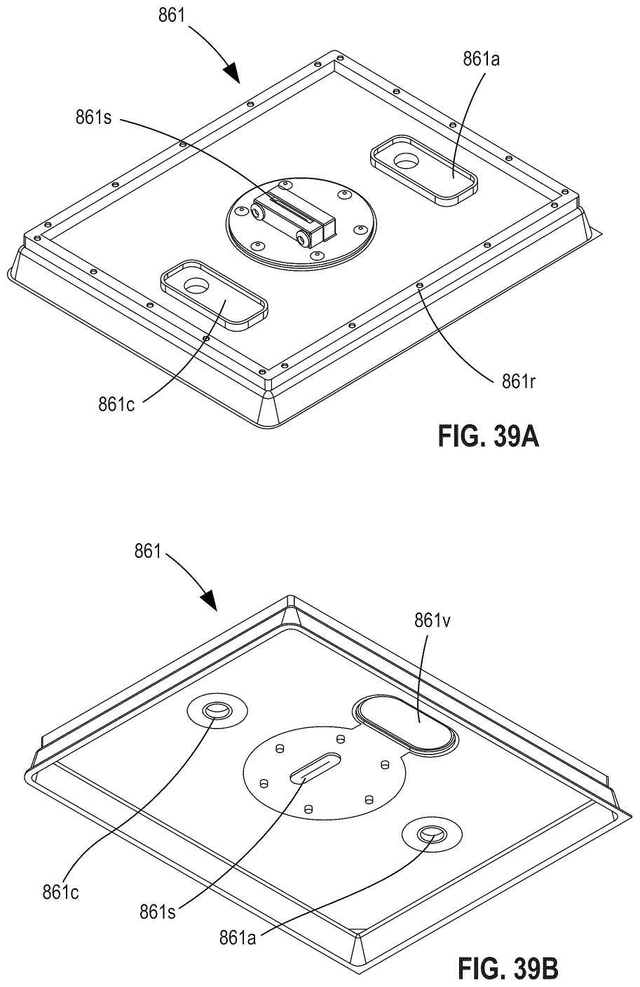

FIG. 39A illustrates a top view of a lid sub-assembly 861 configured to be mounted onto the cover 860c of the electrochemical cell enclosure of FIG. 38E, in accordance with some embodiments. FIG. 39B illustrates a corresponding bottom view of the same lid sub-assembly 861.

In some embodiments, the lid sub-assembly 861 includes a rim 861r (e.g., an aluminum rim) having pre-threaded holes. In some embodiments, the rim 861r is tack welded into position to facilitate reliable attachment of the lid to the cover 860c using fasteners, thereby forming a sealed interface that supports an ingress protection (IP) rating of at least IP67.

The lid sub-assembly 861 further includes a sensing harness feedthrough 861s, which is also configured to prevent gas and moisture from entering the battery pack. In some embodiments, the sensing harness feedthrough 861s is integrated with a flexible printed circuit assembly and is secured in place using compression features or sealing adhesives to maintain environmental isolation.

In some embodiments, the lid sub-assembly 861 also includes electrically insulating inserts or grommets positioned at the locations of the positive terminal (e.g., positive terminal insulator 861c), and the negative terminal (e.g., negative terminal insulator 861a). These insulators 861a and 861c can provide electrical isolation between the terminals and the conductive structure of the lid, improving safety and electric reliability.

An over-pressure safety vent 861v can also be integrated into the lid 861 to allow controlled release of internal pressure in the event of thermal runaway or overcharging conditions. The vent 861v can be configured to open at a defined pressure threshold to protect the integrity of the enclosure.

In some embodiments, sealing rivets can be used to apply compressive force onto the skirt of a gasket positioned between the lid subassembly 861 and the underlying cover 860c. This compressive sealing technique can inhibit moisture or gas ingress and enhances overall mechanical stability of the lid-to-cover interface. In some embodiments, a bracket and fasteners can be used in conjunction with the sealing rivets to enhance the compression seal. The bracket applies uniform pressure across the interface to ensure complete engagement of the sealing features. In some embodiments, the lid sub-assembly 861 may be modified to incorporate a molded elastomeric seal or a glass-to-metal seal to achieve improved hermeticity.

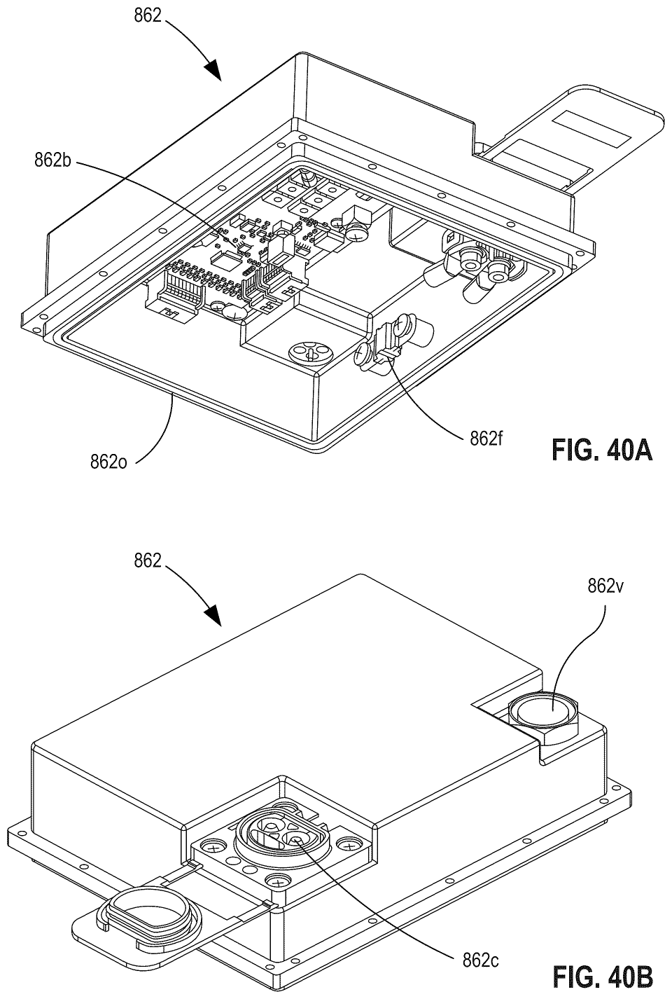

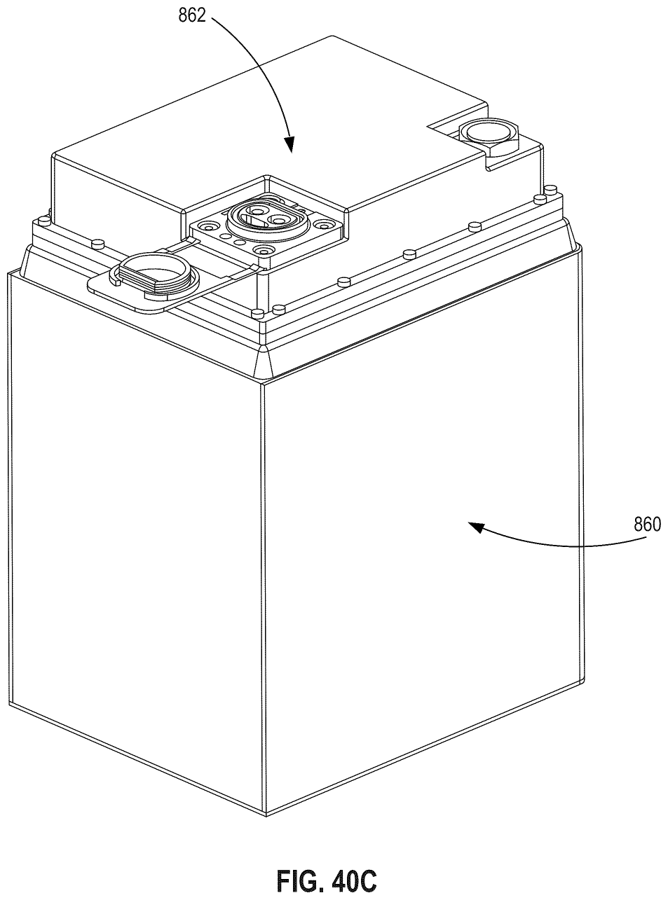

FIG. 40A illustrates a bottom view, and FIG. 40B illustrates a top view of a pack cover sub-assembly 862, in accordance with some embodiments. The pack cover sub-assembly 862 is configured to meet ingress protection (IP) rating requirements of IP67, which provides protection against both dust ingress and water immersion up to 1 meter for 30 minutes. The pack cover sub-assembly 862 includes multiple integrated components configured to support electrical, mechanical, and safety functions of the battery system.

In some embodiments, the pack cover sub-assembly 862 includes an O-ring gasket 8620 positioned around the perimeter of the interface between the pack cover sub-assembly 862 and the lid subassembly 861. The O-ring gasket 8620 is configured to deform under compression to form a continuous environmental seal, thereby preventing moisture, dust, or gas ingress into the battery enclosure.

A pressure relief valve 862v can also integrated into the cover sub-assembly 862 and may be configured to activate in the event of an abnormal rise in internal pressure. This over-pressure valve 862v provides a passive safety feature that allows for the controlled release of gases generated under fault conditions such as cell venting or thermal runaway.

In some embodiments, a feedthrough electrical connector 862c is mounted through the pack cover and provides the primary electrical interface between the internal battery assembly and external power electronics. The connector 862c can be sealed with overmolding, gaskets, or other sealing features to prevent moisture ingress while enabling reliable power transmission.

The cover sub-assembly 862 may further include a safety fuse 862f positioned in-line with the main current path to interrupt current flow in the event of an overcurrent condition. The fuse 862f serves as an additional layer of protection against electrical faults or short circuits.

A battery management system (BMS) board 862b can be mounted directly to the inner surface of the pack cover 862 or within an associated housing cavity. In some embodiments, the BMS board 862b is configured to receive voltage and temperature signals from the sensing harness, control power flow, balance cell voltages, and communicate with external systems.

Although not shown, various cables and contact ring terminals may be connected to the internal busbar structure and routed through the feedthrough connector 862c to complete the electrical path to the outside. The connection of these components may occur prior to the final fastening of the cover.

FIG. 40C illustrates the completed battery pack, in accordance with some embodiments, with the cover sub-assembly 862 fastened to the pack lid 861 and secured to the underlying housing 860. The housing 860 encloses the electrochemical cell sub-assembly and supports the structural and environmental integrity of the pack. A plurality of mechanical fasteners are positioned around the perimeter of the pack lid to compress the O-ring gasket between the lid 861 and the cover sub-assembly 862, thereby forming a sealed interface.

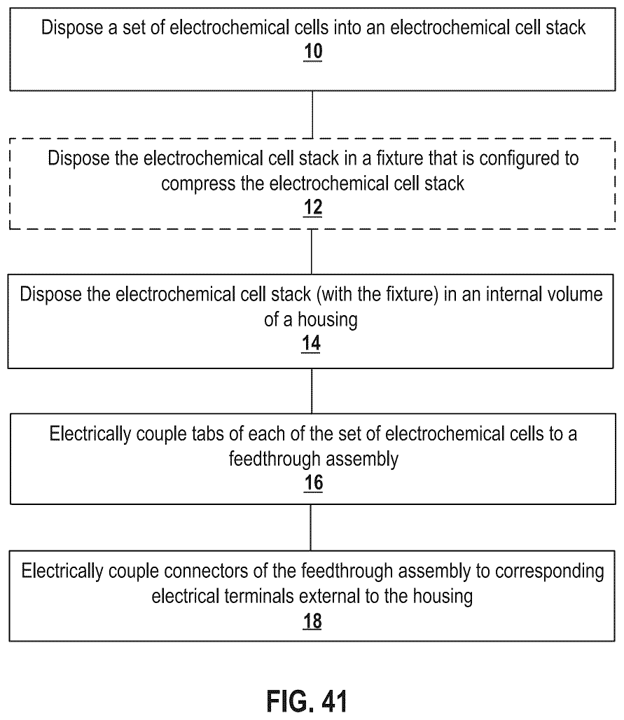

FIG. 41 is a flow chart of an example method of producing an electrochemical cell assembly, according to an embodiment. While described with respect to electrochemical cell assembly 100 including the stack 110, fixture 120, feedthrough assembly 130, housing 160, and external casing 190, the method is equally applicable to any cell assembly described herein. All such variants should be considered to be within the scope of this disclosure.

Method includes disposing a set of electrochemical cells 110a into an electrochemical cell stack 110, at 10. In some embodiments, the electrochemical cells 110a may be arranged into cell substacks, and each cell substack may be stacked to form the cell stack 110. At 12, the method may optionally include disposing the cell stack 110 in a fixture 120 that is configured to compress the cell stack 110 to form a cell subassembly. For example, the cell stack 110 may be disposed on a bottom plate of the fixture 120, and a top plate may be fastened to the bottom at a predetermined distance such that the cell stack 110 is compressed between the top and bottom plates of the fixture 120.

At 14, the method includes disposing the electrochemical cell stack 110 (e.g., with the fixture 120) in an internal volume of a housing 160. At 16, a tab of each of the electrochemical cells and/or a tab of each cell substack is electrically coupled to a feedthrough assembly 308. For example, connectors of the feedthrough assembly 130 (e.g., the conductive arms and/or the feedthrough connectors) may be electrically coupled to the tabs. In some embodiments, the fixture 120 may be coupled to a feedthrough assembly 130 before being disposed in the housing 160. In some embodiments, feedthrough assembly 130 may be coupled to the fixture 120 after the fixture 120 is disposed in the housing 160. In some embodiments, after the feedthrough assembly 130 is electrically coupled to the tabs, a cover plate may be disposed over an opening defined by the housing 160 and coupled to the housing 160. In some embodiments, one or more connection points between the feedthrough assembly 130, the cover plate, and/or the housing 160 may be welded. For example, one or more connection points between the feedthrough connectors and the cover plate may be welded, and one or more connection points between the cover plate and the housing may be welded, thereby hermetically sealing the internal volume defined by the housing 160. In some embodiments, each feedthrough connector may be welded to the cover plate.

In some embodiments, the housing 160 including the cell subassembly may be disposed in an external casing 190 including the electrical terminals 180. At 18, the of the feedthrough assembly 130 (e.g., the contact pads) may be electrically coupled to corresponding electrical terminals 180 external to the housing 160. In some embodiments, a controller may be coupled to the cell stack 110 via the feedthrough assembly 130 and to the electrical terminals 180 external to the housing 160 such that electrical energy can be conveniently withdrawn from the cell stack 110 via the electrical terminals 180.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network fixture, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An assembly, comprising:
a housing defining an internal volume configured to receive an electrochemical cell stack therein, the electrochemical cell stack including a plurality of electrochemical cells stacked on top of each other, each of the electrochemical cells including at least one tab extending therefrom; and
a feedthrough assembly configured to be electrically coupled to the electrochemical cell stack, the feedthrough assembly including:
a conductive arm configured to align with and contact a tab of a corresponding electrochemical cell of the plurality of electrochemical cells when the electrochemical cell stack is disposed in the internal volume, and
a feedthrough connector coupled to the conductive arm and configured to electrically couple the tab of the corresponding electrochemical cell to an electrical component external to the housing.

2. The assembly of claim 1, wherein the feedthrough assembly is at least partially disposed in the housing.

3. The assembly of claim 1, wherein:
the feedthrough connector defines a first threaded cavity and a second threaded cavity; and
the feedthrough assembly further includes a first threaded fastener configured to be disposed in the first threaded cavity to couple the feedthrough connector to the conductive arm.

4. The assembly of claim 3, wherein the feedthrough assembly further comprises:
a second threaded fastener configured to be disposed in the second threaded cavity and electrically connect the conductive arm, the feedthrough connector, and the first threaded fastener to the electrical component external to the housing.

5. The assembly of claim 4, wherein:
an opening is defined in a sidewall of the housing; and
the feedthrough assembly further comprises:
a feedthrough plate configured to cover a portion of the opening of the housing, the feedthrough plate defining an aperture configured to receive a corresponding feedthrough connector therethrough.

6. The assembly of claim 5, further comprising:
a cover plate coupled to the sidewall of the housing to close the opening and substantially hermetically seal the housing.

7. The assembly of claim 4, wherein the second threaded fastener is disposed outside of the internal volume of the housing.

8. The assembly of claim 1, further comprising:
a fixture disposed in the internal volume of the housing, the fixture defining an inner space configured to receive the electrochemical cell stack and at least one of secure the electrochemical cell stack or apply a compressive force on the electrochemical cell stack.

9. The assembly of claim 8, wherein the fixture includes:
a first plate configured to receive the electrochemical cell stack thereon;
a set of arms extending from opposing edges of the first plate at a substantially orthogonal angle relative to the first plate; and
a second plate coupled to ends of each of the set of arms opposite the first plate such that the electrochemical cell stack is secured between the first and second plate and the compressive force is exerted on the electrochemical cell stack.

10. The assembly of claim 8, further comprising:
a compliance member disposed between the housing and the fixture, the compliance member disposed on at least one of an outer surface of the fixture or an inner surface of the housing.

11. The assembly of claim 10, wherein the compliance member comprises a metallized polymer, the metallized polymer including a polymer with a metal coating disposed on a surface of the polymer.

12. The assembly of claim 1, further comprising:
a plurality of cooling plates interposed between at least a portion of the electrochemical cells stacked included in the electrochemical cell stack, the cooling plates configured to facilitate heat transfer away from the electrochemical cell stack.

13. The assembly of claim 12, wherein each of the plurality of cooling plates include:
a base portion; and
a set of arms extending from at least a portion of edges of the base portions towards the housing, the set or arms configured to contact corresponding walls of the housing and be bent inwards to urge the base portion towards a corresponding electrochemical cell of the electrochemical cell stack.

14. The assembly of claim 13, wherein a thermal interface material is disposed between the set of arms and the corresponding wall of the housing.

15. The assembly of claim 1, further comprising:
a controller coupled to the plurality of electrochemical cells in the electrochemical cell stack via the feedthrough assembly.

16. The assembly of claim 1, further comprising:
a casing defining an inner volume configured to receive the housing, the casing including electrical terminals disposed on a sidewall of the housing, the electrical terminals configured to be electrically coupled to a corresponding tab of one or more of the plurality of electrochemical cells via the feedthrough assembly.

17. The assembly of claim 1, further comprising:
one or more backing films, each disposed on at least one current collector of a respective electrochemical cell from the plurality of electrochemical cells.

18. The assembly of claim 1, wherein the at least one tab extending from each of the electrochemical cells of the electrochemical cell stack has a folded configuration.

19. The assembly of claim 1, further comprising:
a plurality of tabs, each of the plurality of tabs electrically coupled to a corresponding electrode of one of the electrochemical cells.

20. A feedthrough assembly, comprising:
a conductive arm configured to align with and contact a terminal tab of a corresponding electrochemical cell in an electrochemical cell stack;
a feedthrough connector coupled to the conductive arm and configured to electrically couple the terminal tab to an external electrical component; and
a busbar electrically coupled to the terminal tab of the electrochemical cell, wherein the conductive arm includes a foil coupled to the busbar and to the feedthrough connector.

21. The assembly of claim 20, wherein the feedthrough connector includes a first threaded cavity and a second threaded cavity.

22. The assembly of claim 21, further comprising a first threaded fastener disposed in the first threaded cavity to couple the feedthrough connector to the conductive arm.

23. The assembly of claim 22, further comprising a second threaded fastener disposed in the second threaded cavity and configured to electrically connect the conductive arm, the feedthrough connector, and the first threaded fastener to the external electrical component.

24. The assembly of claim 20, further comprising a feedthrough plate defining an aperture configured to receive the feedthrough connector.

25. The assembly of claim 24, further comprising a cover plate configured to seal around the feedthrough plate.

26. A system comprising:
a housing defining an internal volume configured to receive an electrochemical cell stack;
a plurality of electrochemical cells stacked within the housing;
a feedthrough assembly electrically coupled to the electrochemical cell stack;
a plurality of cooling plates interposed between at least a portion of the electrochemical cells and configured to transfer heat away from the electrochemical cells; and
a plurality of thermal interface materials disposed between the cooling plates and corresponding walls of the housing.

27. The system of claim 26, wherein the thermal interface materials comprise thermally conductive pads, or thermally conductive gels.

28. The system of claim 26, wherein each of the plurality of cooling plates include:
a base portion; and
a set of arms extending from at least a portion of edges of the base portions towards the housing, the set or arms configured to contact corresponding walls of the housing and be bent inwards to urge the base portion towards a corresponding electrochemical cell of the electrochemical cell stack.

29. The system of claim 28, wherein the thermal interface material is disposed between the set of arms and the corresponding wall of the housing.

30. The system of claim 26, wherein the housing defines a conduction path from the cooling plates to an external heat sink.

31. The system of claim 26, further comprising:
a fixture disposed in the internal volume of the housing, the fixture defining an inner space configured to receive the electrochemical cell stack.

32. The system of claim 31, further comprising:
a compliance member disposed between the housing and the fixture, the compliance member disposed on at least one of an outer surface of the fixture or an inner surface of the housing.

33. The system of claim 26, wherein the feedthrough assembly comprises:
a conductive arm configured to align with and contact a tab of a corresponding electrochemical cell of the plurality of electrochemical cells when the electrochemical cell stack is disposed in the internal volume; and
a feedthrough connector coupled to the conductive arm and configured to electrically couple the tab of the corresponding electrochemical cell to an electrical component external to the housing.

34. The system of claim 26, further comprising a controller electrically coupled to the electrochemical cell stack via the feedthrough assembly.
